(19) United States
(12) Patent Application Publication
(10) Pub. No.: US 2011/0220317 A1
(43) Pub. Date: Sep. 15, 2011

(54) APPARATUS AND PROCESS FOR CONTROLLING THE FLOW RATE OF HEAT TRANSFERRING FLUID FLOWING THROUGH A GROUND LOOP HEAT EXCHANGING (GLHE) SUBSYSTEM CONSTRUCTED FROM ONE OR MORE GROUND HEAT EXCHANGERS (GHE) WHILE OPERABLY CONNECTED TO GEOTHERMAL EQUIPMENT (GTE) INCLUDING A REFRIGERANT COMPRESSOR AND ASSOCIATED WITH A GEOTHERMAL SYSTEM

(75) Inventor: John E. Kidwell, Tulsa, OK (US)

(73) Assignee: Kelix Heat Transfer Systems, LLC

(21) Appl. No.: 13/045,705

(22) Filed: Mar. 11, 2011

Related U.S. Application Data
(63) Continuation-in-part of application No. 12/832,463, filed on Jul. 8, 2010.
Application No. 12/832,463 is a continuation-in-part of application No. 12/798,827, filed on Apr. 12, 2010.
Application No. 12/798,827 is a continuation-in-part of application No. 12/661,176, filed on Mar. 11, 2010.

(51) Int. Cl. G05D 23/00; G05D 23/19; F24J 3/08

(52) U.S. Cl. 165/11.1; 165/287

(57) ABSTRACT

Apparatus and process for monitoring incremental changes in the inlet water temperature into and HTR across a GLHE subsystem, and in response thereto, automatically increasing or decreasing the flow rate of water flowing through into and out of the GLHE subsystem, so as to minimize the electrical energy consumption of electronically-controlled ground loop pumps employed to pump water through the GLHE subsystem.

### RELATED CASES

The present application is a Continuation-in-Part (CIP) of copending U.S. application Ser. No. 12/832,463 filed Jul. 8, 2010, which is a CIP of U.S. application Ser. No. 12/798,827 filed Apr. 12, 2010, which is a CIP of application Ser. No. 12/661,176 filed Mar. 11, 2010, and assigned to Kelix Heat Transfer Systems, LLC, incorporated herein by reference as if set forth fully herein.

### BACKGROUND OF THE INVENTION

1. Field of Invention

The present invention relates to new and improved methods of and apparatus for measuring the energy conversion performance of ground heat exchangers (GHEs) and ground loop heat exchangers (GLHE) installed in deep Earth environments, and new and improved methods of and apparatus for engineering geothermal ground loop subsystems using the same.

2. Brief Description of the State of Knowledge in the Art

In general, most geothermal system engineering projects involve four phases, namely: analysis/planning; design; implementation/construction; and testing.

The analysis and planning phase involves determining the size of the total thermal load that the geothermal system under design must handle during heating and/or cooling modes of operation. During this stage, the thermal loads of individual heat sources and sinks in the building environment are identified and modeled, using conventional software tools, to estimate total load during heating and cooling seasons. There are many excellent tools and methods currently available for supporting this phase of the systems engineering project.

During the design and construction phases, the designer and engineer currently have several vertical-type ground heat exchanger (GHE) technology options available, namely: “closed-loop” vertical U-tube construction; “closed-loop” vertical concentric-tube construction; and “open-loop” standing column well construction.

While open-loop standing column well heat exchangers are known to have excellent performance characteristics, they are typically very expensive to construct and can present serious environmental risks to groundwater and aquifers, making this technology an unpopular choice in many geographic regions.

In contrast, closed-loop vertical U-tube ground heat exchangers have gained great popularity over the past two decades, and have eclipsed conventional closed-loop concentric tube ground heat exchangers. Notably, such growth in U-tube ground heat exchangers has occurred despite the fact that (i) concentric-type heat exchangers have been shown to exhibit greater heat transfer performance capacities than U-tube ground heat exchangers, and (ii) U-tube ground heat exchangers typically require significantly greater borehole drilling depths than concentric-tube ground heat exchangers, to achieve a given amount of heat transfer capacity measured in [BTUs/Hr] or [Tons].

Over the past 25 years, a number of conventional software tools have been developed in Sweden and in the USA, to assist in the design of ground loop heat exchangers (GLHEs) for commercial and institutional buildings, using U-tube and concentric-tube ground heat exchanger (GHE) technology.

Currently, the most popular PC-based software systems support a three-dimensional computer “simulation” of the temperature response of various proposed ground loop heat exchange (GLHE) configurations, each comprising an arrangement of thermally-interacting vertical ground heat exchangers (GHEs) having a particular borehole depth and spacing between neighboring boreholes—and specified by a geometry-dependent thermal response function, called its g-function. To date, over a thousand different g-functions have been developed for ground loop heat exchanger (GLHE) configurations to help ground loop designers and engineers meet the thermal load and ground loop field layout requirements of diverse commercial and institutional geothermal projects.

Such computer simulation systems employ a mathematical heat transfer model for each constituent ground heat exchanger (GHE), based on either the “finite line-source” or “infinite line-source” method, which uses an average “thermal conductivity” parameter [BTU/Hr-ft-° F.], and “thermal diffusivity” parameter [ft²/sec] for the ground which must be measured in the field through in situ testing procedures. During set up operations, these simulation systems request empirically measured thermal conductivity and thermal diffusivity values, along with other ground input parameters, such the deep Earth's volumetric heat capacity [BTU/ft³-F], and if not available, offer the user a list of options from a database.

The aim of such ground loop computer simulation tools is to three-fold: (i) predict the temperature field intensity at the boreholes of various ground heat exchanger configurations (specified by g-functions) to expected monthly heating and cooling loads and monthly peak heating and cooling demands, up to a hundred years; (ii) based on the predicted temperature gradients at each borehole, estimate the transfer of heat energy injected into the deep Earth during cooling demands, and extracted from the deep Earth during heating demands, and account for heat energy injections into and extractions from the thermal mass of simulated ground loop field, for up to 100 years; and (iii), adjust the ground loop heat exchanger (GLHE) configurations and sizes during simulation operations to meet user-specified minimum or maximum heat pump entering fluid temperatures, while satisfying the required heating and cooling loads supplied as input to the computer simulation system.

Based on theoretical simulations of proposed ground loop configurations, the ground loop engineer is urged to select, for construction, the ground loop field configuration having the best simulated performance.

However, it should be noted that all conventional ground loop simulation systems make several simplifications and assumptions during borehole temperature and heat transfer simulations, which cannot not be ignored without risk of predictive error.

First, conventional computer simulation systems assume that the deep-Earth environment is homogeneous over the depths of modeling involved (e.g. 0-600 feet deep) which is certainly not true for most geological environments, which include many geological strata.

Secondly, such computer simulation systems completely ignore the presence of underground water, including aquifers, and the effects that such resources have on the thermal conductivity and diffusivity properties of the Earth's mass in ground loop fields, and the transfer of heat energy by operation of thermal transfer and groundwater hydraulics.

Thirdly, such computer simulation systems assume that the temperature along each ground heat exchanger (i.e. borehole) is constant along its length, which is certainly not the case for concentric-tube ground heat exchangers which exchange heat energy with the deep Earth along its outer flow channel as the water flows back up towards the surface of the Earth.

Also, as a general rule, conventional ground loop simulation systems only employ in situ methods for estimating the thermal conductivity and thermal diffusivity parameters for the ground environment, where a GLHE is being designed and planned for construction. Then, the computer simulation uses these estimated ground parameters to predict the temperature characteristics of the boreholes in different ground loop heat exchanger (GLHE) configurations, generated in response to the expected thermal loads of the building involved in the simulation.

While conventional ground loop simulation systems represent the industry's best efforts to mathematically model and simulate the performance characteristics of potential ground loop heat exchanger (GLHE) arrangements, using analytical and numerical solutions to the thermal problems which they address, the simplifications and assumptions made such by such software simulation systems do not recognize the complex realities of most ground loop heat exchanger (GLHE) environments.

Also, conventional ground heat exchangers (GHEs) have not been designed or constructed to perform with heat energy transferring efficiencies or capacities as otherwise physically and thermodynamically possible.

Also, conventional techniques for in situ measurement of the thermal conductivity and thermal diffusivity of the ground environment have not provided adequate insight into the actual performance of GHEs and GLHEs in particular deep Earth environments in which they are installed.

Consequently, the available thermal energy reserves stored within deep Earth environments have not been fully, efficiently and economically harnessed for cooling and heating applications, placing the benefits of geothermal energy out of the hands of most in America and around the world.

Thus, there has been a great need in the geothermal ground source heat pump industry for an alternative approach to conventional “simulation-driven” ground loop design methodologies, including better ways to measure the performance of ground heat exchangers (GHEs) and ground loop heat exchangers (GLHEs), while avoiding the shortcomings and drawbacks of prior art apparatus and methodologies.

### OBJECTS AND SUMMARY OF THE PRESENT INVENTION

Accordingly, it is a primary object of the present invention to provide a new and improved method of and apparatus for designing and constructing geothermal ground loop subsystems, free of the shortcomings and drawbacks of prior art apparatus and methodologies.

Another object of the present invention is to provide a new and improved apparatus for in situ measuring the capacity of ground heat exchanger (GHE) installations to transfer heat energy with the surrounding deep Earth environment.

Another object of the present invention is to provide a new and improved method of in situ measuring the capacity of a GHE installation to transfer heat energy with its surrounding deep Earth environment.

Another object of the present invention is to provide such a method of in situ measuring the capacity of concentric-tube and U-tube type GHEs installed in diverse deep Earth environments.

Another object of the present invention is to provide a new and improved spreadsheet enthalpy-based heat transfer rate calculator program for use in measuring the energy performance of GHEs and ground loop heat exchanging (GLHE) subsystems installed in deep Earth environments.

Another object of the present invention is to provide a new and improved GHE performance test instrument capable of producing a controlled flow of water at a controlled output temperature while connected to a test GHE installation during an enthalpy-based method of measuring the heat transfer rate of the GHE installation in a deep Earth environment.

Another object of the present invention is to provide a new and improved method designing and constructing a ground loop heat exchanging (GLHE) subsystem using GHEs having heat transfer rate (HTR) performance characteristics that have been empirically-tested in particular deep Earth environments.

Another object of the present invention is to provide a method and apparatus for better guaranteeing geothermal system performance, as required in performance-contract based energy saving programs.

Another object of the present invention is to provide novel methods of and instrumentation for measuring the heat transfer rate (HTR), flow work rate (FWR) and energy efficiency ratio (EER), and heat transfer efficiency (HTE) of ground heat exchanger (GHE) installations so that engineers can make rational decisions on whether or not to use a particular class, type or design of ground heat exchanger to construct a ground loop heat exchanging (GLHE) subsystem for a particular geothermal system project, planned for construction at a specific ground loop site.

Another object of the present invention is to provide a wireless portable GHE performance testing and monitoring system and network capable of acquiring performance data on GHE installations, in diverse geological environments and operating environments, so that empirical heat transfer rate (HTR) surveys can be produced using a standardized high-efficiency closed-loop type concentric-type GHE.

Another object of the present invention is to provide a such wireless ground heat exchanger performance testing and monitoring system for documenting the performance characteristics of test ground heat exchangers (GHEs) installed in diverse geological and operating environments, and providing geothermal engineers with a useful performance data to help design and construct high-performance ground loop heat exchangers (GLHEs) of optimized design.

Another object of the present invention is to provide a method of measuring and recording incremental changes in the deep Earth temperature in a ground loop test site, using multiple portable enthalpy-based GHE performance test systems.

Another object of the present invention is to provide an Internet-based network of wireless enthalpy-based GPS-tracking GHE performance test instrumentation systems deployed over the Earth, and communication with a centralized data logging and recording station, and accessible by a remote database server and a plurality of client systems supporting Web-based communication interfaces.

Another object of the present invention is to provide an Internet-based network of wireless enthalpy-based GPS-tracking GHE performance test instrumentation systems deployed over the Earth, wherein each GPS-tracking GHE performance test instrumentation system can be remotely controlled, operated and monitored during GHE performance test operations via a wireless Web-based communication interface, so that thermal loading of the GHE installation can be remotely controlled throughout an entire test operation.

Another object of the present invention is to provide an enthalpy-based GHE Performance Test Instrumentation System, employing a Web-enabled onboard system computer that has been programmed to perform a number of important functions, including: (i) controlling and managing the operation of the enthalpy-based GHE Performance Test Instrumentation System during all phases of its performance test operations; (ii) enabling the remote programming of test parameters (i.e. inlet temperature of water flowing into the GHE installation, and the volumetric flow rate of water flowing through the GHE installation) using a Web-based browser running on the remote computer system, in communication with system computer, over a wired or wireless communication link (e.g. Internet connection); and (iii) providing sufficient communication interfaces to support digital communication between the digital data logger/recorder and the remote computer system, during performance test operations.

Another object of the present invention is to provide an enthalpy-based GHE Performance Test Instrumentation System, wherein during performance testing operations, a remote wireless computer system is used to establish a communication link with its system computer, and periodically import blocks of test data logged and recorded by a data logger/recorder, into a Spreadsheet GHE performance calculator program, for processing and calculation of GHE performance measures of the present invention, and display on the LCD panel of the remote computer system.

Another object of the present invention is to provide an enthalpy-based GHE Performance Test Instrumentation System, wherein a Web-browser or a Web-enabled application running on a remote computer system is used to remotely program the test parameters (e.g. control variables) such as (Tᵢₙ, \dot{V}_{ghe}) used during each GHE performance test, and that its system computer is programmed to automatically coordinate and control the GHE Performance Instrument System so that the GHE performance testing process of the present invention (having thermal loading and unloading cycles) can be carried out in an automated (or semi-automated manner and remotely monitored using the remote computer system, which may be located anywhere on Earth, relative to the GHE test site, while in wireless digital communication with the wireless GHE Performance Test Instrument.

Another object of the present invention is to provide an enthalpy-based GHE Performance Test Instrumentation System, employing a remote computer system that is capable of generating, on a quasi-real-time basis, GHE Performance Charts in accordance with the principles of the present invention.

Another object of the present invention is to provide a method of creating a GPS-indexed heat transfer rate (HTR) performance database using empirically obtained heat transfer rate (HTR) performance surveys taken using a closed-loop concentric-type GHE and GPS-tracking enthalpy-based GHE performance test instrumentation, so that geothermal engineers have empirical knowledge of the potential capacity of specific regions of Earth mass to exchange heat energy with such types of ground heat exchangers, based on scientific research and empirical investigation.

Another object of the present invention is to provide a method of creating a GPS-indexed heat transfer rate (HTR) performance database, by combining empirical heat transfer rate (HTR) measurements with spatially corresponding hydro-geological measurements of underground ground water conditions.

Another object of the present invention is to provide a novel method of measuring and creating records of deep Earth temperature changes in the ground loop field of a geothermal heat pump system.

Another object of the present invention is to provide a novel method of creating GPS-indexed heat transfer rate (HTR) performance measurement maps of the Earth's subsurface.

Another object of the present invention is to provide a method of performance-based ground loop engineering that employs scientific instruments and techniques to measure and gauge the actual performance of GHE installations on ground loop construction sites, prior to designing GLHE systems for construction.

Another object of the present invention is to provide a portable enthalpy-based GHE performance test instrumentation system, and enthalpy-based GHE performance calculator program, which allows ground loop engineers to accurately measure four very useful performance figures for GHEs and GLHE subsystems.

Another object of the present invention is to provide performance-based ground loop engineering techniques that provide a better way to design and construct high-performance ground loop subsystems in diverse geological conditions, and also predict and verify the performance characteristics of such subsystems during the lifetime of geothermal systems in they are deployed.

Another object of the present invention is to provide a portable enthalpy-based test instrumentation system that measures the Heat Transfer Rate (HTR) of any ground heat exchanger, measured in units of [BTU/Hr], and based on the volume/mass flow rate and the inlet and outlet temperature and pressure of water flowing through the ground heat exchanger during performance testing operations.

Another object of the present invention is to provide a portable enthalpy-based test instrumentation system that measures the Flow Work Rate (FWR) of any ground heat exchanger, measured in units of [BTU/Hr] and [HP], and based on the volume/mass flow rate and the inlet and outlet pressure of water flowing through the ground heat exchanger during performance testing operations.

Another object of the present invention is to provide a portable enthalpy-based test instrumentation system that measures the Energy Efficiency Ratio (EER) of any ground heat exchange (GHE), measured in dimensionless units, and equal to the ratio of the empirically measured HTR and FWR of the GHE during performance testing operations. Essentially, the EER for a GHE, as well as a GLHE subsystem, is a coefficient of performance (COP) measure, based on the ratio of desired (heat) output [BTU/Hr] to the required work (energy) input [BTU/HR].

Another object of the present invention is to provide a portable enthalpy-based test instrumentation system that measures the Heat Transfer Efficiency (HTE) of any ground heat exchanger (GHE) installation, measured in dimensionless units, and equal to the ratio of (i) the empirically-measured enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE.

Another object of the present invention is to provide a portable enthalpy-based test instrumentation system which provide new forms of thermodynamic evidence which engineers can use when recommending a particular geothermal system design as part of an energy-saving building solution, based on an energy savings performance contract, demanding specific levels of performance and accountability during its lifetime.

Another object of the present invention is to provide a enthalpy-based test instrumentation system that measures the HTR, FWR, EER and HTE measures of performance for ground loop heat exchanging (GLHE) subsystems formed from an arrangement of GHEs, based on similar measurements taken on the GLHE subsystem, providing a new and improved way of assessing the performance of GLHEs.

Another object of the present invention is to provide a portable enthalpy-based test instrumentation system that can be used to test the performance of virtually all types of concentric-tube ground heat exchangers, as well as U-tube ground heat exchangers installed in boreholes, in diverse deep Earth environments.

Another object of the present invention is to provide a method of ground loop engineering involving the use of ground heat exchangers (GHEs) that have been assigned heat transfer rate (HTR) performance characteristics determined through empirical performance testing in particular deep Earth environments.

Another object of the present invention is to provide a performance-based method of ground loop engineering ground loop heat exchanging (GLHE) subsystems.

Another object of the present invention is to provide a geothermal system employing a concentric-tube type GLHE subsystem interfaced with the geothermal equipment (GTE) of building, by way of a plate heat exchanger (PHE) for interfacing substantially different hydraulic flows required through the GTE and the GLHE subsystem, and wherein the PHE exchanges heat energy between the GTE and the GLHE subsystem so that the GLHE will be operated at inlet water temperatures that enable maximum heat transfer rate (HTR) performance when the GTE is fully loaded.

Another object of the present invention is to provide such a geothermal system, wherein a plate heat exchanger (PHE) is used to establish a first hydraulic loop between the GTE and the PHE and a second hydraulic loop between GLHE and the PHE, and wherein the volumetric flow rate within the second hydraulic loop is typically at least two or more times greater than the volumetric flow rate within the first hydraulic loop, and the PHE exchanges heat energy between the first and second hydraulic loops so that the GLHE will be operated at inlet water temperatures that enable maximum HTR performance when the GTE is fully loaded.

Another object of the present invention is to provide a new and improved method of and apparatus for controlling the volumetric or mass flow rate of water flowing through the ground loop heat exchanging (GLHE) subsystem in response to real-time measurement and analysis of heat transfer fluid inlet temperature and computed heat transfer rate (HTR) across the GLHE subsystem.

Another object of the present invention is to provide apparatus in the form of an enthalpy-driven ground loop volumetric flow rate controller that monitors incremental changes in the inlet heat transfer water temperature and HTR across the GLHE subsystem, and in responses thereto, automatically increases or decreases the volumetric flow rate of water flowing through into and out of the GLHE subsystem, to minimize the electrical energy consumption of electronically-controlled ground loop pumps employed to pump water through the GLHE subsystem.

Another object of the present invention is to provide such an enthalpy-driven ground loop volumetric flow rate controller that does not use or require control or timing signals supplied from the controller used to control the operation of refrigerant compressors and other power consuming devices associated with the geothermal equipment (GTE), e.g. geothermal heat pump or chiller, connected to the GLHE subsystem.

Another object of the present invention is to provide an enthalpy-driven ground loop volumetric flow rate controller for controlling both (i) the volumetric flow rate of water flowing through a first hydraulic loop between the geothermal equipment (GTE) and a plate heat exchanger (PHE), and (ii) the volumetric flow rate of water flowing through a second hydraulic loop between the PHE and a GLHE subsystem, wherein the PHE is configured to allow the maximum heat transfer rate (HTR) or load across the GTE to be transferred across the PHE to the GLHE subsystem operating a volumetric flow rate tuned to support the maximum HTR across the GTE.

Another object of the present invention to provide a method of and apparatus for monitoring, logging and recording the HTR, FWR, EER and HTE performance characteristics of any GLHE subsystem installation using an Enthalpy-Based Ground Loop Performance Monitoring Module.

Another object of the present invention to provide such an Enthalpy-Based Ground Loop Performance Monitoring Module, comprising: a programmed microprocessor; a system bus; a memory architecture including RAM, FLASH ROM and hard-disc; a high-speed I/O interface for receiving the inputs from temperature and pressure transducers, volumetric fluid rate meter(s), signals from an onboard GPS transceiver module, and other sensed data inputs; a touch-screen LCD display panel interfaced with system bus/CPU via display controller, for selecting functions and displaying sensed data and calculated performance figures for the system being monitored; a communications module for supporting GSM, WIFI, and Ethernet protocols, with related communication interfaces/ports; antennas for supporting the communication module; a power supply module; a backup battery module; and a compact housing for containing all of the system components.

Another object of the present invention is to provide an improved method designing and constructing a geothermal ground loop subsystem using ground heat exchangers that have been assigned heat transfer rate (HTR) performance characteristics that have been empirically-tested in particular deep Earth environments.

Another object of the present invention is to provide an improved method of measuring the effects of heat transfer to a ground heat exchanger (GHE) test installation in response to thermal influences from the thermal loads of neighboring ground heat exchanger (GHE) installations.

Another object of the present invention is to provide an enthalpy-based ground heat exchanger (GHE) performance calculator using a specific enthalpy table for water during heat transfer rate (HTR) calculations for the ground heat exchanger (GHE) under performance testing.

Another object of the present invention is to provide an Internet-based Network of Wireless Enthalpy-Based GPS-Tracking Ground Heat Exchanger (GHE) Performance Test Instrumentation Systems deployed over the Earth, and communication with a centralized data logging and recording station, and accessible by a remote database server and a plurality of client systems supporting Web-based communication interfaces.

Another object of the present invention is to provide a method of creating a GPS-indexed heat transfer rate (HTR) performance database using empirically obtained heat transfer rate (HTR) performance surveys taken using a closed-loop concentric-type ground heat exchanger and GPS-tracking enthalpy-based HTR performance test instrumentation, so that geothermal engineers have empirical knowledge of the potential capacity of specific regions of Earth mass to exchange heat energy with such types of ground heat exchangers, based on scientific research and empirical investigation.

Another object of the present invention is to provide a method of creating a GPS-indexed heat transfer rate (HTR) performance database, by combining empirical heat transfer rate (HTR) measurements with spatially corresponding hydro-geological measurements of underground ground water conditions.

Another object of the present invention is to provide a method of interfacing geothermal equipment (GTE) in a building, with a ground loop heat exchanging (GLHE) subsystem installed in the deep Earth environment outside of said building.

Another object of the present invention is to provide an enthalpy-based GHE performance test instrumentation system, employing a remote computer system that is capable of generating, on a quasi-real-time basis, GHE performance charts for each GHE installation that has been performance tested.

Another object of the present invention is to provide an enthalpy-based ground loop performance monitoring module operably connected to a ground loop heat exchanging (GLHE) subsystem installation, for monitoring, logging and recording the energy performance characteristics thereof.

Another object of the present invention is to provide a method of determining the maximum flow rate through a GLHE subsystem having fixed-speed ground loop circulation pumps and being connected to geothermal equipment (GTE) employing fixed-speed refrigerant compressor.

Another object of the present invention is to provide a method of determining the maximum and minimum flow rates through a GLHE subsystem having variable-speed ground loop circulation pumps and being connected to geothermal equipment (GTE) employing a variable-speed refrigerant compressor.

Another object of the present invention is to provide a method of determining the maximum and minimum flow rates through a GLHE subsystem having variable speed ground loop pumps and being connected to multi-stage geothermal equipment (GTE) employing multiple variable-speed refrigerant compressors a ground loop heat exchanging (GLHE) subsystem employing multiple ground heat exchangers (GHEs) installed in the loop field and connected together with ground loop water pumps and underground piping in a first hydraulic loop that is thermally interfaced with a second hydraulic loop by way of a plate heat exchanger (PHE), wherein the second hydraulic loop contains multiple ground source heat pumps (GSHPs) and/or other geothermal equipment (GTE) associated with the building to be environmentally controlled; and wherein an Enthalpy-based GLHE subsystem performance monitoring module is installed in said second hydraulic loop and configured to monitor and record the performance of the GLHE subsystem during geothermal system operation.

A process for controlling the flow rate of heat transferring fluid flowing through a ground loop heat exchanging (GLHE) subsystem constructed from one or more ground heat exchangers (GHE) and being operably connected to geothermal equipment (GTE) including a refrigerant compressor that is associated with a geothermal system, comprising the steps of: (a) monitoring incremental changes the temperature of heat transferring fluid entering into the GLHE subsystem, and also the heat transfer rate (HTR) across the GLHE subsystem; and (b) in response to said monitored incremental changes temperature and the HTR, automatically incrementally increasing or decreasing the flow rate of the heat transferring fluid flowing through the GLHE subsystem.

Another object of the present invention is to provide apparatus for controlling the flow rate of heat transferring fluid flowing through a ground loop heat exchanging (GLHE) subsystem constructed from one or more ground heat exchangers (GHE) and one or more electronically-controlled pumps installed in a GLHE loop, and being operably connected to geothermal equipment (GTE) including a refrigerant compressor that is associated with a geothermal system.

Another object of the present invention is to provide an enthalpy-driven ground loop volumetric flow rate controller that monitors incremental changes in the inlet water temperature and HTR across the GLHE subsystem, and in responses thereto, automatically increases or decreases the volumetric flow rate of water flowing through into and out of the GLHE subsystem, to minimize the electrical energy consumption of electronically-controlled ground loop pumps employed to pump water through the GLHE subsystem.

Another object of the present invention is to provide an enthalpy-driven ground loop volumetric flow rate controller that does not use or require control or timing signals supplied from the controller used to control the operation of refrigerant compressors and other power consuming devices associated with the geothermal equipment (GTE), e.g. geothermal heat pump or chiller, connected to the GLHE subsystem.

Another object of the present invention is to provide an enthalpy-driven ground loop volumetric flow rate controller for controlling both (i) the volumetric flow rate of water flowing through a first hydraulic loop between the geothermal equipment (GTE) and a plate heat exchanger (PHE), and (ii) the volumetric flow rate of water flowing through a second hydraulic loop between the PHE and a GLHE subsystem, wherein the PHE is configured to allow the maximum heat transfer rate (HTR) or load across the GTE to be transferred across the PHE to the GLHE subsystem operating a volumetric flow rate tuned to support the maximum HTR across the GTE.

Another object of the present invention is to provide a process for controlling the flow rate of aqueous-based heat transferring fluid flowing through a ground loop heat exchanging (GLHE) subsystem constructed from one or more ground heat exchangers (GHEs) connected in ground loop through which aqueous-based heat transferring fluid is circulated using one or more electronically-controlled pumps, and connected to geothermal equipment (GTE) having one or more refrigerant compressors.

These and other objects of the present invention will become apparent hereinafter and in the Claims to Invention appended hereto.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below.

FIG. 1A is a schematic representation of the globally-extensive, Mobile-Wireless GPS-Tracking Ground Heat Exchanger (GHE) Performance Test Instrumentation Network of the present invention shown comprising a plurality of wireless Portable GPS-Based Enthalpy-Based GHE Performance Test Instrumentation Systems as shown in FIG. 1A, wherein each such system is connected to a ground heat exchanger (GHE) installation, and collecting GPS-indexed performance data relating to the ground heat exchanger (GHE) installation under performance testing operations;

FIG. 1B is a schematic illustration view showing a single Portable Enthalpy-Based GHE Performance Test Instrumentation System of the present invention connected to a concentric-tube geothermal ground heat exchanger (GHE) installed in a deep Earth environment, during energy-based performance testing operations, using a RF transceiver station to receive measured inlet and outlet temperatures and pressures and volumetric flow rates of the water through the ground loop, and a remote data logger/recorder and database server, operably connected to the infrastructure of the Internet, for processing collected test data and computing energy performance measures in accordance with the principles of the present invention so that one or more Web-enabled remote client computers can access such performance data and generated performance charts and reports for ground loop system engineering purposes;

FIG. 1C is a first perspective view of a single Portable Enthalpy-Based GHE Performance Test Instrumentation System, as schematically depicted in FIG. 1B, shown being electrically powered by an external power generator, while thermally loading a ground heat exchanger (GHE) at a test site during GHE performance testing operations and collecting, processing and displaying test data—in real-time—using the Enthalpy-Based GHE Performance Test Instrumentation System of the present invention;

FIG. 1D is a second perspective view showing the Enthalpy-Based GHE Performance Test Instrumentation System of FIG. 1C, shown without the electrical power generator connected thereto;

FIG. 2A is a first perspective view of the Portable Enthalpy-Based GHE Performance Test Instrumentation System of the present invention shown in FIGS. 1C and 1D, but with the cover portion of its rugged housing arranged in an open configuration revealing the installation of the 3G/4G WIFI router, GSM-enabled data logger, recorder and transmitter, water temperature controller, and volumetric pump flow rate controller on the inside panel of the hinged cover portion of the its rugged housing, and with its molded thermal insulation packing material removed revealing certain of its various system components, including its water heating and pumping module, volumetric flow meter, inlet and outlet water temperature transducers, inlet and outlet water pressure transducers, electrical grounding post, and other components;

FIG. 2B is a second perspective view of the Portable Enthalpy-Based GHE Performance Test Instrumentation System of the present invention shown in FIG. 2A, but with its cover housing portion arranged in a closed configuration;

FIG. 3A is a first perspective view of the water heating, pumping and measuring assembly of the present invention, shown removed from the housing of the Portable Enthalpy-Based GHE Performance Test Instrumentation System shown in FIGS. 2A through 2B, and comprising an electronically-controlled water pump, electric heat elements contained within a pair of joined together water flow channels, volumetric flow meter, temperature and pressure transducers installed at the outer inlet and outlet ports of the apparatus, a water fill port and an air-release valve;

FIG. 3B is an isometric view of a first section of the water heating, pumping and measuring assembly of the present invention, illustrated in FIG. 3A, and containing the electrical heating elements employed in this first section thereof;

FIG. 3C is a cross-sectional view of the section of the water heating, pumping and measuring assembly of the present invention, shown in FIG. 3B;

FIG. 3D is a perspective view of an electric heating element employed in the water heating, pumping and measuring assembly shown in FIG. 3A;

FIG. 4A is a schematic diagram of the Portable Enthalpy-Based GHE Performance Test Instrumentation System shown in FIGS. 1A through 2B, operably connected to a concentric-tube type geothermal ground heat exchanger, and showing its primary components, namely, a ground loop water pumping module with flow rate control, a ground loop water heating module with water temperature control module, a data logger/recorder, a portable computer system interfaced with the data logger/recorder and running a spreadsheet enthalpy-based spreadsheet GHE performance calculator program, and a system controller for remotely controlling the components of the enthalpy-based GHE Performance Test Instrumentation System, via a wireless communication link over the Internet or other network;

FIG. 4B is a schematic diagram of the Portable Enthalpy-Based GHE Performance Test Instrumentation System of FIGS. 1A through 2B, shown connected to a concentric-tube type ground heat exchanger (GHE) by way of its system inlet and outlet pipes, and supplying a constant flow rate of water to the ground heat exchanger, at a constant inlet temperature during energy performance testing operations;

FIG. 4C is a schematic diagram of the Portable Enthalpy-Based GHE Performance Test Instrumentation System of FIGS. 1A through 2B, shown connected to a conventional U-tube type ground heat exchanger (GHE) by way of its system inlet and outlet pipes, and supplying a constant flow rate of water to the ground heat exchanger, at a constant inlet temperature during energy performance testing operations;

FIG. 5 is a schematic representation of an energy conservation balance conducted for a generalized thermodynamic system involving heat transfer rate and work rate functions;

FIG. 5A is a schematic representation of an energy conservation balance conducted for any concentric-type ground heat exchanging system when operating at temperatures Tᵢₙ≠Tₒᵤₜ≠T_{de} with Tᵢₙ=95° F. and the system is at thermal equilibrium;

FIG. 5B is a schematic representation of an energy conservation balance conducted for any U-tube type ground heat exchanging system when operating at temperatures Tᵢₙ≠Tₒᵤₜ≠T_{de} with Tᵢₙ=95° F. and the system at thermal equilibrium;

FIG. 6 is a schematic representation defining the system boundaries/control volume for any U-tube type ground heat exchanging system, being analyzed for energy conservation balance as illustrated in FIG. 5B;

FIG. 7A is a schematic representation defining the system boundaries/control volume for ground loop water pumping and heating module of the GHE performance testing instrument of the present invention, being analyzed for energy conservation balance as illustrated in FIG. 7B, when operating at temperatures Tᵢₙ≠Tₒᵤₜ≠T_{de} with Tᵢₙ=95° F. and the system is at thermal equilibrium;

FIG. 7B is a schematic representation of an energy conservation balance conducted for the ground loop water pumping and heating module of FIG. 7A when operating at temperatures Tᵢₙ≠Tₒᵤₜ≠T_{de} with Tᵢₙ=95° F. and the system is at thermal equilibrium;

FIG. 8A is a schematic representation defining the system boundaries/control volume for any concentric-type ground heat exchanging (GHE) system, being analyzed for energy conservation balance when operating at temperatures Tᵢₙ=Tₒᵤₜ=T_{de} and the system is at thermal equilibrium;

FIG. 8B is a schematic representation defining the system boundaries/control volume for any concentric-tube type ground heat exchanging (GHE) system, being analyzed for energy conservation balance as illustrated in FIG. 8A;

FIG. 8C is a schematic representation defining the system boundaries/control volume for any U-tube ground heat exchanging (GHE) system, being analyzed for energy conservation balance when operating at temperatures Tᵢₙ=Tₒᵤₜ=T_{de} and the system is at thermal equilibrium;

FIG. 8D is a schematic representation of an energy conservation balance conducted for any U-tube ground heat exchanging system, being analyzed for energy conservation balance when operating at temperatures Tᵢₙ=Tₒᵤₜ=T_{de} and the system is at thermal equilibrium;

FIG. 8E is a schematic representation defining the system boundaries/control volume for the ground loop water pumping and heating module of the GHE performance testing instrument of the present invention, being analyzed for energy conservation balance, depicted in FIG. 8F, when operating at temperatures Tᵢₙ=Tₒᵤₜ=T_{de} and the system is at thermal equilibrium;

FIG. 8F is a schematic representation of an energy conservation balance conducted for the ground loop water pumping and heating module of FIG. 8E, when operating at temperatures Tᵢₙ=Tₒᵤₜ=T_{de} and the system is at thermal equilibrium;

FIG. 8G is a schematic representation of an energy conservation balance conducted for any “real” concentric-tube or U-tube ground heat exchanger (GHE) system when operating at temperatures Tᵢₙ≠Tₒᵤₜ≠T_{de} the system is at thermal equilibrium;

FIG. 8H is a schematic representation of an energy conservation balance conducted for any “ideal” concentric-tube or U-tube ground heat exchanger (GHE) system when operating at temperatures Tᵢₙ≠Tₒᵤₜ=T_{de} and the system is at thermal equilibrium;

FIG. 8I is a definition of heat transfer efficiency (HTE) for any concentric-tube or U-tube ground heat exchanger (GHE) based on the measured enthalpy of water entering and leaving the ground heat exchanger (GHE);

FIGS. 9A1 and 9A2, taken together, provide a schematic representation of the graphical user interface (GUI) component of the spreadsheet enthalpy-based GHE performance calculator program of the present invention, used to calculate the actual heat transfer rate (HTR), flow work rate (FWR), energy efficiency ratio (EER) and the heat transfer efficiency (HTE) energy-based performance figures for a ground heat exchanger (GHE) installation under performance testing;

FIG. 9B is a table listing the specific enthalpy (h) values of sub-cooled water over a particular range of pressure and temperature values, expressed in units of [BTUs/lbm];

FIGS. 10A through 10I, taken together, provide a flow chart describing the primary steps of the method of measuring the energy performance of a ground heat exchanger (GHE) installation, during a GHE performance test conducted using the Portable Enthalpy-Based GHE Test Instrumentation System shown in FIGS. 1A through 2G;

FIG. 11A is a GHE Performance Chart (\dot{Q}_{ghe} vs. Tᵢₙ) for constant values of volumetric flow rate \dot{V} within the operating limits of the performance test;

FIG. 11B is a GHE Performance Chart (\dot{Q}_{ghe} vs. ΔT_{driving}) constant values of volumetric flow rate \dot{V} within the operating limits of the performance test;

FIG. 11C is a GHE Performance Chart (\dot{W}_{ghe} vs. Tᵢₙ) for constant values of volumetric flow rate \dot{V} within the operating limits of the performance test;

FIG. 11D is a GHE Performance Chart (EER_{ghe} vs. Tᵢₙ) for constant values of volumetric flow rate \dot{V} within the operating limits of the performance test;

FIG. 11E is a GHE Performance Chart (HTE_{ghe} vs. Tᵢₙ) for constant values of volumetric flow rate \dot{V} within the operating limits of the performance test;

FIG. 12A is a performance chart plotting a GHE Performance Chart (\dot{Q}_{ghe} vs. \dot{V}_{ghe}) for constant values of inlet water temperature Tᵢₙ within the operating limits of the performance test;

FIG. 12B is a GHE Performance Chart (\dot{W}_{ghe} vs. \dot{V}_{ghe}) for constant values of inlet water temperature Tᵢₙ within the operating limits of the performance test;

FIG. 12C is a GHE Performance Chart (EER_{ghe} vs. \dot{V}_{ghe}) for constant values of inlet water temperature Tᵢₙ within the operating limits of the performance test;

FIG. 12D is a GHE Performance Chart (HTE_{ghe} vs. \dot{V}_{ghe}) for constant values of inlet water temperature Tᵢₙ within the operating limits of the performance test;

FIG. 13A through 13D, taken together, sets forth a flow chart describing the steps of the method of engineering a ground loop heat exchanging (GLHE) subsystem for medium and large scale geothermal system;

FIG. 14 is a schematic diagram of a geothermal system of the present invention employing a concentric-tube type GLHE subsystem interfaced with the geothermal equipment (GTE) of a building, using a plate heat exchanger (PHE) to establish a first hydraulic loop between the GTE and the PHE and a second hydraulic loop between GLHE and the PHE, and wherein the volumetric flow rate within the second hydraulic loop is typically at least two or more times greater than the volumetric flow rate within the first hydraulic loop, and the PHE exchanges heat energy between the first and second hydraulic loops in a highly efficiently manner so that the GLHE will be operated at inlet water temperatures that enable maximum heat transfer rate (HTR) performance when the GTE is fully loaded;

FIG. 15A is a schematic representation of a first completed geothermal heat pump system including a ground loop heat exchanging (GLHE) subsystem employing a pair of ground heat exchangers (GHEs) installed in the loop field and connected together via underground piping to a geothermal heat pump and associated ground loop water pumps, and showing an Enthalpy-Based Ground Loop Performance Monitoring Module of the present invention, mounted within the pump room of a building in which the completed geothermal heat pump system has been installed and is operating, in cooperation with its air handling subsystem, under the control of the central environmental control system of the building;

FIG. 15B is a block schematic diagram showing the primary components in the enthalpy-based ground loop performance monitoring module of the present invention, shown in FIGS. 15A and 16;

FIG. 15C is a schematic representation defining the system boundaries/control volume for the completed geothermal heat pump system and associated GLHE subsystem of FIG. 17A, being analyzed for energy conservation balance when operating at temperature Tᵢₙ≠Tₒᵤₜ≠T_{de} and the system is otherwise in a state of thermal equilibrium or quasi-equilibrium;

FIG. 16 is schematic representation of a second completed geothermal heat pump system including a ground loop heat exchanging (GLHE) subsystem employing five (5) ground heat exchangers (GHEs) installed in the loop field and connected together with ground loop water pumps and underground piping in a first hydraulic loop that is thermally interfaced with a second hydraulic loop by way of a plate heat exchanger (PHE), as shown in FIG. 14, wherein the second hydraulic loop contains five ground source heat pumps (GSHPs) and other geothermal equipment (GTE) associated with the building to be environmentally controlled, and wherein an Enthalpy-Based Ground Loop Performance Monitoring Module is installed in the second hydraulic loop and configured to monitor and record the performance of the GLHE subsystem during geothermal system operation;

FIG. 17 is a schematic diagram of a geothermal system of the present invention employing a concentric-tube type GLHE subsystem interfaced with the GTE of a building using a PHE as shown in FIG. 14, and an enthalpy-based GLHE subsystem performance monitoring module deployed in the GLHE loop of the system for the purpose of measuring the HTR performance across the GLHE subsystem while the electrical load on the refrigerant compressor is measured, during the tuning of the ground loop flow rate in accordance with the principles of the present invention;

FIG. 18A is a flow chart describing the primary steps of the method of determining the maximum volumetric flow rate through a GLHE subsystem having fixed-speed ground loop circulation pumps and being connected to geothermal equipment (GTE) employing fixed-speed refrigerant compressor;

FIG. 18B is a flow chart describing the primary steps of the method of determining the maximum and minimum volumetric flow rates through a GLHE subsystem having variable-speed ground loop circulation pumps and being connected to geothermal equipment (GTE) employing a variable-speed refrigerant compressor;

FIG. 18C is a flow chart describing the primary steps of the method of determining the maximum and minimum volumetric flow rates through a GLHE subsystem having variable speed ground loop pumps and being connected to multi-stage geothermal equipment (GTE) employing multiple variable-speed compressors;

FIG. 19 is a schematic diagram of a geothermal system of the present invention employing a concentric-tube type GLHE subsystem interfaced with the GTE of a building, using a PHE, as shown in FIG. 14, and deploying an enthalpy-driven ground loop volumetric flow rate controller for the purpose of controlling both (i) the volumetric flow rate of water flowing through a first hydraulic loop between the geothermal equipment (GTE) and a plate heat exchanger (PHE), and (ii) the volumetric flow rate of water flowing through a second hydraulic loop between the PHE and a GLHE subsystem, wherein the PHE is configured to allow the maximum heat transfer rate (HTR) or load across the GTE to be transferred across the PHE to the GLHE subsystem operating a volumetric flow rate tuned to support the maximum HTR across the GTE;

FIG. 19A is a schematic block diagram of the primary components in the GLHE pump control module of the present invention, adapted to be interfaced to the enthalpy-based GLHE subsystem performance monitoring module, ECM pump controllers and compressor controller(s), as shown in FIG. 19;

FIGS. 20A and 20B, taken together, set forth a flow chart describing the primary steps carried out the real-time ground loop flow rate control process and controller according to the principles of the present invention, wherein incremental changes in the inlet water temperature and HTR across the GLHE subsystem are monitored, and in responses thereto, the volumetric flow rate of water flowing through into and out of the GLHE subsystem is automatically increased or decreased, to minimize the electrical energy consumption of electronically-controlled ground loop pumps employed to pump water through the GLHE subsystem;

FIG. 21 is schematic representation illustrating multiple of Portable Enthalpy-Based GHE Performance Test Instrumentation Systems being used to measure incremental changes in deep Earth temperature about a ground heat exchanger (GHE) installation, in response to thermal influences from the thermal loads of neighboring ground heat exchanger (GHE) installations; and

FIGS. 22A and 22B set forth a flow chart describing the steps of the method for detecting, measuring and recording incremental changes in the deep Earth temperatures in a planned ground loop field.

### DETAILED DESCRIPTION OF THE ILLUSTRATIVE EMBODIMENTS OF THE PRESENT INVENTION

Referring to the figures in the accompanying Drawings, the various illustrative embodiments of the Portable Enthalpy-Based GHE Performance Test Instrumentation System, and GHE performance testing method of the present invention, will be described in great detail, wherein like elements will be indicated using like reference numerals.

### Considering the Various Factors Impacting the Heat Transfer Rate (HTR) Performance of any Ground Heat Exchanger (GHE) Installed at any Ground Loop Test Site

Before specifying the GLE Process and GHE Performance Test Instrument of the present invention 1 in greater detail, it will be helpful to consider the various factors which impact the heat transfer rate (HTR) performance of any ground heat exchanger (GHE) 2 installed at any ground loop test site, measured in [BTU/hr]. Understanding these factors will help the engineers quickly master the particular requirements of the GLE Process and the GHE Performance Test Instrumentation.

Below is a list of factors impacting the heat transfer rate (HTR) performance of any GHE installation, \dot{Q}_{ghe} regardless of where it is installed on Earth:

(1) the Thermal Potential Difference or TPD (ΔT_{driving}=Tᵢₙ−T_{de}=TPD_{driving}) driving the GHE installation 2 during heat transfer operation, where Tᵢₙ is the inlet water temperature entering the GHE, and where T_{de} is the average deep Earth temperature immediately surrounding the borehole 3 in which the GHE is installed;

(2) the volumetric flow rate of water \dot{V} passing through the GHE installation during cooling and heating modes of heat transfer operation;

(3) the heat transfer properties of the heat exchanging fluid (i.e. water) circulated through the GHE installation;

(4) the thermal conductivity properties associated with GHE components and its thermo-fluidic functions supported along its inner and outer flow channels;

(5) the thermal conductivity properties of the deep Earth environment 5 surrounding the GHE borehole along its vertical length;

(6) the hydro-geological conditions surrounding the GHE borehole, including the presence or absence of aquifers, and other sources of underground water flowing across or through the borehole; and

(7) the volumetric heat capacity of the GHE installation and its surrounding deep Earth environment, and the thermal diffusivity characteristics of the deep Earth environment in which multiple GHEs are installed and connected together to construct a GLHE subsystem at the ground loop field site.

Below, the above factors will be considered in the context of a long felt need for new and improved ways of rationally engineering high-efficiency GLHE subsystems (i.e. “ground loops”) in diverse deep Earth environments.

### The Driving TPD Across the GHE Installation

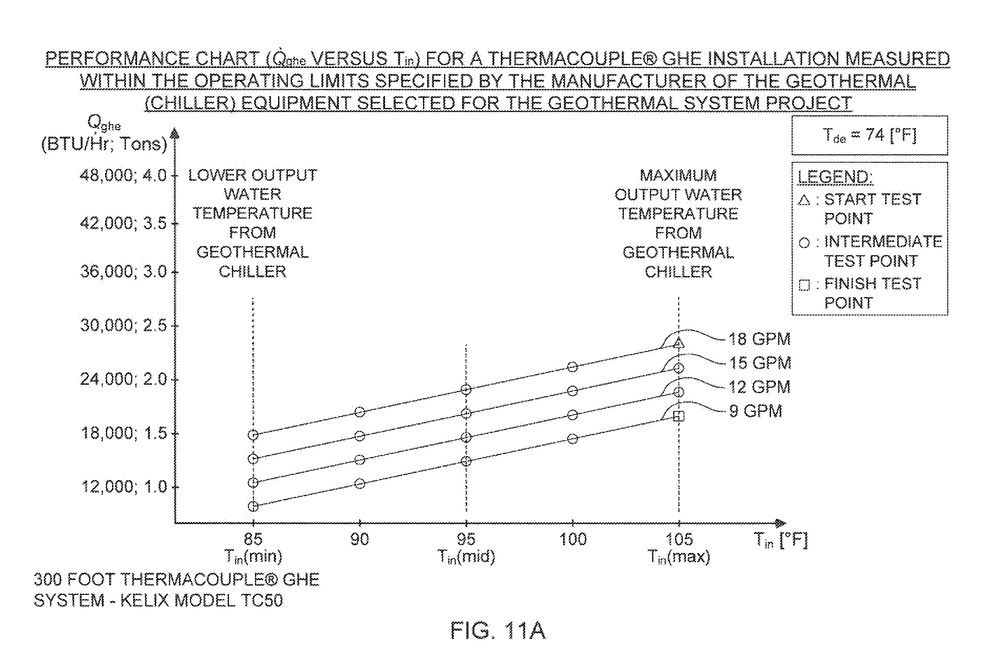

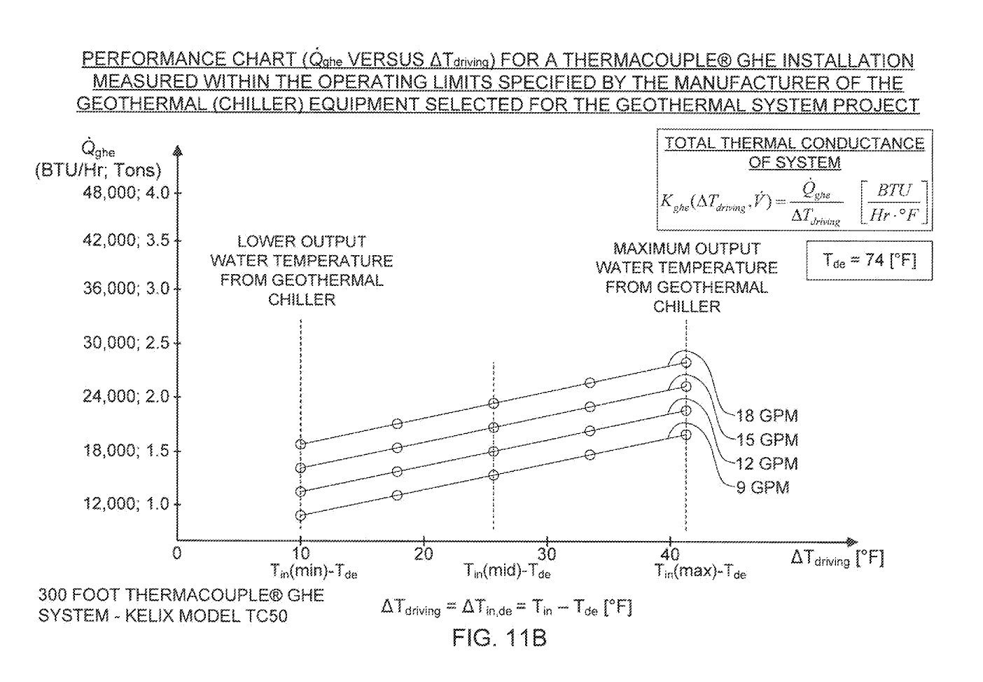

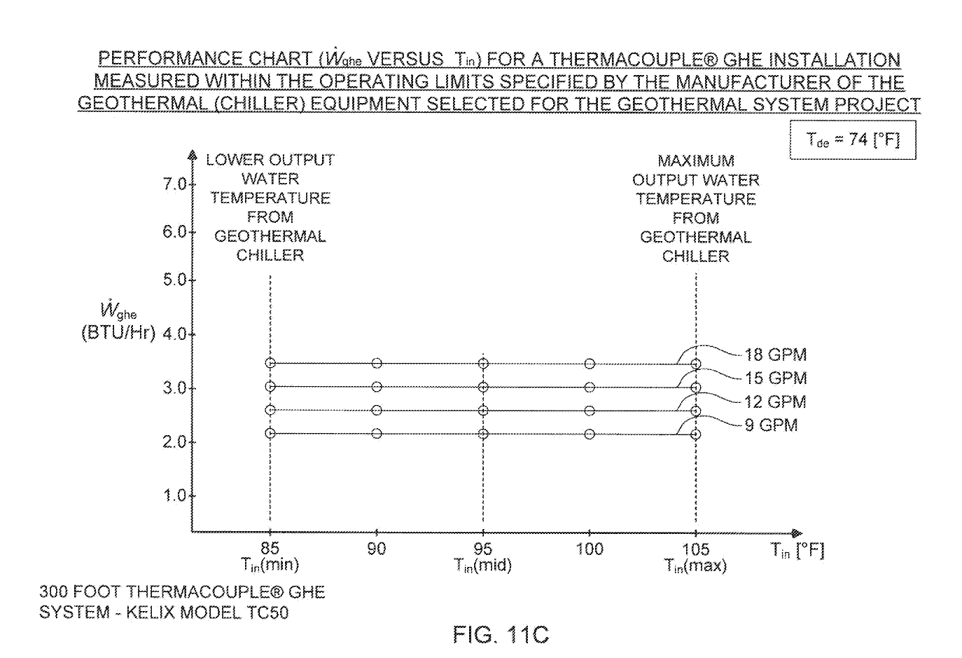

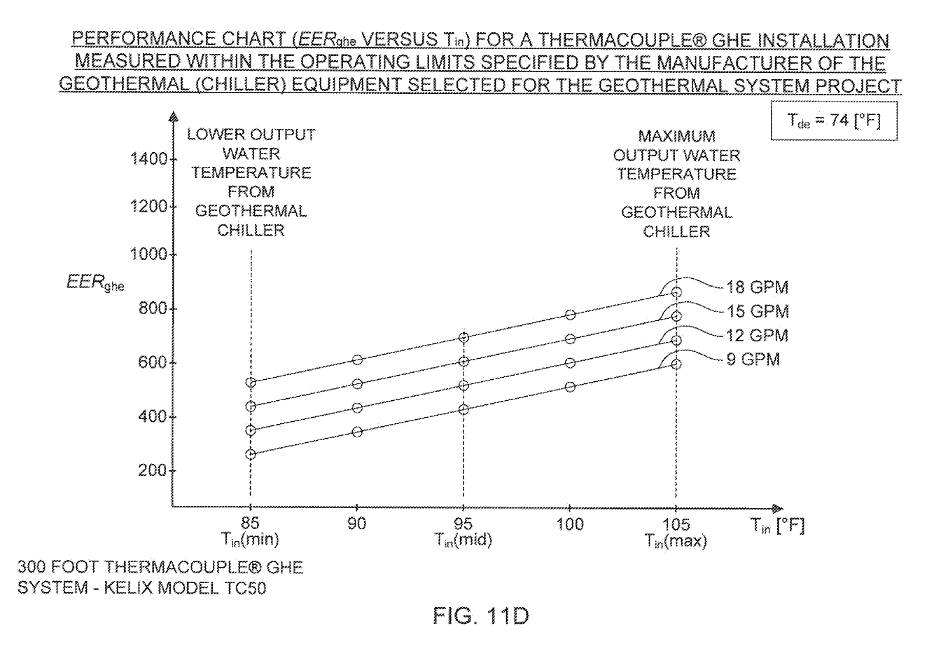

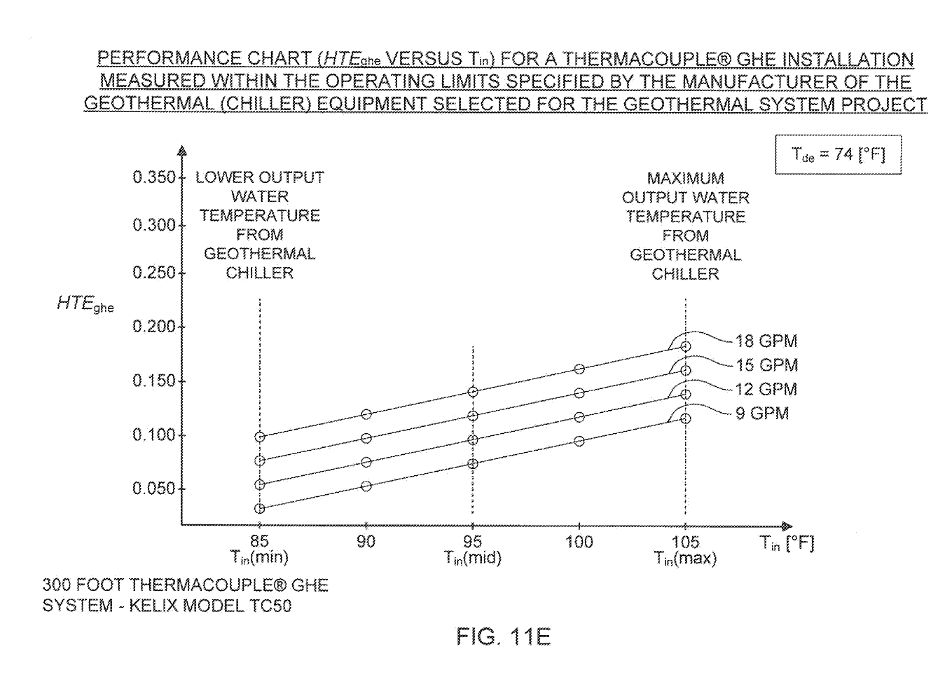

The Driving TPD is the total thermal potential difference (TPD) between the inlet water temperature Tᵢₙ and the deep Earth temperature T_{de}, and represents the total magnitude of thermal potential energy difference that is available to drive a GHE installation when connected to geothermal equipment (GTE), and also during performance testing operations at particular test site. A low value for Driving TPD signifies that the GHE is driven by inlet water temperature having with a temperature state that is to drive the transfer heat energy with the deep Earth environment. The larger the driving TPD, the more likely the GHE will respond by exchanging heat energy with the deep Earth environment, depending on the overall Total Thermal Conductance of the GHE [BTU/Hr-F], as defined in FIG. 11B.

The Performance Test Method of the present invention makes extensive use of the Driving TPD function. Also, the GHE Performance Test Instrument 1, that is used to practice the Method, controls this test variable, by controlling the inlet water temperature Tᵢₙ during performance testing operations. A basic assumption made is that the average deep Earth temperature T_{de} does not change significantly during such performance testing operations, to influence energy calculations supported by the Performance Test Instrumentation 1.

By controlling the inlet water temperature parameter Tᵢₙ during performance testing operations, the Performance Test Instrument 1 is capable of testing any GHE installation across and at the edge of its full range of operation—determined by the geothermal equipment (GTE) selected for use with the GLHE subsystem under design.

It is also well known that the average deep Earth temperature T_{de} about any given GHE can increase over time, i.e. in response to thermal loading caused by the injection and/or extraction of thermal energy from a densely populated ground loop field, in which multiple GHEs are spaced 15 feet or less apart from each other. Thus, to significantly reduce the thermal influence between neighboring GHE installations, across the 300 deep volumetric expanse of any ground loop field, the GLE Process adopts a general design rule on GHE spacing, namely: that each and every GHE shall be installed in vertical boreholes that are spaced at least 20 feet apart from each other, and greater than 20 feet whenever and wherever possible. Also, this spacing requirement simplifies the ground loop sizing process by reducing the thermal influence effects of neighboring GHE installations.

### The Heat Transfer Properties and Volumetric Flow Rate of Water Flowing Through the GHE Installation

As water is the heat transferring medium in the GHE system, both the inlet temperature and volumetric flow rate of water entering the GHE directly influence how much heat energy is carried by the water through the GHE, for exchange with its deep Earth environment, on a rate basis. Like any heat exchanger, if the water flows too slowly through the GHE, then the heat transfer rate will be less than its capacity for a given temperature differential across its heat transferring surfaces. Also, if the water flows too quickly through the GHE, then the heat transfer rate will also be less than its capacity for a given temperature differential across its heat transferring surfaces.

Thus, when attempting to optimize the heat transfer rate across any GHE installation, it is very useful to know what specific rate of heat transfer will result between water flowing through the GHE installation and its deep Earth environment when a particular value of thermal potential difference (TPD) drives the heat transfer surfaces of the GHE installation, while water flows through the GHE installation at a specific volumetric flow rate.

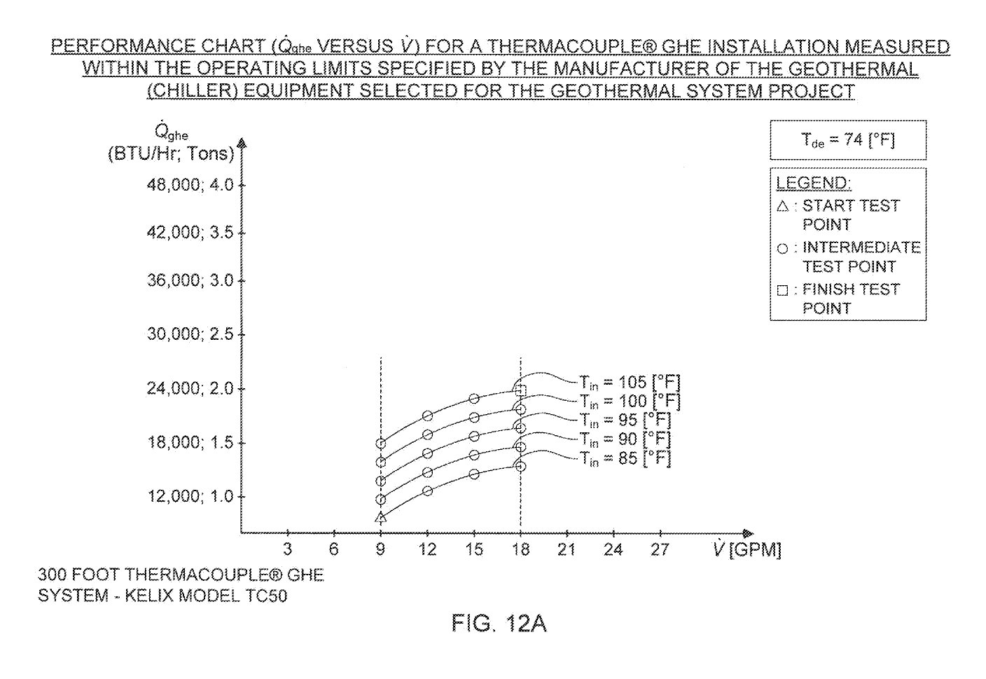

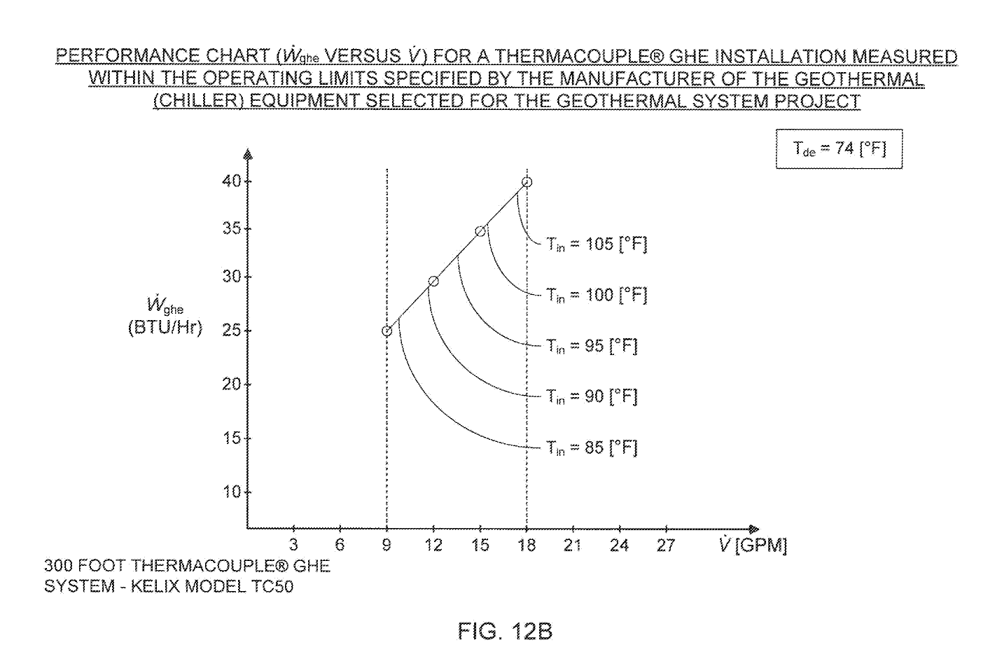

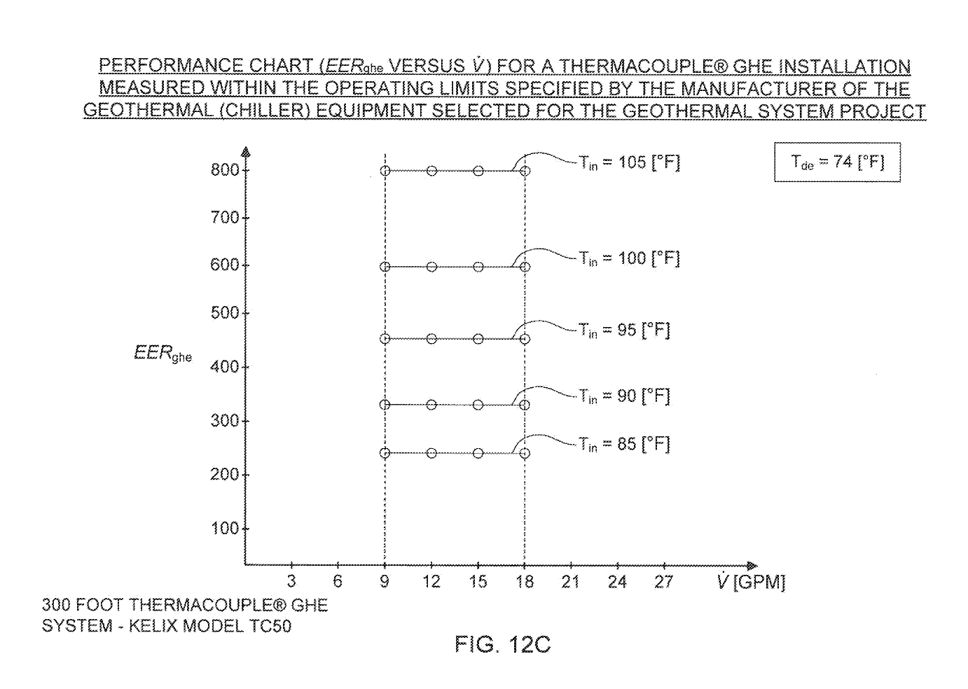

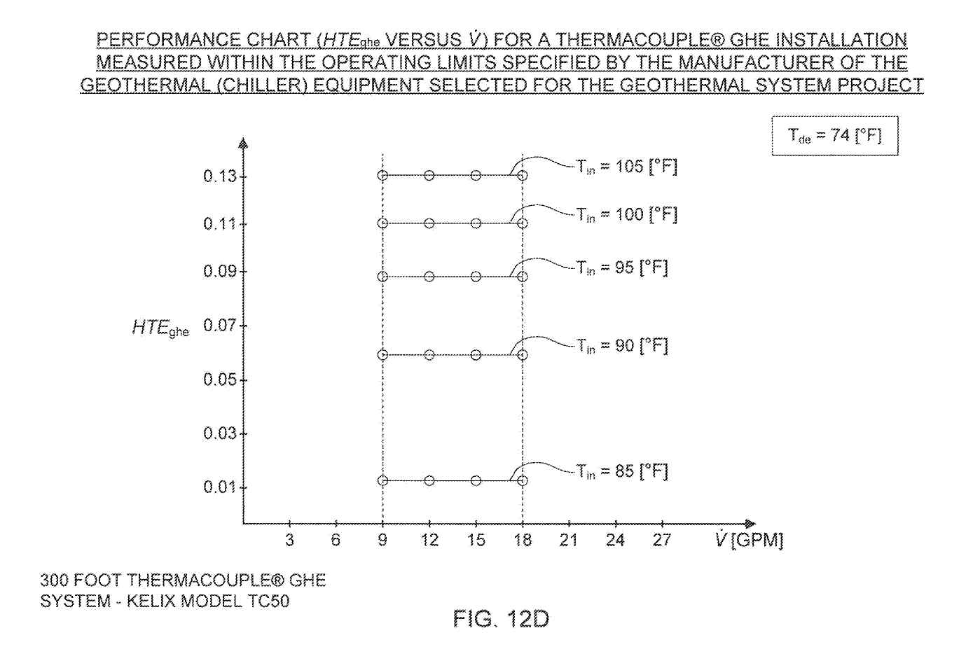

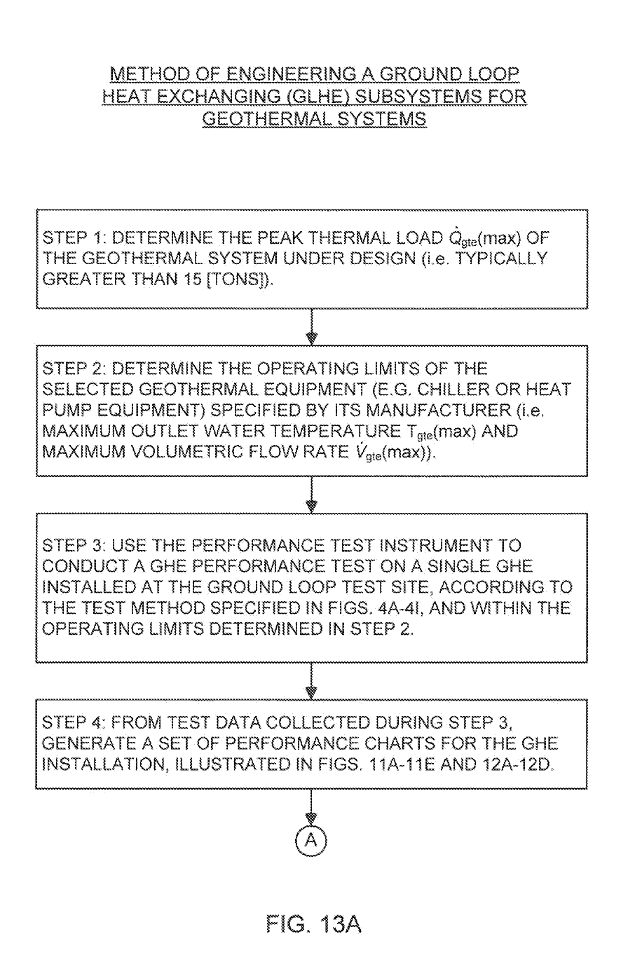

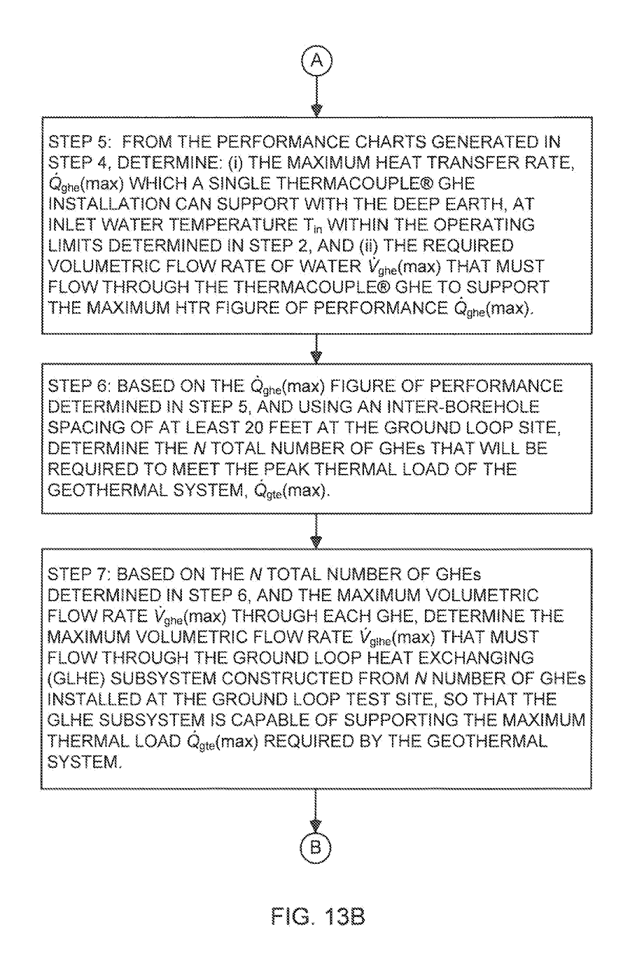

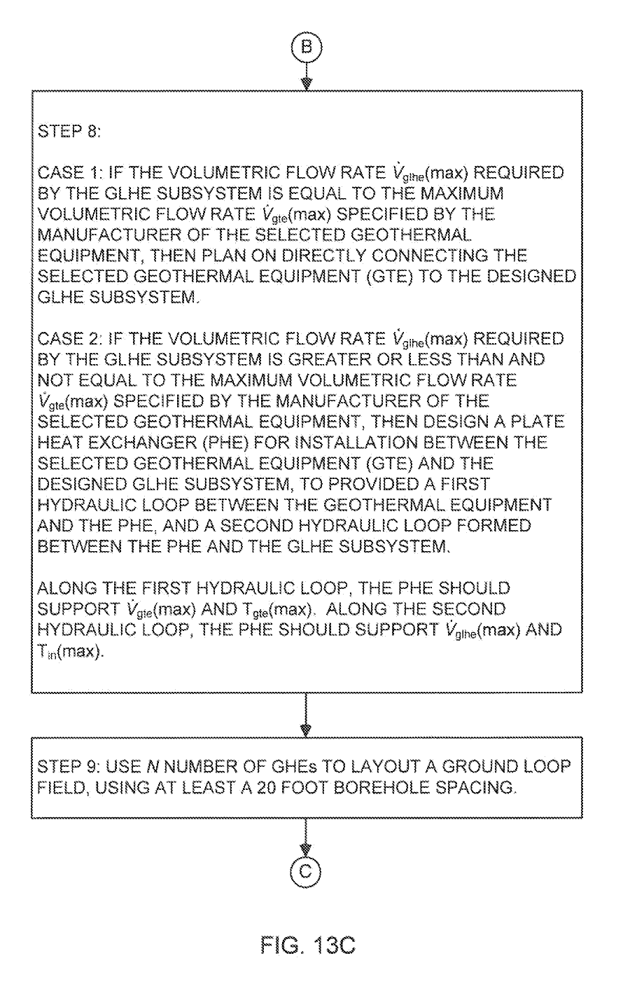

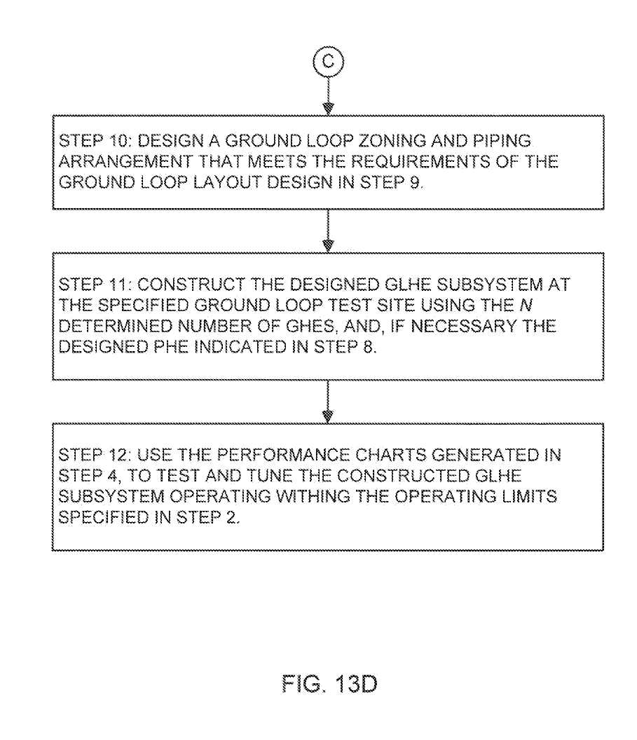

The purpose of the GHE Performance Test Instrument and Method of the present invention is to test the performance of any GHE installation, under precisely controlled test conditions maintained at the ground loop test site, so that such performance characteristics can be plotted and used to optimally design any size GLHE subsystem, to be constructed anywhere on Earth. Illustrative examples of such performance characteristics are shown in the GHE Performance Charts presented in FIGS. 11A through 11E and 12A through 12D.

The Thermal Conductivity Properties Associated with GHE Components and the Deep Earth Environment, and the Hydro-Geological Conditions Surrounding the Deep Earth Borehole Environment

As expected, the thermal conductivity properties associated with particular components (i.e. inner and outer tubes) of the GHE, and its thermo-fluidic functions (i.e. controlled laminar and turbulence along its inner and outer flow channels) have a direct influence on the heat transfer rates supported between water flowing through the GHE, and its deep Earth borehole environment. Thus, by design, the thermal and mass transfer characteristics of the GHE system should be selected so that the rate of heat transfer rate [Btu/hr] or [Ton] between water flowing through the GHE and its deep Earth environment, is optimized over its range of operation.

Also, it is well known that thermal conductivity properties of the deep Earth environment, surrounding any vertically installed GHE, will influence the rate of heat transfer between the GHE and the deep Earth environment. Also, these thermal conductivity properties typically vary along the entire length of most boreholes, and are determined by the actual geological conditions existing at the particular ground loop test site. Thus, the ground loop engineers have no control over the thermal conductivity properties of the deep Earth environment in which GHEs might be installed around the Earth.

Likewise, the hydro-geological conditions surrounding the deep Earth borehole environment will influence the rate of heat transfer between any GHE and its deep Earth environment. As general rule, the greater the presence of water in, about and through the borehole region of any GHE installation, the greater will be the rate of heat transfer between the water flowing through the GHE installation and its deep Earth environment. However, like other factors, the ground loop engineers have no control over the hydro-geological conditions of deep Earth environments in which GHEs might be installed.

### In Search of a Better and More Rational Way of Designing High-Efficiency GLHE Subsystems

Clearly, ground loop engineers are faced with many unknowns and many unknowable's when designing any GLHE subsystem, and many factors influencing the heat transfer rate between each GHE and its deep Earth environment fall far outside their control and into the hands of nature.

Also, over the past thirty-five or more years, the task of sizing and designing a GLHE subsystem for a particular geothermal application has evolved into the use of complex PC-based ground-loop simulation software systems. The underlying thermodynamic models in these systems are based on the use of g-functions and the principle of superposition of thermal potential functions over space and time across a ground loop test site. Such ground loop field simulation systems require numerous inputs, including soil formation thermal conductivity estimates expressed in units of [BTU/hr-ft-° F.], and the average thermal diffusivity for the soil formation expressed in units of [ft²/day]. Typically, these parameters are estimated through In Situ (Soil) Formation Thermal Conductivity Testing, and Data Analysis, using the line source method LS(5), Oak Ridge National Labs (ORNL) numerical, and ORNL line source methods.

Clearly, conventional (Soil) Formation Thermal Conductivity Testing does not measure the actual performance of a GHE installation at a particular ground loop test site, driven across and to the edge of its operating limits—specified by the manufacturer of the geothermal equipment (e.g. chillers, heat pumps, etc) to which the finally constructed GLHE subsystem will be connected.

Also, such conventional ground loop field simulation tools and design methods do not provide a simple and reliable way of empirically testing the heat transfer rate performance of any particular ground loop field configuration, once actually constructed at the ground loop test site.

In view of the various factors influencing the rate of heat transfer in GHEs, and more particularly the fact that most of these factors are outside the sphere of control of the ground loop engineer, there is a great need a new and improved method of rationally designing GLHE subsystems, based on scientific in situ heat transfer rate measurement principles and techniques that provide a new level of efficiency, performance and accountability.

Such an approach, taught therein about the Performance Test Instrumentation and Methods of the present invention, recognizes at the onset, two simple facts about Applicant's coaxial-flow GHE technology disclosed in U.S. Pat. No. 7,345,753, (as well as U-tube and any other water-loop based GHE technology) and that is:

(1) that all of the above described “factors” cooperate together and contribute to the Total Thermal Conductance of any GHE installation, K_{ghe}, as seen from the inlet and outlet ports of its header/distributor, and defined in FIG. 11B; and

(2) that the heat transfer rate \dot{Q}_{ghe} supported between water flowing through the GHE installation and its deep Earth environment, is the natural response of the GHE installation to the application of the Thermal Potential Difference (TPD) (between the inlet water temperature and the average deep Earth temperature) driving the GHE installation.

Thus, by driving the GHE installation over a controlled range of inlet water temperatures while holding the volumetric flow rate a constant during performance testing operations, it is possible to accurately measure the actual heat transfer rate (HTR) performance of the GHE test installation—using the enthalpy-based HTR techniques of the present invention, and without knowledge of the many unknowns and unknowable parameters beneath the deep Earth environment.

And from such empirically determined values of HTR and controlled values of TPD (ΔT_{driving}=Tᵢₙ−T_{de}) to drive the GHE test installation, the Total Thermal Conductance of the GHE installation can also be measured for different values of TPD (ΔT_{driving}=Tᵢₙ−T_{de}) and volumetric flow rate \dot{V}_{ghe}, which are under the control of the engineers conducting such GHE performance Testing operations.

Based on the above, Applicant firmly believes when engineering any GLHE system with GHE technology in mind, engineers will achieve superior results when using the GLE Process described herein.

In general, the GLE Process requires the following:

(i) first, directly and empirically measuring the actual heat transfer rate (HTR) performance characteristics of a simple GHE Installation during highly-controlled performance testing conditions that emulate a full range of thermal loading effects to be expected by the selected geothermal equipment (GTE) used to construct the geothermal system;

(ii) second, generating GHE Performance Charts from collected test data; and

(iii) third, using these Performance Charts to rationally determine (ii) number of GHEs required to meet the heat transfer rate requirements of the geothermal system under design, as well as (ii) the required volumetric flow rates required to support such heat transfer rates on both sides of the geothermal system.

The GLE process of the present invention will be described in greater technical detail hereinafter.

### Brief Overview on Designing and Constructing Geothermal Ground Loop Heat Exchanging (GLHE) Subsystems Using the Performance-Based Ground Loop Engineering (GLE) Process of the Present Invention

The performance-based GLE process according to the principles of the present invention provides a practical way to engineer high-performance ground loop heat exchanging (GLHE) subsystems from component ground heat exchangers (GHEs). It recognizes that all GHEs and GLHE subsystems follow basic principles of energy conservation established by the laws of thermodynamics. It demands empirical knowledge of the actual heat transfer rate (HTR) performance of a GHE installation in its deep Earth environment, prior to designing and constructing a GLHE subsystem employing the GHE as a system component. It also demands that such empirical knowledge be acquired using scientific principles that have helped engineers build fossil-fueled steam power plants, gas turbine jet engines, spark-ignition reciprocating engines, and liquid-fuel rockets.

The GLE Process of the present invention involves learning the following techniques:

(1) how to use the Portable Enthalpy-Based Ground Heat Exchanger (GHE) Performance Test Instrumentation System of the present invention, and its Enthalpy-Based GHE Performance Test Methods at ground loop test sites around the world;

2) how to accurately and reliably measure the average deep Earth temperature T_{de} about any test site borehole, and four (4) important “energy” performance characteristics of any GHE test installation, allowing for objective comparisons against competing GHE technologies, installed at the same location;

(3) how to design and construct high-performance ground loop heat exchanging (GLHE) subsystems, based on the actual energy performance measurements of a GHE test installation, taken at a ground loop test site using the Portable Enthalpy-Based Ground Heat Exchanger (GHE) Performance Test Instrumentation System and Methods of the present invention;

(4) how to test and tune an GLHE subsystem after it is installed and operating with its geothermal heat pump, chiller and/or HVAC equipment; and

(5) how to monitor and record the energy performance characteristics of GLHE subsystems during the lifetime of the geothermal systems to which they are connected.

It is appropriate as this juncture to concisely review the four “energy performance measurements” taken by the Portable Enthalpy-Based Ground Heat Exchanger (GHE) Performance Test Instrumentation System of the present invention, when carrying out a performance test on any ground heat exchanger (GHE) installation, in accordance with the GLE Process.

The first energy performance measurement is the Heat Transfer Rate (HTR) of any ground heat exchanger (GHE) installation, measured in units of [BTU/Hr], and based on the volume/mass flow rate and the inlet and outlet temperature and pressure of water flowing through the ground heat exchanger during performance testing operations.

The second performance figure is the Flow Work Rate (FWR) of any GHE installation, measured in units of [BTU/Hr], and based on the specific volume of water, the mass flow rate through the GHE, and the inlet and outlet pressure of water flowing through the GHE during performance testing operations.

The third performance figure is the Energy Efficiency Ratio (EER) of any GHE installation, measured in dimensionless units, and equal to the ratio of the empirically (i.e. experimentally) measured HTR and FWR of the GHE installation during performance testing operations. Essentially, the EER for a GHE, as well as a GLHE subsystem, is its coefficient of performance (COP) measure, based on the ratio of desired (heat) output [BTU/Hr] to the required work (energy) input [BTU/HR].

The fourth performance figure is the Heat Transfer Efficiency (HTE) of any GHE installation, measured in dimensionless units, and equal to the ratio of (i) the actual real (empirically-determined) enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE installation.

For any scale geothermal project, a performance-based method is recommended to design and construct ground loop subsystems. This method involves first installing at least one GHE in the deep Earth environment at the ground loop field test site, where its actual heat transfer rate (HTR), flow work rate (FWR), energy efficiency ratio (EER) and heat transfer efficiency (HTE) energy performance characteristics are then measured—using the Portable Enthalpy-Based Test Instrumentation System and Method of the present invention.

Then, these enthalpy-based performance figures are plotted as a function of inlet water temperature Tᵢₙ, for different values of constant volumetric water flow rate \dot{V} through the GHE installation, to generate a first set of GHE Performance Charts revealing actual performance characteristics of the GHE in its installation environment. Also, these enthalpy-based performance figures are plotted as a function of volumetric water flow rate \dot{V} through the GHE installation, for different values of constant water inlet temperature Tᵢₙ into the GHE installation, to generate a second set of GHE Performance Charts, revealing actual performance characteristics of the GHE in its installation environment.

These Performance Charts are then used by engineers to size, design and construct a ground loop heat exchanging (GLHE) subsystem at the test site, based on the actual performance characteristics of the GHE, empirically determined for the specific ground loop field test site under testing and analysis.

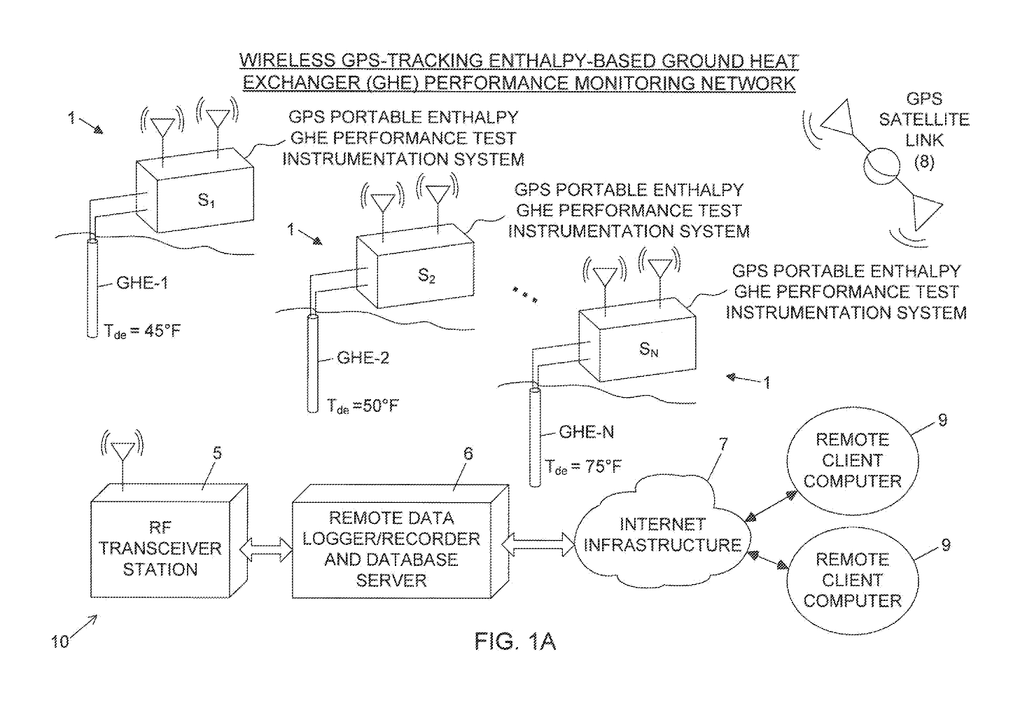

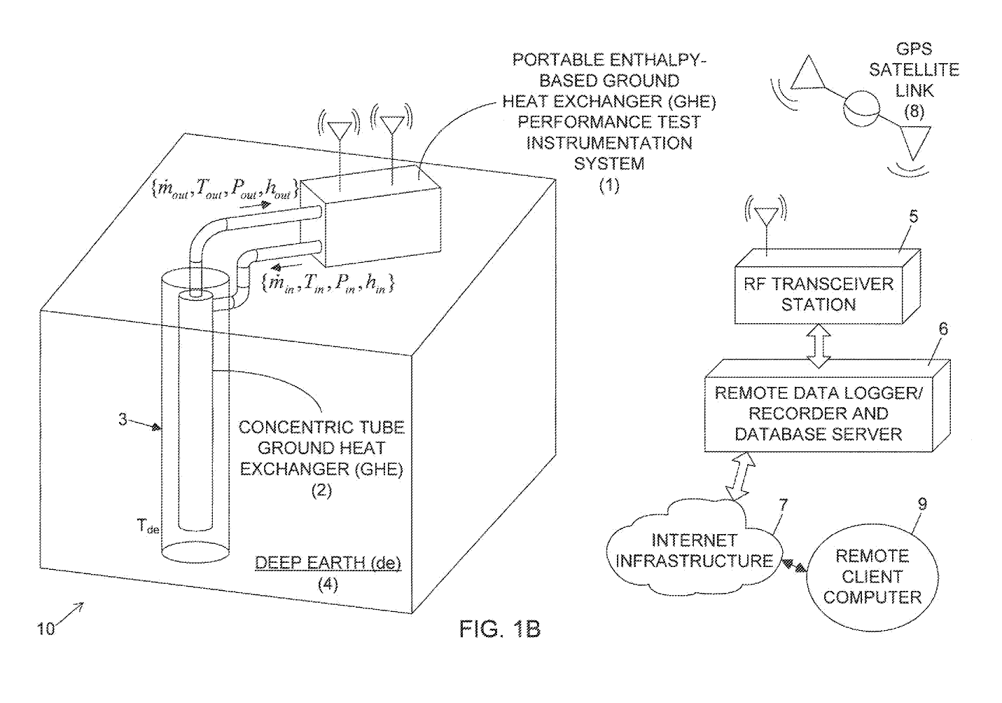

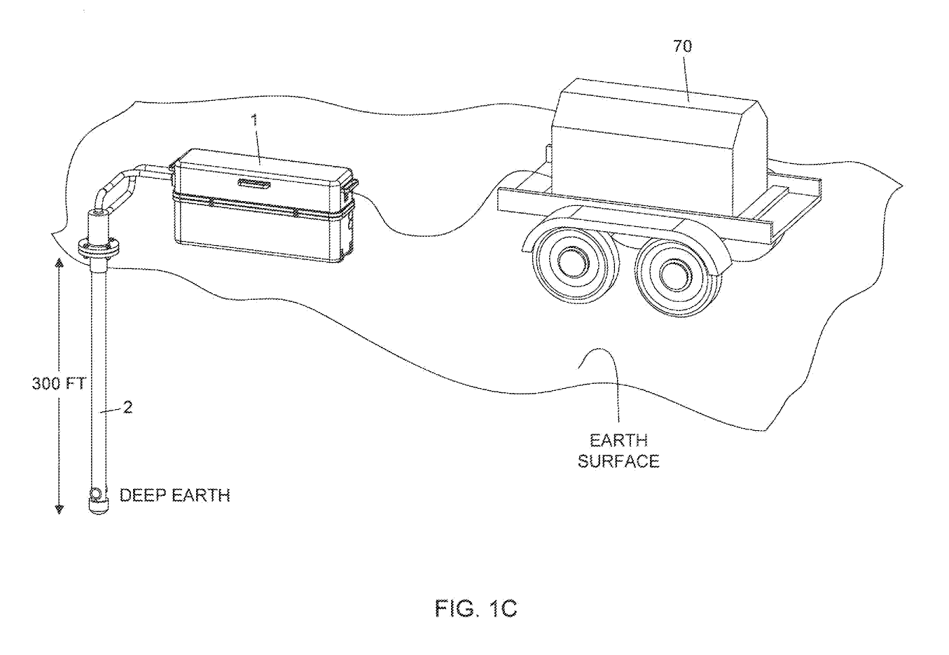

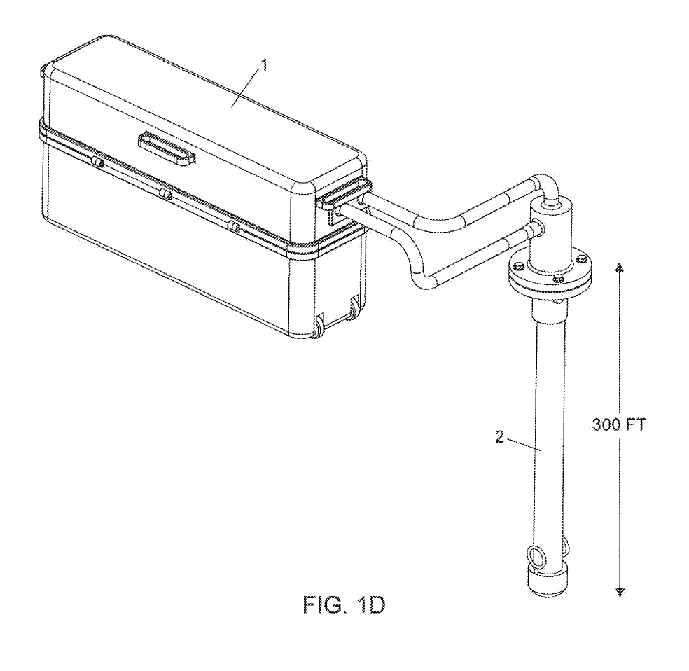

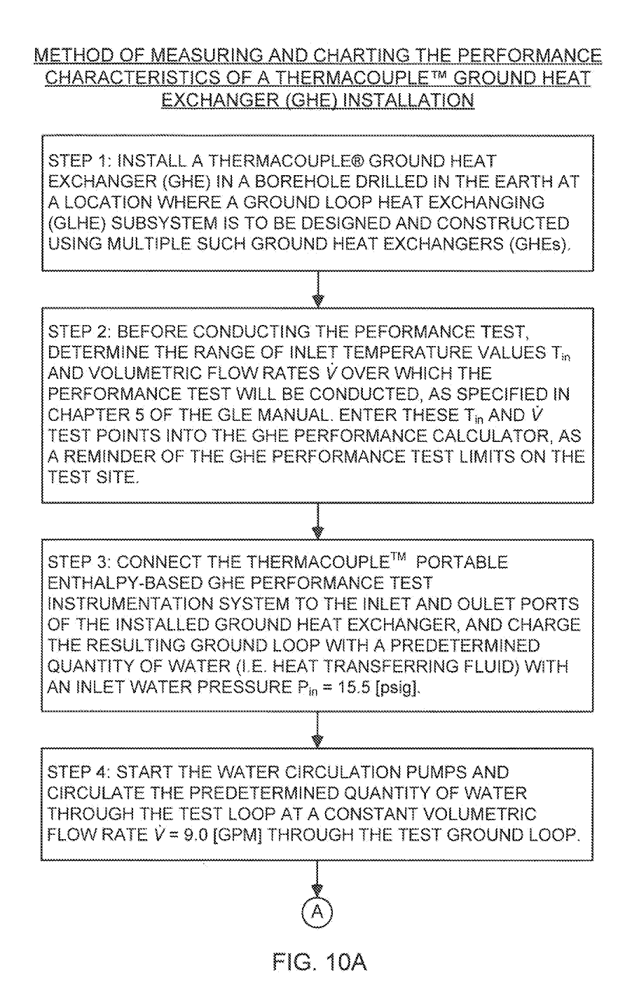

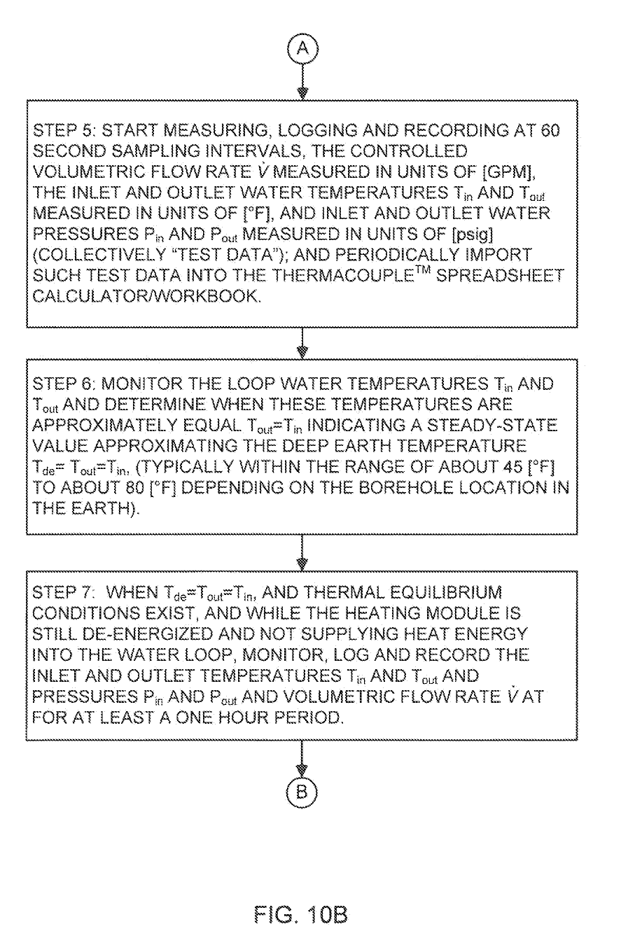

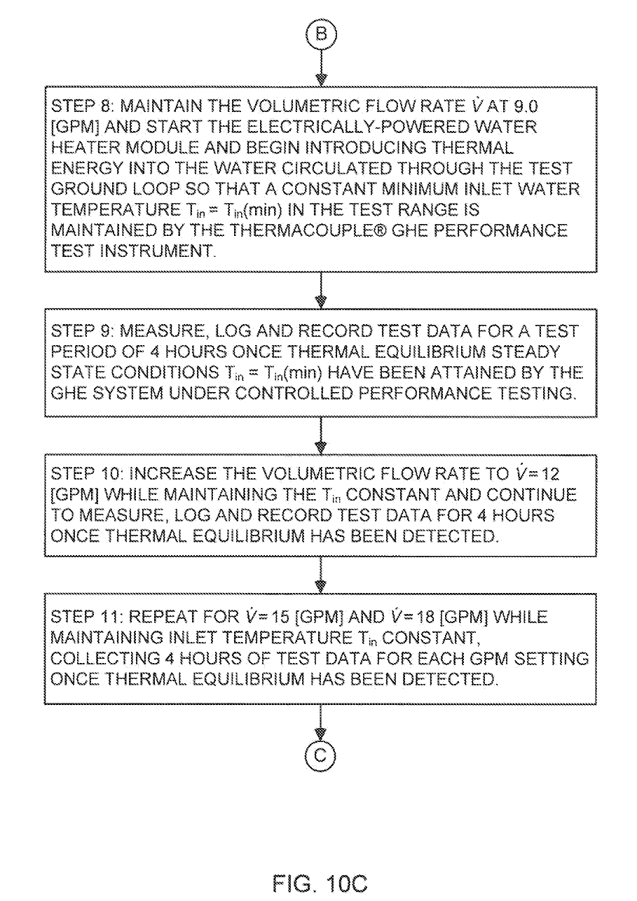

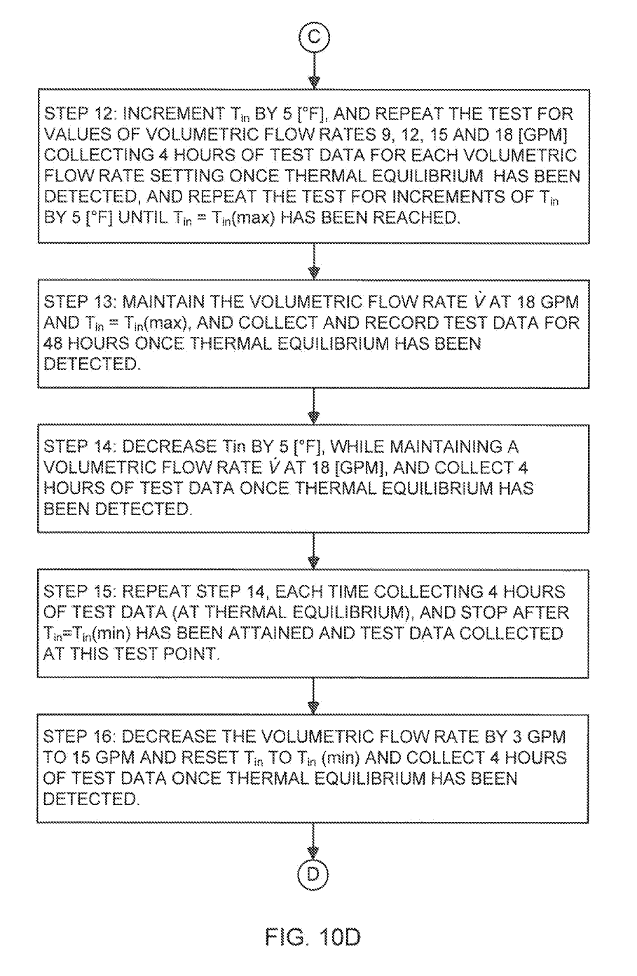

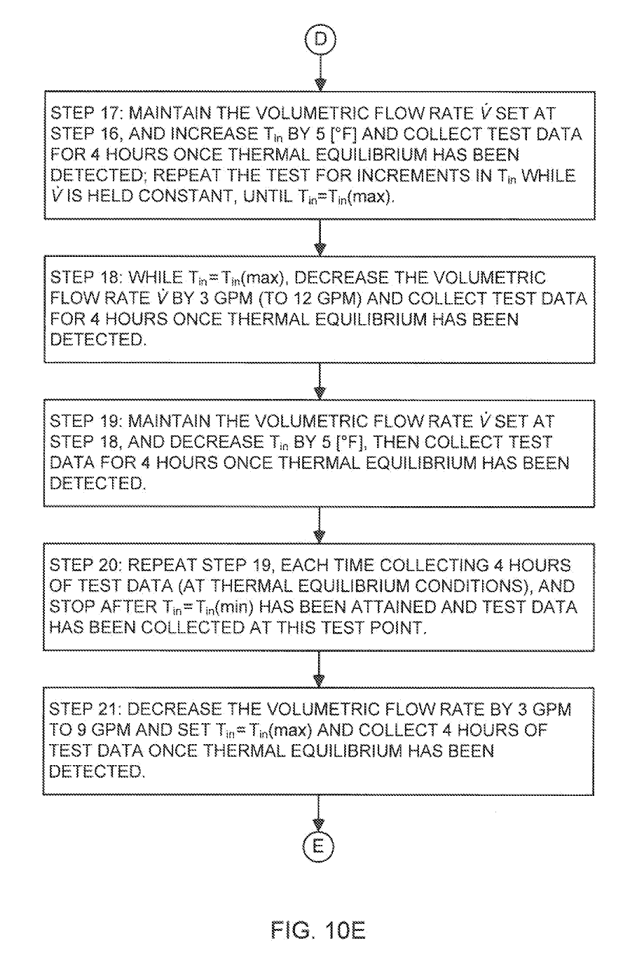

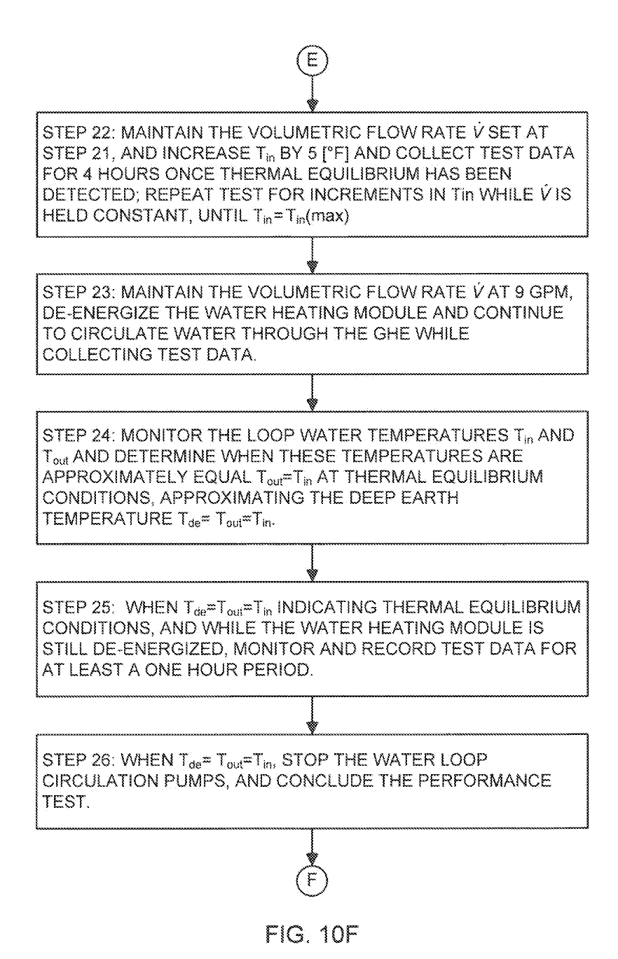

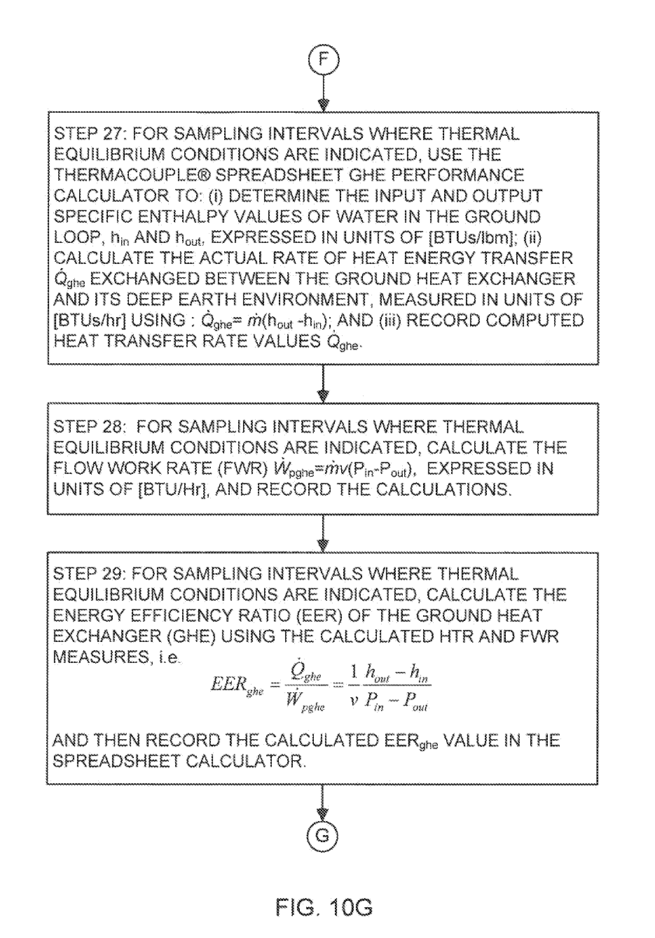

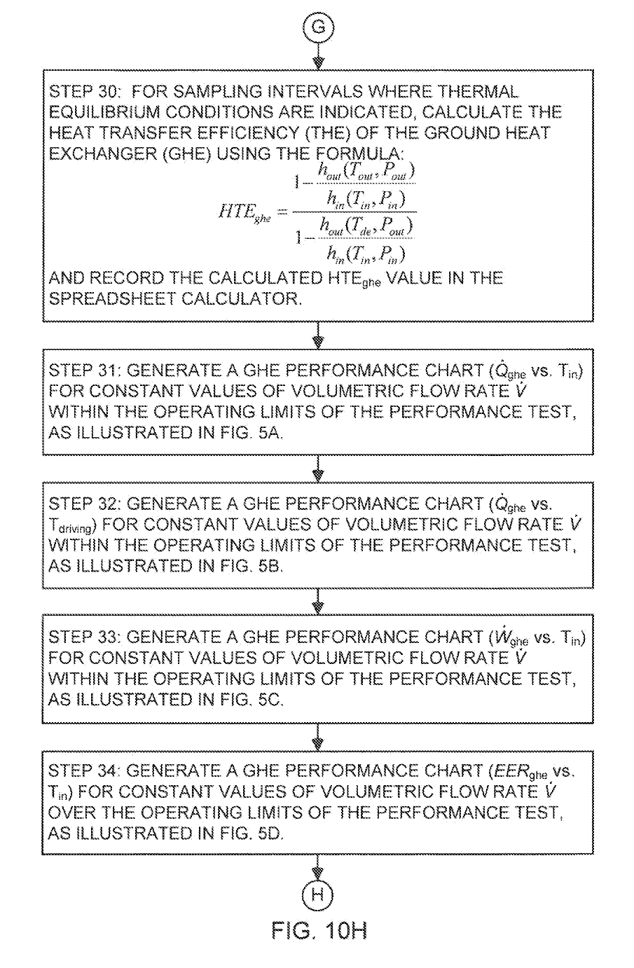

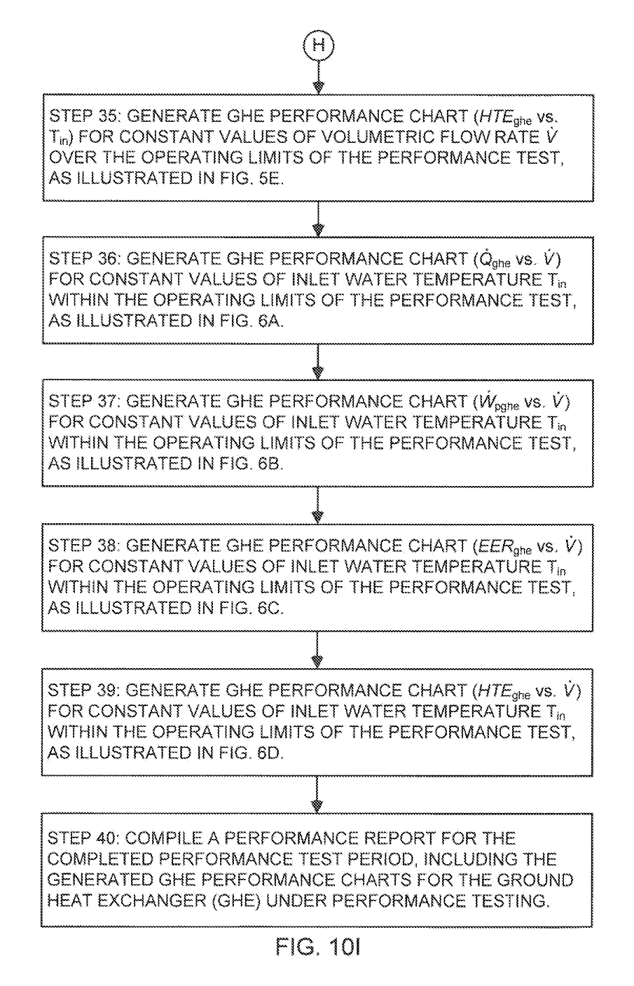

When practicing the method of the present invention, it will advantageous to use of the Portable Enthalpy-Based GHE Performance Test Instrumentation System shown in FIGS. 1A through 4D, and Enthalpy-based GHE Performance Test Method described in FIGS. 10A through 10, to perform in situ energy-based performance measurements on any type of GHE installation at a specified ground loop field test site.

It is appropriate at this juncture to briefly describe the performance-based GLE) process of the present invention when using a high-performance concentric-tube turbulence-generating ground heat exchanger (GHE) technology, such as taught in U.S. Pat. Nos. 7,343,753; 7,347,059; 7,363,769; 7,370,488; 7,373,785; and 7,377,122 to Applicant, whenever designing and constructing a GLHE subsystem of any size, at any location where there is empirical knowledge that the deep Earth environment has low or moderate levels of ground water.

Before discussing the details of the GLE Process, it will be helpful to consider the factors which impact the heat transfer rate performance of any GHE, and then provide a brief overview of the GLE Process for geothermal system projects, below.

### Overview of the Performance-Based Ground Loop Engineering (GLE) Process of the Present Invention

As explained briefly above, the GLE Process involves the use of concentric-tube type GHE technology whenever designing and constructing a GLHE subsystem of any size, at any location where there is empirical knowledge that the deep Earth environment has an average deep Earth temperature of about 65° F. or higher, and/or low or moderate levels of ground water.

When designing and constructing a GLHE subsystem for a geothermal system having thermal loads of less than 15 Tons and deep Earth temperatures less than about 65° F., then the GLE Process suggests a Library-based design method using “average” empirically-determined heat transfer rates (HTR) for particular size GLE products. This method greatly simplifies the sizing of small-scale GLHE subsystems, without the use of GHE performance testing on the test site.

However, when designing and constructing a GLHE subsystem for a geothermal system having thermal loads of 15 or more Tons or in deep Earth environments having average deep Earth temperatures greater than 65° F., then the GLE Process also involves in situ GHE performance the Performance Test Instrument to measure the actual HTR, FWR, EER/COP and HTE performance figures for any GHE test installation.

Before discussing the details of the GLE Process, it will be helpful to provide at this juncture a brief overview of the GLE Process below.

In accordance with standard systems engineering principles, the GLE Process of the present invention can be decomposed into four (4) distinct phases, namely: Analysis; Design; Implementation/Construction; and Testing. Each of these phases will be described in greater detail below.

### Analysis Phase of the GLE Process

(1) Analyze and determine the peak and block thermal load requirements for the building during both heating and cooling season, using conventional building load modeling tools and techniques.

(2) Select candidate geothermal equipment for implementing the geothermal system, including the selection of geothermal heat pump, chiller, and/or HVAC equipment capable of meeting the thermal load requirements of the geothermal system project.

(3) Determine the maximum and minimum operating limits of the candidate geothermal equipment, e.g. maximum and minimum entering water temperature (EWT) into the GHE and leaving water temperature (LWT) from the GHE, and volumetric water flow rates supported by the geothermal equipment.

Determining the maximum and minimum entering water temperature (EWT) into the GHE and leaving water temperature (LWT) from the GHE involves carefully reviewing the geothermal equipment manufacturer's specification sheets, operating instructions, manuals and other documents to determine (i) the maximum and minimum entering water temperature (EWT) into the GHE, the leaving water temperature (LWT) from the GHE, and (ii) the minimum and maximum volumetric water flow rates through the geothermal equipment (GTE) and the GLHE subsystem. Only by determining these operating limits Tᵢₙ(min), Tᵢₙ(max), set on the geothermal equipment manufacturer, can engineers properly test a GHE installation, and rationally design and construct the GLHE subsystem for the geothermal system.

(4) Visit the Test Site where the GLHE subsystem will be constructed, and install at least one GHE in the deep Earth environment for performance testing.

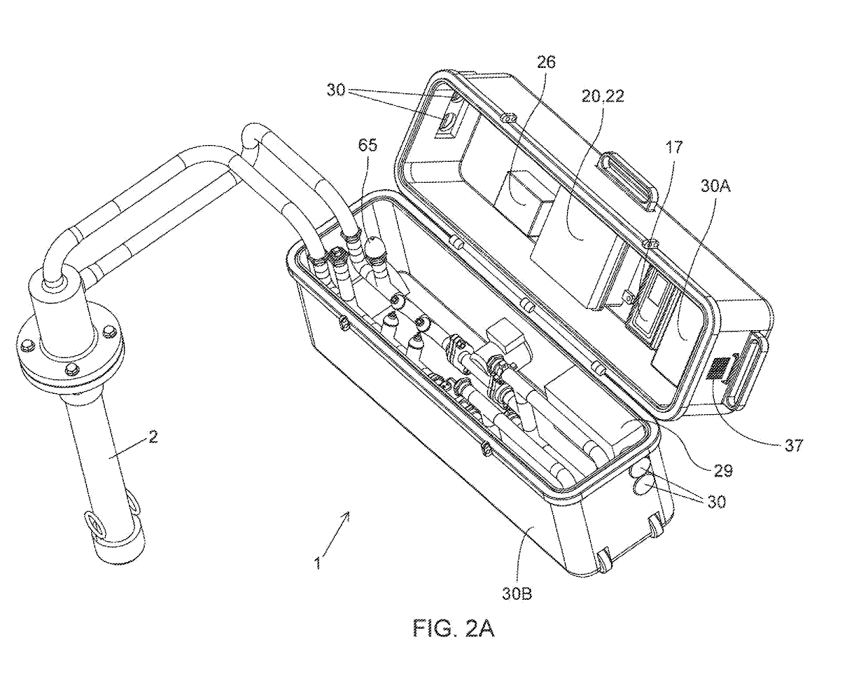

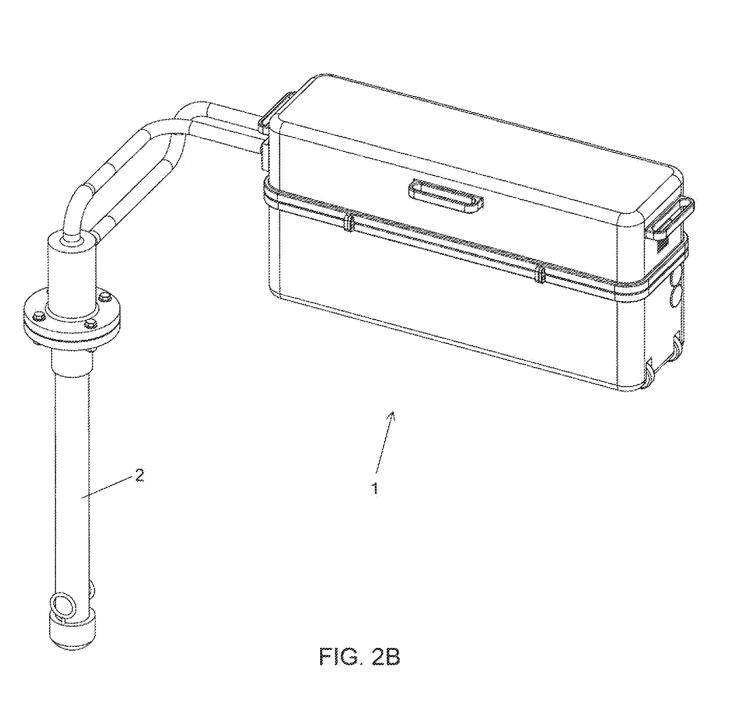

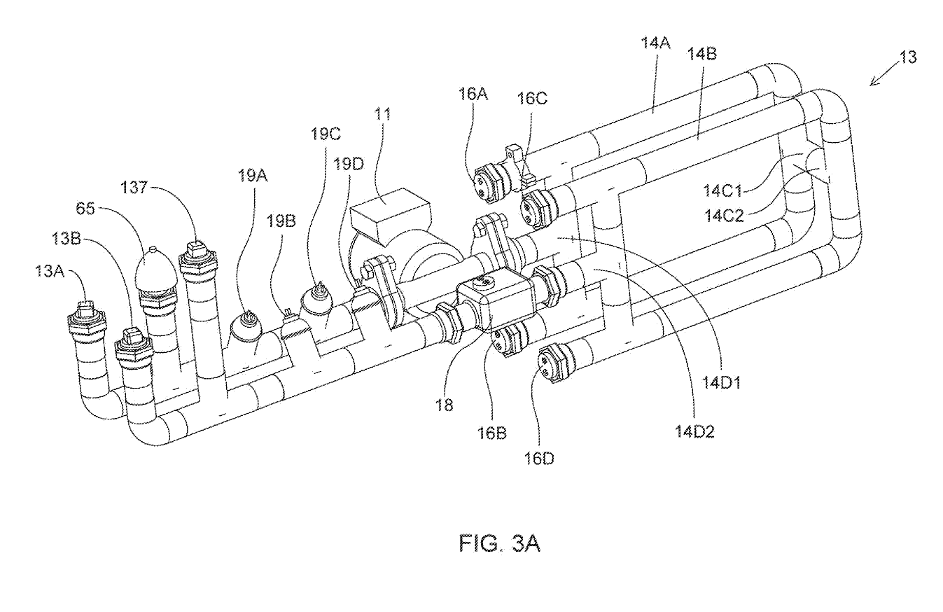

(5) Connect a Performance Test Instrument to the GHE installation as shown in FIGS. 1B through 2B and described herein, and then conduct a Performance Test on the GHE installation in accordance with the GHE Performance Test Method specified in FIGS. 10A through 10I, and collect Test Data.

(6) From the collected Test Data, generate a Performance Test Report including the GHE Performance Charts illustrated in FIGS. 11A through 12D, measured at specified conditions closely matching operating conditions of geothermal heat pump or chiller equipment selected for the geothermal system design.

Mathematical models and methods used to derive all formulas used in such energy-based performance calculations are set forth hereinafter.

### Design Phase of the GLE Process

(7) Based on the Thermal Load Requirements of the Geothermal System Project and the GHE Performance Test Report, select geothermal heat pump and/or chiller equipment with which to design and construct a GLHE subsystem for installation on the Test Site and which will meet the Thermal Load Requirements of the Geothermal System Project.

(8) Design a GLHE subsystem for the Geothermal System Project as described herein, using:

(i) The Thermal Load Requirements of the Geothermal Project;

(ii) The Performance Charts contained in the GHE Performance Test Report;

(iii) The selected geothermal heat pump, chiller and/or HVAC equipment; and

(iv) Piping, pumps, valves, manifolds, materials and standards.

### Implementation/Construction Phase of the GLE Process

(9) Construct the designed GLHE subsystem on the Test Site.

(10) Set up, operate and tune the GLHE subsystem for optimum performance.

### Testing Phase of the GLE Process

(11) Install a Ground Loop Performance Monitoring Module on the GLHE subsystem, and monitor and record its performance during the lifetime of the geothermal system to which it is connected.

(12) Determine how closely the actual performance characteristics of the constructed GLHE subsystem match the predicted performance characteristics of the GLHE subsystem design.

(13) Based on any discrepancies observed or detected above, inform the Analysis and Design Phases of the GLE Process and make any necessary modifications to the GLHE subsystem design and bring the GLHE subsystem construction in conformity with the modified design, and resume testing and the process until the GLHE subsystem performs as required to meet the heat transfer requirements of the geothermal system.

With this overview, we are now ready to describe in greater detail, the Portable Enthalpy-Based GHE Performance Test Instrumentation System of the present invention, and the Method Of Enthalpy-Based GHE Performance Testing, which it supports at any ground loop test site.

The Portable GPS-Based Enthalpy-Based Ground Heat Exchanger (GHE) Performance Test Instrumentation System and Network of the Present Invention, and Method of GHE Performance Testing in Accordance with the Principles of the Present Invention

FIGS. 1A and 1B show a globally-extensive, Mobile-Wireless GPS-Tracking Ground Heat Exchanger (GHE) Performance Test Instrumentation Network 10 comprising a plurality of wireless Portable GPS-Based Enthalpy-Based GHE Performance Test Instrumentation Systems 1 as described hereinbelow. In the illustrative embodiment shown in FIGS. 1A and 1B, the Portable GPS-Based GHE Performance Test Instrumentation System 1 is shown connected to a generalized ground heat exchanger (GHE) 2 installed in a borehole 3 drilled in the deep Earth environment 4. Such ground heat exchangers can be closed-loop concentric-tube (i.e. coaxial-flow) type ground heat exchangers as disclosed in U.S. Pat. Nos. 7,343,753; 7,347,059; 7,363,769; 7,370,488; 7,373,785; and 7,377,122; HDPE U-tube type heat exchangers; open standing column well the ground heat exchangers; and other ground heat exchanger technologies known in the art.

As shown, the Portable GHE Performance Test Instrumentation System 1 delivers a heat energy carrying fluid, such as water, 5 into the ground heat exchanger 2, the deep Earth environment exchanges heat with the heat energy carrying fluid, and water output from the ground heat exchanger is returned to the HTR test system for reheating, along the ground test loop. As shown, the thermal properties for the input water stream Tₒᵤₜ are input mass flow rate \dot{m}ᵢₙ, input water pressure Pᵢₙ input water temperature Tᵢₙ and input specific enthalpy hᵢₙ which is a function of input water pressure Pᵢₙ and input water temperature Tᵢₙ. The thermal properties for the output water stream are output mass flow rate \dot{m}ₒᵤₜ, output water pressure Pₒᵤₜ output water temperature Tₒᵤₜ, and specific enthalpy hₒᵤₜ, which is a function of output water pressure Pₒᵤₜ and output water temperature hₒᵤₜ, well known in the field of water thermodynamics.

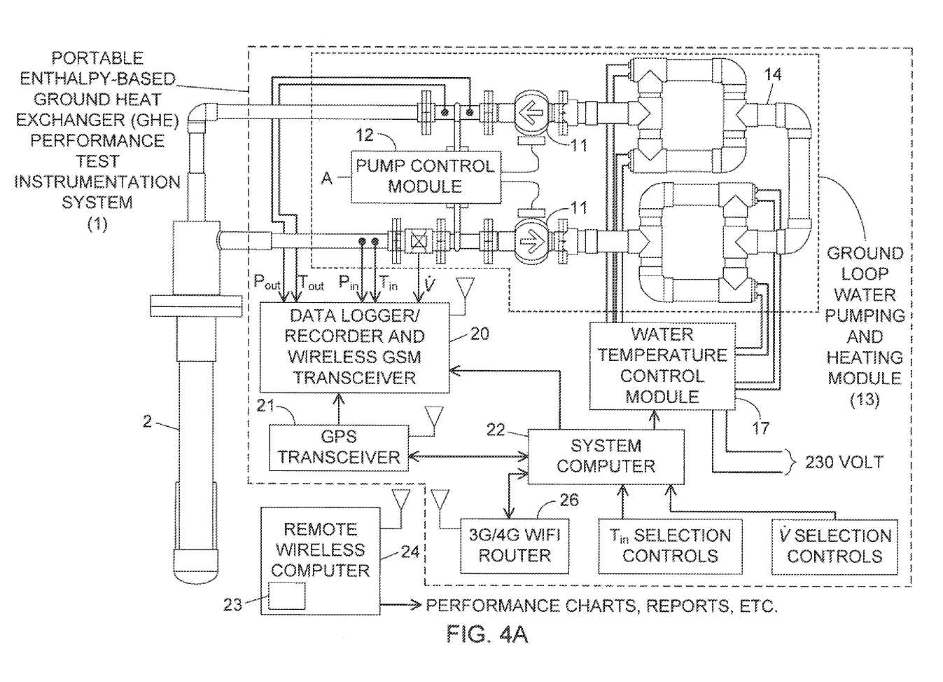

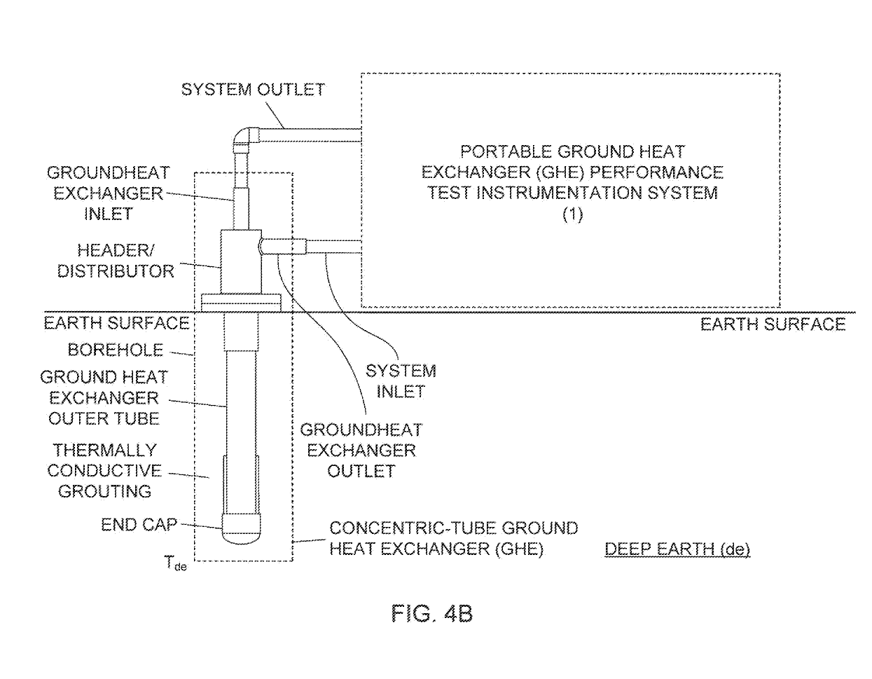

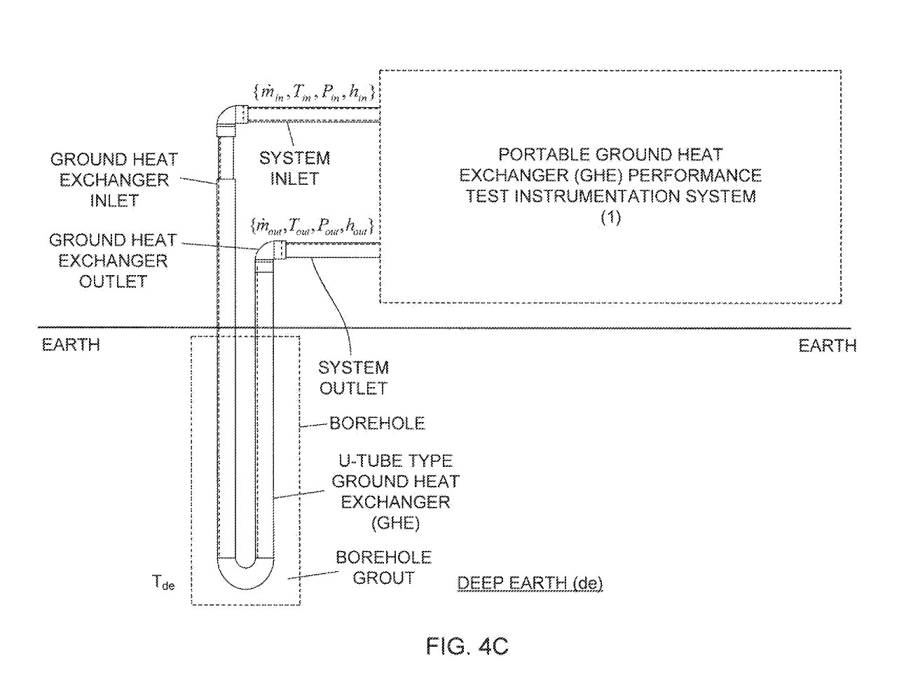

In general, the Portable GHE Performance Test Instrumentation System 1 can be used to perform in situ heat transfer rate (HTR) performance measurements on any type of geothermal ground heat exchanger, described above. Two illustrative examples are given in FIGS. 4A through 4D: a closed-loop concentric-tube (i.e. coaxial-flow) type ground heat exchanger shown in FIGS. 4A through 4C; and a U-tube type GHE shown in FIG. 4D.

In FIG. 1A, an illustrative embodiment of the Portable GHE Performance Test Instrumentation System 1 is shown connected to a closed-loop concentric-tube (i.e. coaxial-flow) type ground heat exchanger, installed in a borehole drilled in the deep Earth environment. As shown, the concentric-tube type ground heat exchanging system 2 is filled with an aqueous-based heat transfer fluid (e.g. water and possibly some small quantity of additive), that is contained and circulated within a sealed underground concentrically-arranged (coaxial-flow) tube assembly. In the design disclosed in U.S. Pat. No. 7,343,753, both laminar and turbulent fluid flows are employed within the tube assembly, to efficiently and safely transfer heat energy between the geothermal heat pump unit and the Earth's crust, all year round, in a highly efficient, economical and environmentally-safe manner. Typically, the concentric-tube type ground heat exchanging system is installed in a six (6) inch diameter 300 feet deep vertical borehole, but the borehole length may vary from installation to installation. Multiple ground heat exchangers of this design can be installed in 300 foot boreholes, spaced at 20 feet apart, and connected together with conventional piping below the frost-line, to meet the heat transfer rate requirements of any size geothermal heat pump or geothermal chiller project.

As shown in FIGS. 1A and 1B, each such Portable GHE Performance Test System is connected to a ground heat exchanger (GHE) installation, and is capable of monitoring and logging GPS-indexed performance test data on the installed ground heat exchanger, and transmitting such performance test data from the Portable Test System to a remotely situated RF transceiver station 5, operably connected to a remote data logger/recorder and database server 6. In turn, the remote data logger/recorder and database server 6 is operably connected to the infrastructure of the Internet 7, in a conventional manner.

One or more GPS satellites 8 from a GPS system transmit GPS signals which are received and processed by a GPS transceiver/processor in each GPS-Based Enthalpy-Based GHE Performance Test System 1, to resolve its location using GPS techniques well known in the art. Remote client systems 9, running the Spreadsheet Enthalpy-Based GHE Performance Calculator of the present invention can access and import logged and recorded test data from the database server 6, and then calculate the energy performance figures (e.g. HTR, FWR, EER and HTE) using the Spreadsheet Enthalpy-Based GHE Performance Calculator.

Alternatively, the functionalities of the Spreadsheet Enthalpy-Based GHE Performance Calculator can be integrated into the database server 6, allowing remote client systems 9 to use a Web-based browser to directly access calculated HTR, FWR, EER and HTE performance figures on a particular ground heat exchanger test installation.

Using the GHE Performance Test Instrumentation Network 10 shown in FIGS. 1A and 1B, ground loop engineers and hydro-geologists working together can easily create a GPS-indexed heat transfer rate (HTR) performance database 6 using empirically obtained heat transfer rate (HTR) performance surveys taken using a closed-loop concentric-type ground heat exchanger and GPS-tracking enthalpy-based HTR performance test instrumentation. By doing so, geothermal engineers have empirical knowledge of the potential capacity of specific regions of Earth mass to exchange heat energy with such types of ground heat exchangers, based on scientific research and empirical investigation. Also, using the Instrumentation Network of FIG. 1B, ground loop engineers and others can easily create a GPS-indexed heat transfer rate (HTR) performance database 6, by combining empirical heat transfer rate (HTR) measurements with spatially corresponding hydro-geological measurements of underground ground water conditions.

In FIG. 4D, the Portable GHE Performance Test Instrumentation System 1 is shown connected to a conventional-based U-Tube heat exchanger 2, installed in a borehole 3 drilled in the deep Earth environment. As shown, the U-Tube type ground heat exchanging system is filled with an aqueous-based heat transfer fluid, that is contained and circulated within a sealed HDPE U-tube configuration, installed in a borehole that is filled with grouting, that may have thermally enhanced properties. Typically, a U-Tube ground heat exchanger is installed in borehole of 4 to 6 inches in diameter, running in length from 100 feet up to 500 feet, and possibly deep in some applications. Multiple ground heat exchangers of this design can be installed in boreholes, also spaced at 20 feet apart, and connected together with conventional piping below the frost-line, to meet the heat transfer rate requirements of a geothermal heat pump project.

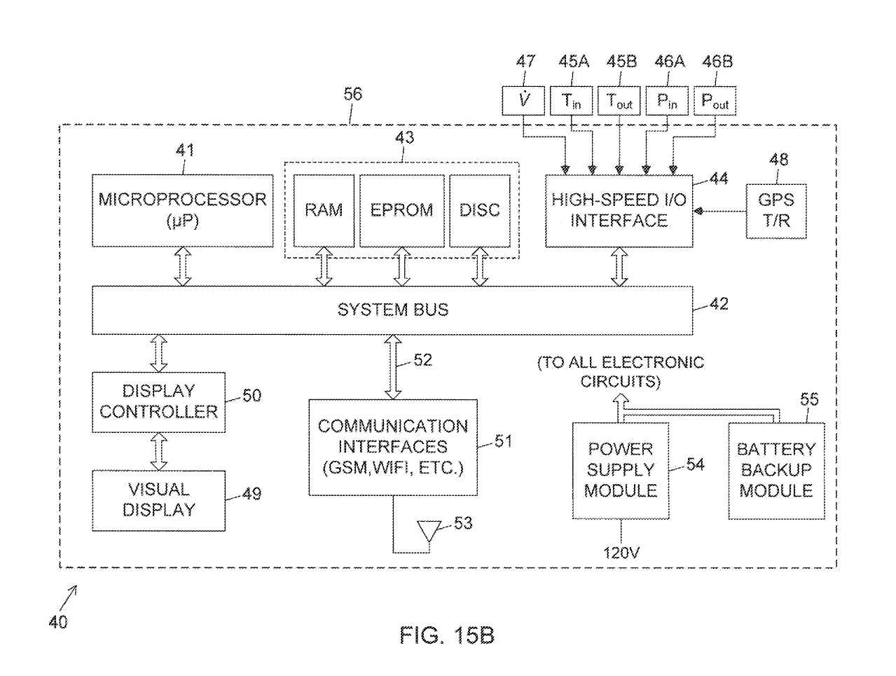

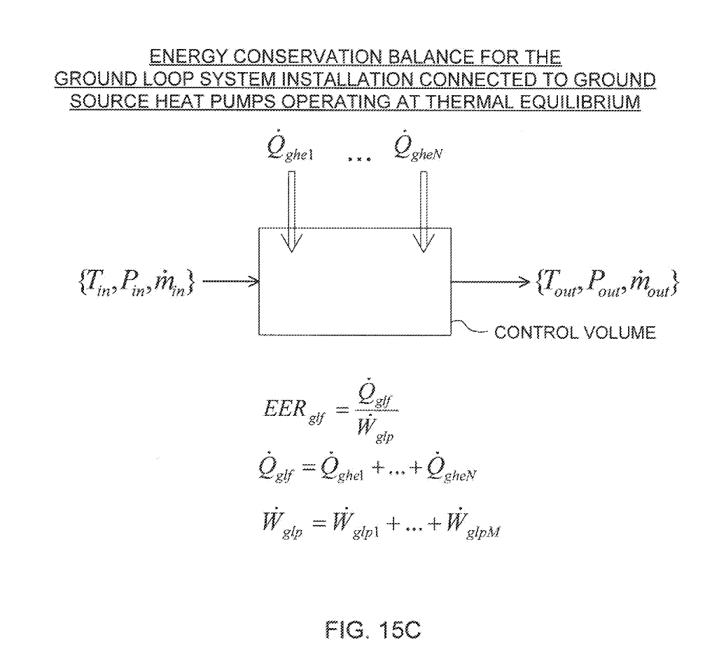

As shown in FIGS. 2A-3L and 4A-4C, the Portable GHE Performance Test Instrumentation System 1 comprises a number of components, namely: water circulation pump 11 associated with an electronic pump control module 11 for controlling the pump so that a predetermined quantity of water (i.e. heat transferring fluid) is circulated through the test ground loop at a controlled volumetric flow rate \dot{V} (or mass flow rate \dot{m}) according to the test procedure period; a ground loop water heating module 13 consisting of a flow control tube assembly 14 having inlet and outlet flow channels 13A and 13B, containing a pair of parallel flow water heating submodules 16, each having a pair of electrically-powered water heating elements, characterized by resistances R₁, R₂ and R₃, R₄ each rated to operate at output power values of at least 5.5 KW [kilowatts]; water temperature control module 17 for supplying electrical power to the heating elements (e.g. supplied at the test site) so that the heating elements generate thermal energy and heat up the water pumped through the flow control tube assembly so that the inlet or entering water temperature Tᵢₙ is maintained at a constant input temperature measured in units of [° F.] specified in accordance with the Test Method specified at FIGS. 10A through 10I; a volumetric flow rate meter 18 for measuring in units of [gallons/minute] the controlled volume flow rate \dot{V} of water through the test ground loop, which is then converted to a corresponding value of mass flow rate \dot{m} within the instrument system; a pair of temperature transducers 19A, 19B, located on the interior surfaces of the inlet and outlet of the output ports of the apparatus, for measuring the inlet and outlet water temperature values Tᵢₙ and Tₒᵤₜ in units of [° F.] at discrete periodic sampling times; a pair of pressure sensors/transducers 19C, 19D located on the interior surface of the inlet and output ports of the apparatus, for measuring the inlet and outlet water pressures Pᵢₙ and Pₒᵤₜ in units of [psig] at discrete periodic sampling times during the performance test period; a GSM-enabled digital onboard logger/recorder 20 for logging and recording temperatures Tᵢₙ and Tₒᵤₜ, pressures Pᵢₙ and Pₒᵤₜ, and the volumetric flow rate of water \dot{V} flowing along the test ground loop, for each measuring period (e.g. every 60 seconds), and optionally transmitting such logged/recorded GHE data to a remote transceiver station 5 (e.g. via WIFI, GSM, GPRS or other wireless protocol), that is interfaced with a remote data logging/recorder and database server 6 which, in turn, is operably connected to the Internet infrastructure, for remote access by one or more Web-enabled client computers 9, as shown in FIGS. 1A and 1B; a GPS transceiver and antenna 21, interfaced with the digital onboard data logger/recorder 20, for receiving GPS signals from GPS satellites 8 and computing the space-time position of the Portable GHE Performance Test Instrumentation System 1 at any instant in space-time within the GPS system; a Web-enabled onboard system computer 22 (e.g. universal digital controller) interfaced with a 3G/4G WIFI router 26 via a conventional communication interface (e.g. USB); a Spreadsheet Enthalpy-Based GHE Performance Calculator Program 23 illustrated in FIG. 15A, running on the wireless remote computer system 24; and an electrical grounding post 27, for grounding the electrical conductivity components to Earth ground when configured and operating with an electrical power supply or source (e.g. electrical power generator) provided on the GHE performance test site.

The Web-enabled onboard system computer 22 (i.e. system controller) can be realized by a programmed microprocessor having system and I/O buses, supporting one or more of the following data communication interfaces: USB, Firewire, and Ethernet communication interfaces, through which the 3G/4G WIFI router 26 is interfaced. In general, the system computer 22 supports multiple analog and digital signal inputs, and multiple communication protocols, for example: RS422/485, Ethernet 10Base-T TCP/IP, Modbus RTU, Ethernet 10Base-T TCP/IP Modbus, BacNet, and Lonworks data communication protocols, as well as WIFI (802.11), infrared (IR) R100 remote communication protocol. Such communication protocols allows the system computer 22 to communication with, control and monitor the various component devices (e.g. subsystems) employed within the GHE performance test instrument system, as well as communicate with the remote computer system 24, RF transceiver station 5, server 6, remote client computers 9, and other computing devices operable connected to the Internet or other packet-based communication networks.

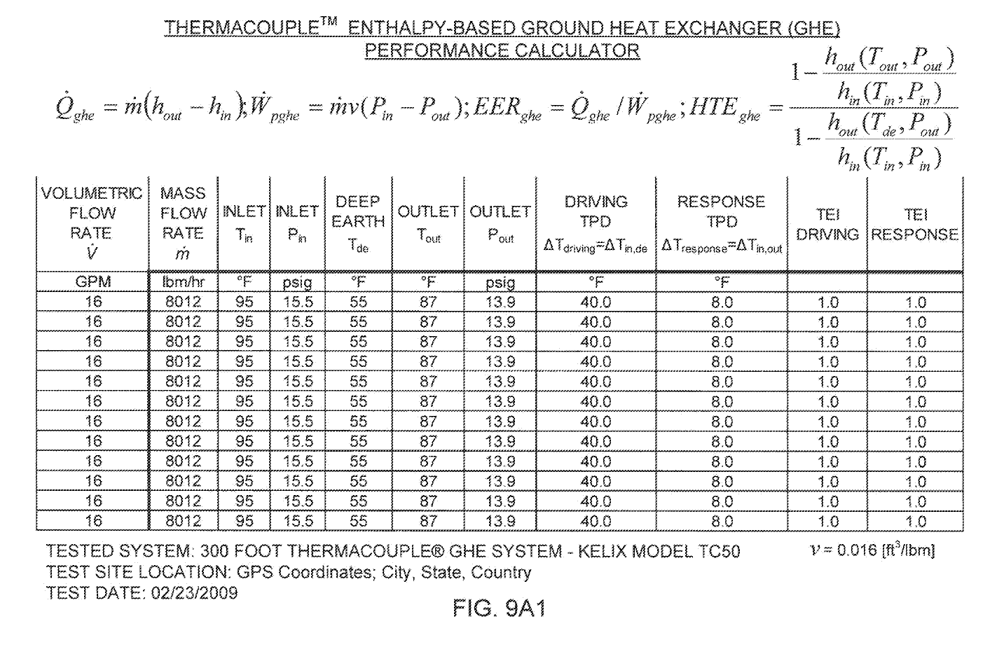

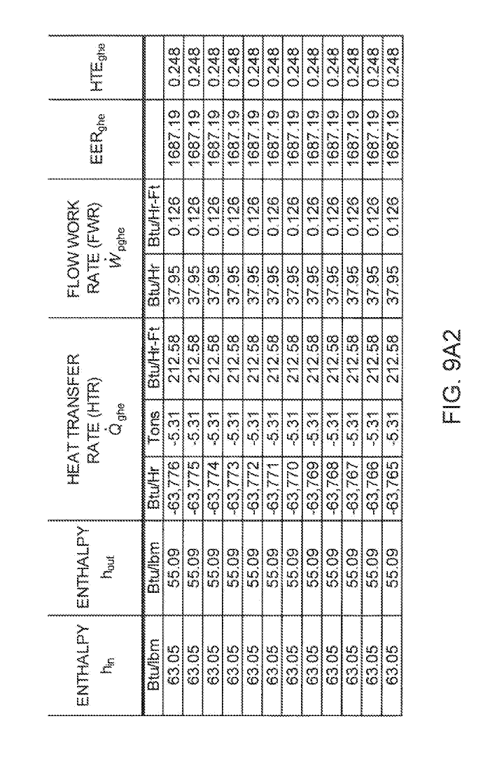

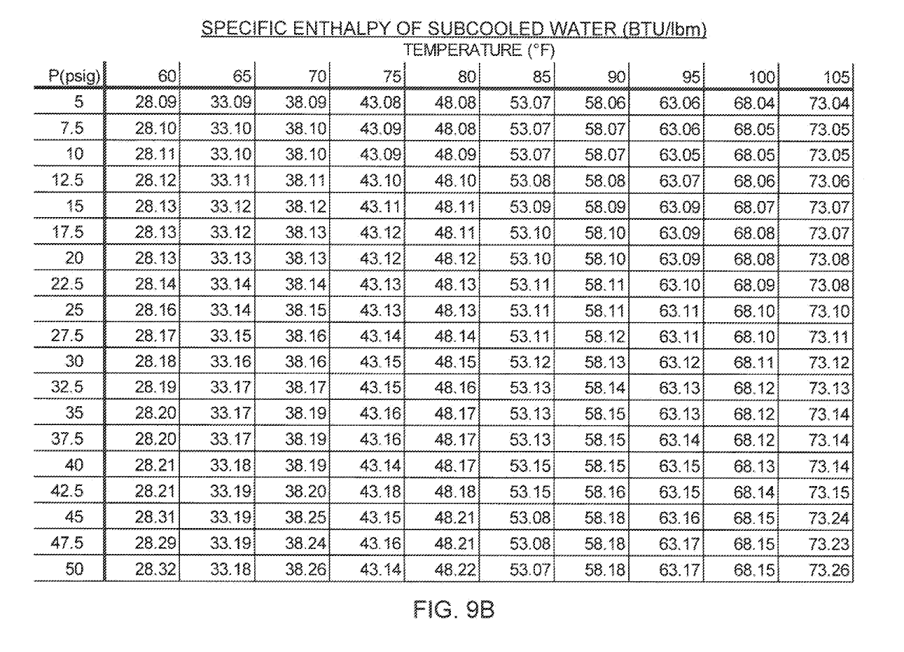

The system computer 22 performs a number of important functions, including: (i) controlling and managing the operation of the enthalpy-based GHE Performance Test Instrumentation System during all phases of its performance test operations as specified in FIG. 10A through 10I; (ii) enabling the remote programming of test parameters (i.e. inlet temperature of water flowing into the GHE installation, and the volumetric flow rate of water flowing through the GHE installation) using a Web-based browser running on the remote computer system 24, in communication with system computer 22, over a wired or wireless communication link (e.g. Internet connection); and (iii) providing sufficient communication interfaces to support digital communication between the digital data logger/recorder 20 and the remote computer system 24, during performance test operations. During performance testing operations, the remote wireless computer system 24 can establish a communication link with the system computer 22, via the 3G/4G WIFI router 26, and periodically import blocks of test data logged and recorded by logger/recorder 20, into the Spreadsheet GHE performance calculator program 23, for processing and calculation of GHE performance measures of the present invention as shown in FIGS. 9A1 and 9A2, and display on the LCD panel of the remote computer system. Alternatively, the remote wireless computer system 24 can establish a direct communication link with logger/recorder 20, and periodically import blocks of test data therefrom, into the Spreadsheet GHE performance calculator program 23, for processing and calculation of GHE performance measures of the present invention as shown in FIGS. 9A1 and 9A2, and displayed on the LCD panel of the remote computer system.

In the illustrative embodiment, a Web-browser or a Web-enabled application running on the remote computer system 24 is used to remotely program the test parameters (e.g. control variables) such as (Tᵢₙ, \dot{V}_{ghe}) used during each GHE performance test, as specified in FIGS. 10A through 10I, in accordance with the principles of the present invention. The control parameters specified in FIGS. 10A through 10I are programmed into memory in the system computer 22. Using these parameters and the control process specified at Steps 8 through 26 in FIGS. 10C through 10F, the system computer 22 is programmed to automatically coordinate and control the GHE Performance Instrument System 1 so that the GHE performance testing process of the present invention (having thermal loading and unloading cycles) can be carried out in an automated (or semi-automated manner and remotely monitored using the remote computer system 24, which may be located anywhere on Earth, relative to the GHE test site, while in wireless digital communication with the wireless GHE Performance Test Instrument 1. In the preferred embodiment, remote computer system 24 is capable of generating, on a quasi-real-time, basis the GHE Performance Charts illustrated in FIGS. 11A through 11E and 12A through 12D, as specified in Steps 27 through 39.

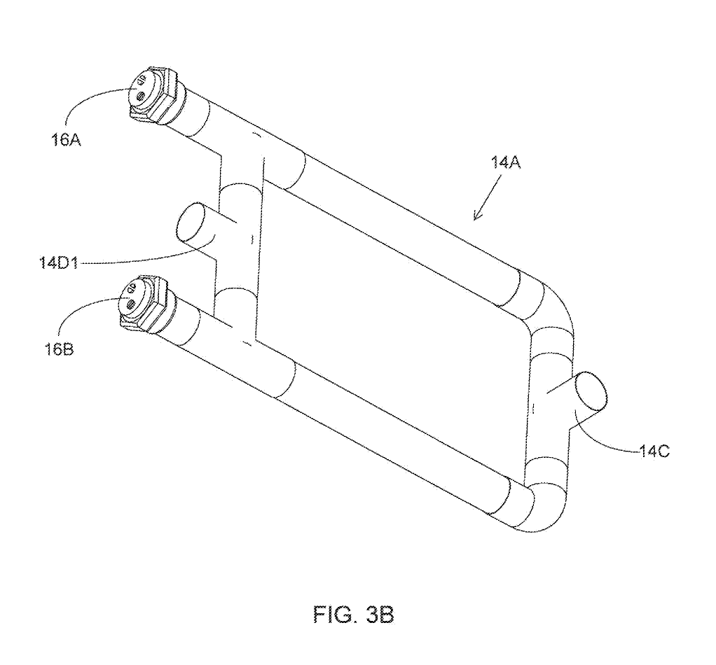

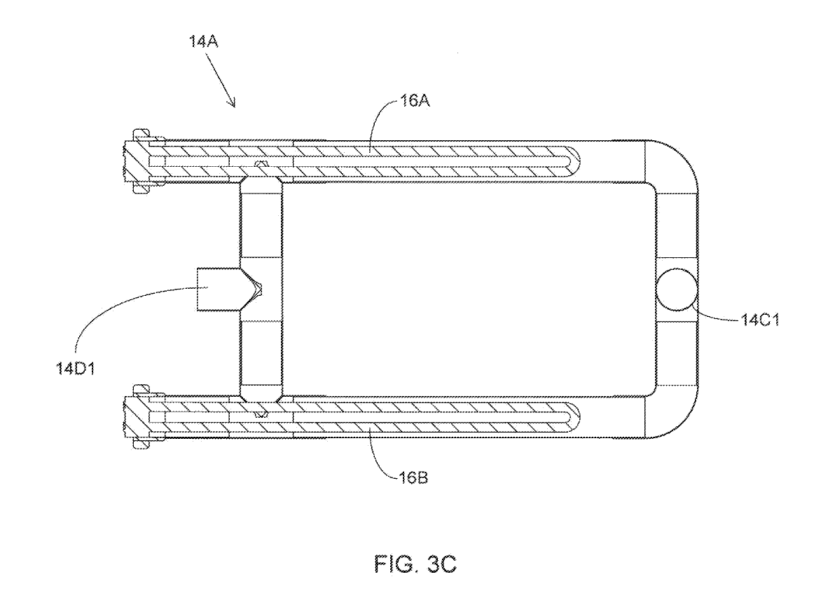

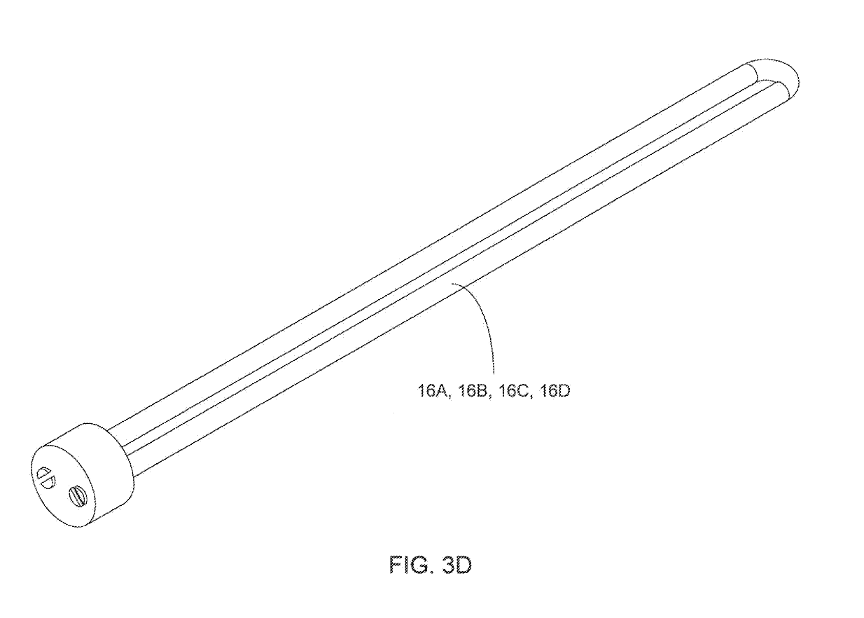

In FIGS. 1D, 2A, 2B, 3A, 3B and 3C, the Portable Enthalpy-Based GHE Performance Test Instrumentation System 1 is shown comprising an assembly of components contained in a rugged high-impact plastic housing 30 having an upper housing portion 30B supporting various components, and a lower housing portion 30B containing a water heating, pumping and measuring assembly 14 shown in greater detail in FIGS. 3A, 3B an 3C.

As shown in FIGS. 1C, 1D and 2A, the upper housing portion 30A includes a pair of apertures 30, through which flexible thermally-insulated inlet and outlet hoses are connected to the inlet and outlet ports of the apparatus 14, and also the inlet and outlet ports of the GHE installation 2, shown in FIGS. 1B and 1C. During transport operations, these apertures 30 are occluded via rubber plugs. Rubber plugs 32 are also used to close off the electrical power ports formed in the lower portion of the housing 30B, and leading to the power supply module 29 of the system. Through these ports, electrical power cable extends between the power supply module 29 and the electrical power supply (e.g. generator) 70 provided at the ground loop test site. Also, in the upper portion of the housing, an electrically-powered fan is provided for achieving ventilation through the housing when operated with its upper housing portion 30A is closed, as shown in FIGS. 1C, 1D and 2B.

### Portable Enthalpy-Based GHE Performance Test Instrumentation System of the Present Invention

As shown in FIG. 4A, the Portable Enthalpy-Based GHE Performance Test Instrumentation System shown in FIGS. 1A through 2B, operably connected to a concentric-tube type geothermal ground heat exchanger, and showing its primary components, namely, a ground loop water pumping module with flow rate control, a ground loop water heating module with water temperature control module, a data logger/recorder, a portable computer system interfaced with the data logger/recorder and running a spreadsheet enthalpy-based spreadsheet GHE performance calculator program, and a system controller for remotely controlling the components of the enthalpy-based GHE Performance Test Instrumentation System, via a wireless communication link over the Internet or other network;

Preferably, the Spreadsheet GHE Performance Calculator Program illustrated in FIG. 15A has integrated a steam table for sub-cooled water over the range of measured temperature and pressure values, expected during testing operations. In the preferred embodiment of the present invention, this integrated steam table (partially) shown in FIG. 9B contains the specific enthalpy of water, known as h=ƒ(p,T), defined as a function of temperature and pressure, in accordance with the International Association for the Properties of Water and Steam (IAPWS) Industrial Formulation 1997, known as the “IAPWSIF97” standard.

The Spreadsheet GHE Performance Calculator Program running on the portable computer system performs a number of functions, namely: (i) importing the logged-in temperature, pressure and mass (or volume) flow rate data values; (ii) determining the input and output specific enthalpy values of water hᵢₙ and hₒᵤₜ using measured water temperatures and pressures Tᵢₙ, Pᵢₙ and Tₒᵤₜ, Pₒᵤₜ, respectively, and the integrated steam table for water; (iii) using the formula \dot{W}_{pghe}=\dot{m}v(Pᵢₙ−Pₒᵤₜ) derived hereinafter to calculate the actual flow work rate (FWR), \dot{W}_{pghe} \dot{W}_{pghe} (i.e. the rate of work actually performed by the ground loop pump to pump the water through the ground heat exchanger) at the controlled volume/mass flow rate \dot{m} during steady-state temperature conditions Tᵢₙ=Tₒᵤₜ=T_{de}, during performance testing operations, expressed in units of [BTU/Hr] and [HP], and (iv) for each measuring period, using the enthalpy-based formula \dot{Q}_{ghe}=\dot{m}(hₒᵤₜ−hᵢₙ) derived hereinafter to calculate the actual rate of heat energy transfer \dot{Q}_{ghe} being exchanged between the ground heat exchanging system and the deep Earth (at T_{de}) in units of [BTUs/Hr]; (v) using the formula

$${ER}_{ghe} = \frac{{\dot{Q}}_{ghe}}{{\dot{W}}_{pghe}} = \frac{1}{v} \frac{( {h}_{out} - {h}_{in} )}{( {P}_{in} - {P}_{out} )}$$

derived hereinafter to calculate the energy efficiency ratio (EER) for the ground heat exchanger indicating how many of units of thermal power [BTUs/Hr] are exchanged with the deep Earth by the ground heat exchanger for every one (1) unit of electrical power supplied to the electrically powered pump pushing/pulling water through the ground heat exchanger; using the formula

$${HTE}_{ghe} = \frac{{\dot{Q}}_{ghe}^{ideal}}{{\dot{Q}}_{ghe}^{ideal}} = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}$$

derived hereinafter to calculate the heat transfer (HTE) of any GHE installation, measured in dimensionless units, and equal to the ratio of (i) the actual real (empirically-determined) enthalpy difference between the inlet and outlet ports of the GHE when input and outlet water temperatures are unequal and in thermal equilibrium, to (ii) the ideal enthalpy difference between the inlet and outlet ports of the GHE when outlet water temperature is equal to and in thermal equilibrium with the deep Earth temperature about the GHE.

As will be shown in great detail hereinafter, the enthalpy-based formulas for \dot{Q}_{ghe}, \dot{W}_{glp}, EER_{ghe} and HTE_{ghe} are derived from mathematical modeling of the ground heat exchanging (GHE) system, through the application of the First Law of Thermodynamics based on energy and mass conservation and balancing principles, well known in the fields of thermodynamics and thermal and mass flow engineering.

Developing a Mathematical Model for the Ground Heat Exchanging (GHE) System and its Portable Enthalpy-Based GHE Performance Test Instrumentation System in Accordance with Thermodynamic Energy and Mass Conservation Principles

The first step to designing and developing the Enthalpy-Based GHE Performance Test Instrumentation System and method of the present invention, involves developing a mathematical model for the ground heat exchanging (GHE) system which will be connected to the system during performance test operations. To build a thermodynamic model for the system, one must first define the thermodynamic “system” which, in general, can be any quantity of matter upon which attention is focused for study. In the present invention, the thermodynamic system will be identified as the water mass flowing through the ground heat exchanger (GHE) installed in the deep Earth (de) environment. Everything external to the system shall be called the thermodynamic surroundings, and the system is separated from the surroundings by the system boundaries. The system boundaries may either be fixed or movable. In the present invention, there is a need to analyze the ground heat exchanger in thermodynamic terms, involving a flow of mass into and out of the underground heat exchanging device. The thermodynamic modeling process involves specifying a control surface or volume, such as the heat exchanger tube walls, and mass, as well as that heat energy that may flow across the control surface or volume, during system operation.

In the field of thermodynamics, “systems” are classified as isolated, closed, or open, based on the possible transfer of mass and energy across the system boundaries. A control volume is a fixed region in space chosen for the thermodynamic study of mass and energy balances for flowing systems. The boundary of the control volume may be a real or imaginary envelope. The control surface is the boundary of the control volume. An isolated system is one that is not influenced in any way by the surroundings. This means that no energy in the form of heat or work may cross the boundary of the system. In addition, no mass may cross the boundary of the system. A closed system has no transfer of mass with its surroundings, but may have a transfer of energy (either heat or work) with its surroundings. An open system is one that may have a transfer of both mass and energy with its surroundings (i.e. mass, heat, and external work are allowed to cross the control boundary).

When a system is in equilibrium with regard to all possible changes in state, the system is in thermodynamic equilibrium. Steady state is that circumstance in which there is no accumulation of mass or energy within the control volume, and the properties at any point within the system are independent of time. Whenever one or more of the properties of a system change, a change in the state of the system occurs. The path of the succession of states through which the system passes is called the thermodynamic process. One example of a thermodynamic process is increasing the temperature of a fluid while maintaining a constant pressure. Another example is increasing the pressure of a confined gas while maintaining a constant temperature. Thermodynamic processes occur in most thermodynamic systems, including geothermal ground heat exchangers.

In a thermodynamic system, energy is transferred and sometimes converted into other forms of energy, yet the sum of all energies must obey the First Law of Thermodynamics. As will be described in greater detail hereinafter, the various forms of energy that might be transferred in a system include potential energy (PE), kinetic energy (KE), internal energy (U), flow energy (P-V), work (\dot{W}) and heat (\dot{Q}). Such diverse forms of energy may be measured in numerous basic units. It will be helpful to concisely summarize such units of energy measurement.

In general, there are three types of units to measure energy: (1) mechanical units, such as the foot-pound-force (ft-lbf); (2) thermal units, such as the British thermal unit (Btu); and (3) electrical units, such as the watt-second (W-sec). In the mks (meter, kilogram and second) and cgs (centimeter, grams and second) systems, the mechanical units of energy are the joule (j) and the erg, the thermal units are the kilocalorie (kcal) and the calorie (cal), and the electrical units are the watt-second (W-sec) and the erg. Although the units of the various forms of energy are different, they are equivalent.

In 1843, J. P. Joule conducted some very important experiments in science demonstrating quantitatively that there was a direct correspondence between mechanical and thermal energy. These experiments showed that one kilocalorie equals 4,186 [joules]. These same experiments, when performed using English system units, show that one British thermal unit (Btu) equals 778.3 [ft-lbf]. These experiments established the equivalence of mechanical and thermal energy. Other experiments established the equivalence of electrical energy with both mechanical and thermal energy. For engineering applications, these equivalence of these “energy” units is expressed by the following relationships:

1 [ft-lbf]=1.286×10−3 [Btu]=3.766×10⁻⁷ [kW-hr]

1 [Btu]=778.3 [ft-lbf]=2.928×10⁻⁴ [kW-hr]

1 [kW-hr]=3.413×10³ [Btu]=2.655×10⁶ [ft-lbf]

1 [hp-hr]=1.980×10⁶ [ft-lbf]

These relationships can be used to convert between the various English system units for the various forms of energy.

In an energy transfer system, most computations involving the energy of the working fluid are performed in units of Btu's. Forms of mechanical energy, such as potential energy, kinetic energy, and mechanical work, and other forms of energy, such as P-V energy, are usually given in foot-pounds-force. These forms of mechanical energy are converted to Btu's by using the conversion factor 1 Btu=778.3 [ft-lbf]. From this conversion factor, the mechanical equivalent of heat, denoted by the symbol J and referred to as Joule's constant, is defined as J=778 [ft lbf./BTU].

Power is defined as the time rate of doing work. It is equivalent to the rate of the energy transfer. Power has units of energy per unit time. As with energy, power may be measured in numerous basic units, but the units are equivalent. In the English system, the mechanical units of power are foot-pounds-force per second or per hour [ft-lbf/sec] or [ft-lbf/hr] and horsepower [hp]. The thermal units of power are British thermal units per hour [Btu/hr], and the electrical units of power are watts [W] or kilowatts [kW]. For engineering applications, the equivalence of these “power” units is expressed by the following relationships.

1 ft-lbf/sec=4.6263 [Btu/hr]=1.356×10⁻³ [kW]

1 Btu/hr=0.2162 f[t-lbf/sec]=2.931×10⁻⁴ [kW]

1 kW=3.413×10³ [Btu/hr]=737.6 [ft-lbf/sec]

1 Btu=778.169 [ft-lbf]

Horsepower is related to foot-pounds-force per second [ft-lbf/sec] by the following relationship: 1 hp=550.0 [ft-lbf/sec]. Also, horsepower is related to BTUs per hour by the following relationship: 1 [hp]=2546.4 [Btu/hr]. These relationships can be used to convert the English system units for power.

### Modeling the Energy and Mass Balances Across the Control Volume of the Ground Heat Exchanger and its Portable Enthalpy-Based GHE Performance Test Instrumentation System

The First Law of Thermodynamics relates to the balance of the various forms of energy as such forms of energy pertain to the specified thermodynamic system under study. Specifically, the First Law of Thermodynamics states that energy can neither be created nor destroyed, but rather transformed into various forms as the fluid or mass flow within the control volume is being studied.

In engineering, energy balances are used to quantify the energy used or produced by a system. Making an energy balance for a system is similar to making a mass balance for the system, but there are a few differences to remember, namely: that a specific system might be closed in a mass balance sense, but open as far as the energy balance is concerned; and that while it is possible to have more than one mass balance for a system, there can be only one energy balance.

The First Law of Thermodynamics addresses the total amount of energy, which consists of kinetic energy (KE), potential energy (PE) known as mechanical energy, and the internal energy (U) including flow energy (Pv), represented by specific enthalpy h of the system. For any system, energy transfer is associated with (i) mass and energy crossing the control boundary, (ii) external work and/or heat crossing the boundary, and (iii) the change of stored energy within the control volume. In general, kinetic, potential, internal, “flow” energies and the exchange of external work and/or heat energy are associated with the flow of fluid mass in the system, and must be considered during the overall energy balance of the system. In the case of the present invention, the heat transfer fluid or mass flow is water, but may be any aqueous-based fluid, in general.

To perform an energy balance for a system in accordance with the First Law of Thermodynamics, the various energies associated with water are identified as they cross the boundaries of the system, and then mathematical expressions are drawn to the energy balance of the system under analysis.

The First Law of Thermodynamics can be expressed in different ways. The First Law of Thermodynamics states that, in an open system, all energies flowing into a system are equal to all energies leaving the system, plus the change in storage of energies within the system.

When expressed over a time interval (Δt), the First Law of Thermodynamics states that the increase in the amount of energy stored in a control volume must equal the amount of energy that enters the control volume, minus the amount of energy that leaves the control volume. When applying this principle, it should be recognized that energy can enter and leave the control volume due to heat transfer (\dot{Q}) through the boundaries, work done on a by the control volume (\dot{W}), and energy advection. For the study of heat transfer, focus should be made on thermal and mechanical forms of energy. The sum of thermal and mechanical energy is not conserved because there can be conversion between other forms of energy and thermal energy. Energy conversion results in thermal energy generation, which can be either positive or negative.

When expressed as a thermal and mechanical energy balance equation over a time interval (Δₜ), the First Law of Thermodynamics states that the increase in the amount of thermal and mechanical energy stored in the control volume must equal the amount of thermal and mechanical energy that enters the control volume, minus the amount of thermal and mechanical energy that leaves the control volume, plus the amount of thermal energy that is generated within the control volume.

As the First Law of Thermodynamics must be satisfied at each and every instant of time t, it can be formulated on as rate basis as follows: the rate of increase of thermal and mechanical energy stored in the control volume must equal the rate at which thermal and mechanical energy enters the control volume, minus the rate at which thermal and mechanical energy leaves the control volume, plus the rate at which thermal energy is generated within the control volume.

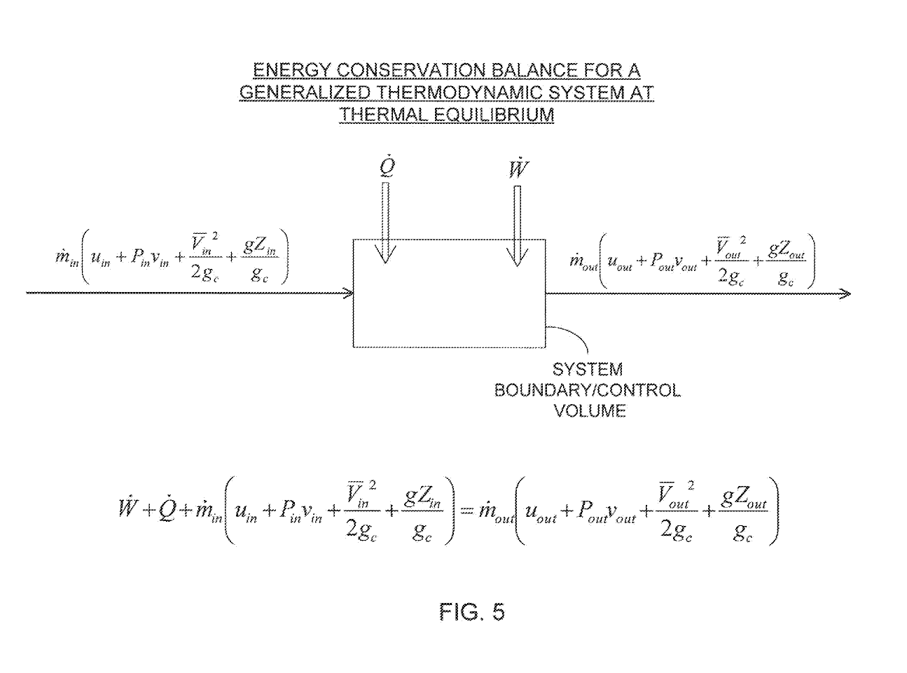

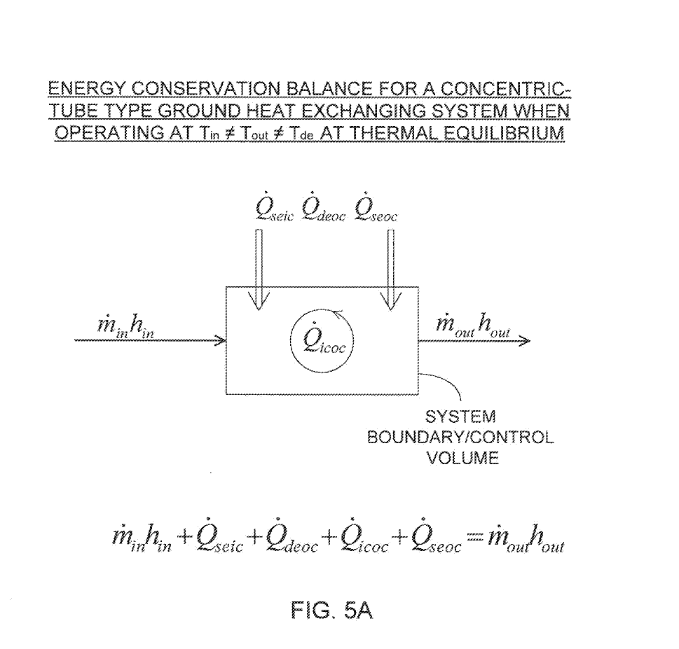

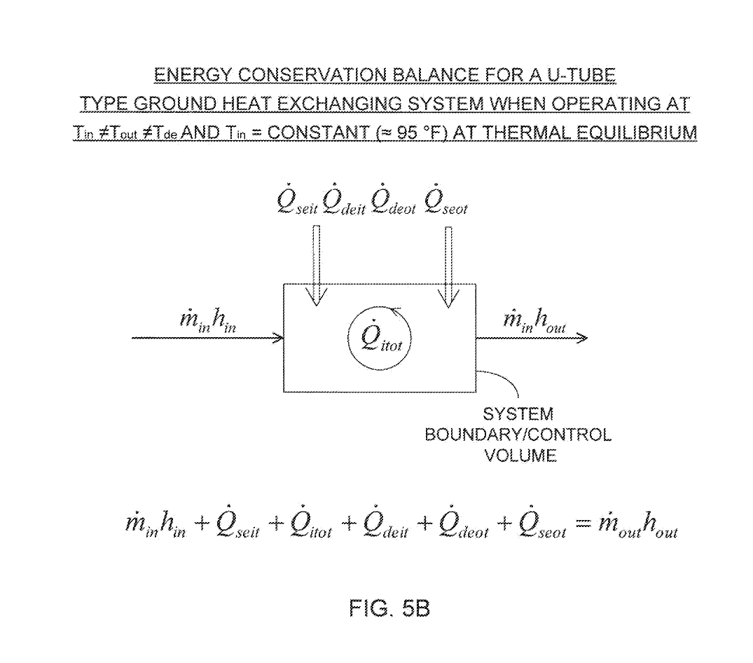

Thus, for any closed thermodynamic system, in which the rate of increase of thermal and mechanical energy stored in its control volume is zero, the First Law of Thermodynamics can be expressed in rate form as a generalized energy conservation balance, shown in FIG. 5 and given by the expression below:

$${\dot{m}}_{out} ( {u}_{out} + {P}_{out} {v}_{out} + \frac{{\overline{V}}_{out}^{2}}{2 {g}_{c}} + \frac{g {Z}_{out}}{{g}_{c}} ) = {\dot{m}}_{in} ( {u}_{in} + {P}_{in} {v}_{in} + \frac{{\overline{V}}_{in}^{2}}{2 {g}_{c}} + \frac{g {Z}_{in}}{{g}_{c}} ) + \dot{Q} + \dot{W}$$

where:
\dot{Q}=represents (all or net) heat flow rates into and out of the system (Btu/hr)
\dot{m}ᵢₙ=mass flow rate into the system (lbm/hr)
uᵢₙ=specific internal energy into the system (Btu/lbm)
Pᵢₙvᵢₙ=pressure-specific volume energy into the system (ft-lbf/lbm)
vᵢₙ=specific volume of fluid entering the system (ft³/lbm)
Pᵢₙ=pressure of fluid into the system (ft-lbf/ft²)

V̅ᵢₙ²/=KEᵢₙ=kinetic energy into the system (ft-lbf/lbm)

where
V̅ᵢₙ=average velocity of fluid into the system (ft/sec)
g_{c}=the gravitational constant (32.17 ft-lbm/lbf-sec²)

gZᵢₙ/g_{c}=_PEᵢₙ=potential energy of the fluid entering the system (ft-lbf/lbm)

where
Zᵢₙ=height above reference level (ft) (at the surface of the Earth)
g=acceleration due to gravity (ft/sec²)
g_{c}=the gravitational constant (32.17 ft-lbm/lbf-sec²)
\dot{W}=represents (all or net) work flow rates into and out of the system (ft-lbf/hr)
\dot{m}ₒᵤₜ=mass flow rate out of the system (lbm/hr)
uₒᵤₜ=specific internal energy out of the system (Btu/lbm)
Pₒᵤₜvₒᵤₜ=pressure-specific volume energy moving out of the system (ft-lbf/lbm)
vₒᵤₜ=specific volume of fluid leaving the system (ft³/lbm)
Pₒᵤₜ=pressure of fluid out of the system (ft-lbf/ft²)

V̅ₒᵤₜ²/2g_{c}=KEₒᵤₜ=kinetic energy out of the system (ft-lbf/lbm)

wherein
V̅ₒᵤₜ=average velocity of fluid moving out of the system (ft/sec)
gZₒᵤₜ/g_{c}=PEₒᵤₜ=potential energy out of the system (ft-lbf/lbm)
Zₒᵤₜ=height above reference level (ft) (at the surface of the Earth)

To determine which of these energy component terms are present in a ground heat exchanger (GHE) of the types shown in FIGS. 4C and 4D, and should be considered in any heat transfer model, it will be helpful to briefly review the nature and properties of each of these energy components in the general model, and then develop particular energy balance models for the GHEs shown in FIGS. 4C and 4D.

### Potential Energy (PE)

Potential energy (PE) is defined as the energy of position. Using English system units, it is defined by PE=mgZ/g_{c}

where
PE=potential energy [ft-lbf]
m=mass [lbm]
Z=height above some reference level [ft]
g=acceleration due to gravity [ft/sec²]
g_{c}=gravitational constant=32.17 [ft-lbm/lbf-sec²]

### Kinetic Energy (KE)

Kinetic energy (KE) is the energy of motion. Using English system units, it is defined by

KE=m V̅²/2g_{c}

where:
KE=kinetic energy [ft-lbf]
m=mass [lbm]
V̅=velocity [ft/sec]
g_{c}=gravitational constant=32.17 [ft-lbm/lbf-sec²]

### Specific Internal Energy (U)

Potential energy and kinetic energy are macroscopic forms of energy. They can be visualized in terms of the position and the velocity of objects. In addition to these macroscopic forms of energy, a substance, such a flow of mass or fluid, possesses several microscopic forms of energy. Microscopic forms of energy include those due to the rotation, vibration, translation, and interactions among the molecules of a substance. While none of these forms of energy can be measured or evaluated directly, techniques have been developed to evaluate the change in the total sum of all these microscopic forms of energy. These microscopic forms of energy are collectively called internal energy, customarily represented by the symbol U. In engineering applications, the unit of internal energy is the British thermal unit (Btu), which is also the unit of heat.

The specific internal energy (u) of a substance is its internal energy per unit mass. It equals the total internal energy (U) divided by the total mass (m).

u=U/m

where:
u=specific internal energy [Btu/lbm]
U=internal energy [Btu]
m=mass [lbm]

### Specific P-V Energy

In addition to the internal energy (U), another form of energy, called P-V energy, arises from the pressure (P) and the volume (V) of a fluid, and represents the “flow energy” of the system. It is numerically equal to PV, the product of pressure and volume. Because energy is defined as the capacity or potential energy of a system to perform work, where pressure and volume are permitted to expand performing work on its surroundings. Therefore, a fluid under pressure has the capacity to perform work. In engineering applications, the units of P-V energy, also called flow energy, are the units of pressure multiplied by volume (pounds-force per square foot times cubic feet) which equals foot-pounds force (ft-lbf). The specific P-V energy of a substance is the P-V energy per unit mass. It equals the total P-V divided by the total mass m, or the product of the pressure P and the specific volume v, and is written as Pv=PV/m where:

P=pressure [lbf/ft²]
V=volume [ft³]
v=specific volume [ft³/lbm]
m=mass [lbm]

The difference in flow energy between the inlet and outlets of a system is defined as flow work which is defined as the rate of work done by the fluid at the system outlet minus the rate of work done on the fluid at the system inlet. Flow work overcomes frictional, viscous and other fluid losses, which results in an overall pressure drop.

### Specific Enthalpy (h)

Specific enthalpy (h) is defined as h=u+Pv, where u is the specific internal energy (Btu/lbm) of the system being studied, P is the pressure of the system [lbf/ft²], and v is the specific volume [ft³/lbm] of the system. Enthalpy is a thermodynamic property of a substance, like pressure, temperature, and volume, but it cannot be measured directly. Normally, the enthalpy of a substance is given with respect to some reference value. For example, the specific enthalpy of water or steam is given using the reference that the specific enthalpy of water is zero at 0.01° C. and normal atmospheric pressure. The fact that the absolute value of specific enthalpy is unknown is not a problem, however, because it is the change in specific enthalpy (Δh) and not the absolute value that is important in practical problems. Steam tables include values of specific enthalpy as part of the information tabulated, and the specific enthalpy of water, h=ƒ(p,T) is defined as a function of temperature and pressure, in accordance with the International Association for the Properties of Water and Steam (IAPWS) Industrial Formulation 1997, known as the “IAPWSIF97” standard.

### Work (W)

Kinetic energy, potential energy, internal energy, and P-V energy are forms of energy that are properties of a system. Work is a form of energy, but it is energy in transit. Work is not a property of a system. Work is a process done by or on a system, but a system contains no work. Work is defined for mechanical systems as the action of a force on an object through a distance. It equals the product of the force (F) times the displacement (d).

W=Fd

where:
W=work [ft-lbf]
F=force [lbf]
d=displacement [ft]

The rate at which Work is performed on or by a system is defined as Work Rate, \dot{W}, and is the time derivative of Work, W. Also, it is noted that work rate \dot{W} can also be defined in rotational systems where a torque is applied at a distance to cause angular displacement, rather than linear displacement.

### Heat (Q)

Heat, like work, is energy in transit. The transfer of energy as heat, however, occurs at the molecular level as a result of a temperature difference. The symbol Q is used to denote heat. This should not be confused with the symbol \dot{Q} used to denote heat transfer rate, which the rate at which is transferred over time, the first time derivative of Q. In engineering applications, the unit of heat is the British thermal unit (Btu). Specifically, this is called the 60 degree Btu because it is measured by a one degree temperature change from 59.5 to 60.5° F.

As with work, the amount of heat transferred depends upon the path, and not simply on the initial and final conditions of the system. Also, as with work, it is important to distinguish between heat added to a system from its surroundings and heat removed from a system to its surroundings. A positive value for heat indicates that heat is added to the system by its surroundings. This is in contrast to work that is positive when energy is transferred from the system and negative when transferred to the system. The symbol q is sometimes used to indicate the heat added to or removed from a system per unit mass. The symbol q equals the total heat (Q) added or removed divided by the mass (m). The term “specific heat” is not used for q since specific heat is used for another parameter. The quantity represented by q is referred to simply as the heat transferred per unit mass.

q=Q/m

where:
q=heat transferred per unit mass [Btu/lbm]
Q=heat transferred [Btu]
m=mass [lbm]
Defining a Control Volume for the Ground Heat Exchanging (GHE) System to be Tested Using the Enthalpy-Based GHE Performance Test Instrumentation System and Method of the Present Invention, and then Constructing an Energy Balance Equation According to the First Law of Thermodynamics

The control volume approach will be used to analyze the ground heat exchangers of FIGS. 4A and 4D, and then constructing an energy balance for each system. In the control volume approach, a fixed region in space is established with specified control boundaries. The energies that cross the boundary of this control volume, including those with the mass crossing the boundary, are then studied and the energy balance performed.

As shown in FIG. 5B, the control volume of the concentric-tube ground heat exchanger system in FIGS. 1A, 1B and 4C can be defined as the surfaces coincident with the inner and outer surfaces of the inner tube section of the concentric-tube ground heat exchanger, the inner surfaces of the outer tube sections, and the inner surfaces of the inlet and outlet ports of the header/distributor of the ground heat exchanger, connecting with the inner and outer tube sections.

In general, the forms of energy that may cross the control volume boundary include those associated with the mass (m) crossing the boundary. Mass in motion has potential (PE), kinetic (KE), and internal energy (U). In addition, since the mass flow is normally supplied with some driving power (e.g. a pump), there is another form of energy associated with the fluid caused by its pressure, referred to as “flow energy” (i.e. Pv-work), discussed above. The thermodynamic terms thus representing the various forms of energy crossing the control boundary with the mass are given as \dot{m}(u+Pv+KE+PE).

In open and closed system analysis, the u and Pv terms occur so frequently that another property, specific enthalpy, has been defined as h=u+Pv, and has been discussed in detail above. This results in the above expression being written as \dot{m}(h+KE+PE). In addition to the mass and its energies, externally applied work (W), usually designated as shaft work, is another form of energy that may cross the system boundary. To complete and satisfy the conservation of energy relationship, energy that is caused by neither mass nor shaft work, is classified as heat energy (\dot{Q}) These relationships can be used to reformulate the Eulerian energy conservation equation as follows:

\dot{m}(hₒᵤₜ+PEₒᵤₜ+KEₒᵤₜ)\dot{m}=(hᵢₙ+PEᵢₙ+KEᵢₙ)+\dot{Q}+\dot{W}

where:
\dot{m}=mass flow rate of working fluid into and out of the system [lbm/hr]
hᵢₙ=specific enthalpy of the working fluid entering the system [Btu/lbm]
hₒᵤₜ=specific enthalpy of the working fluid leaving the system [Btu/lbm]
PEᵢₙ=specific potential energy of working fluid entering the system [ft-lbf/lbm]
PEₒᵤₜ=specific potential energy of working fluid leaving the system [ft-lbf/lbm]
KEᵢₙ=specific kinetic energy of working fluid entering the system [ft-lbf/lbm]
KEₒᵤₜ=specific kinetic energy of working fluid leaving the system [ft-lbf/lbm]
\dot{W}=net rate of work done by the system [ft-lbf/hr]
\dot{Q}=net heat transfer rate into the system [Btu/hr]

When the thermodynamic system (e.g. heat transferring fluid being studied) changes its properties (i.e. temperature, pressure, volume) from one value to another as a consequence of work or heat or internal energy exchange, then it is said that the fluid has gone through a “process.” In some processes, the relationships between pressure, temperature, and volume are specified as the fluid goes from one thermodynamic state to another. The most common processes are those in which the temperature, pressure, or volume is held constant during the process. These would be classified as isothermal, isobaric, or iso-volumetric processes, respectively. If the fluid passes through various processes and then eventually returns to the same state it began with, then the system is said to have undergone a cyclic process.

In the geothermal ground heat exchanging systems under consideration, the potential and kinetic energy terms PE and KE and work rate term \dot{W} are recognized as being negligible and thus considered zero, and the mass flow rate entering the system equals the mass flow rate leaving the system \dot{m}₁=\dot{m}₂=\dot{m}, greatly simplifying the energy balance equation for each ground heat exchanging system, as follows:

\dot{m}hₒᵤₜ=\dot{m}hᵢₙ+\dot{Q}

With algebraic manipulation, the energy balance equation can be expressed as:

\dot{Q}=\dot{m}(hₒᵤₜ−hᵢₙ)

At this stage, it is helpful to recognize the different heat transfer rate components operating within each type of ground heat exchanging system, however small or negligible they may be, and thereafter decide to eliminate particular such terms from the model based on rational analysis, consistent with observable facts.

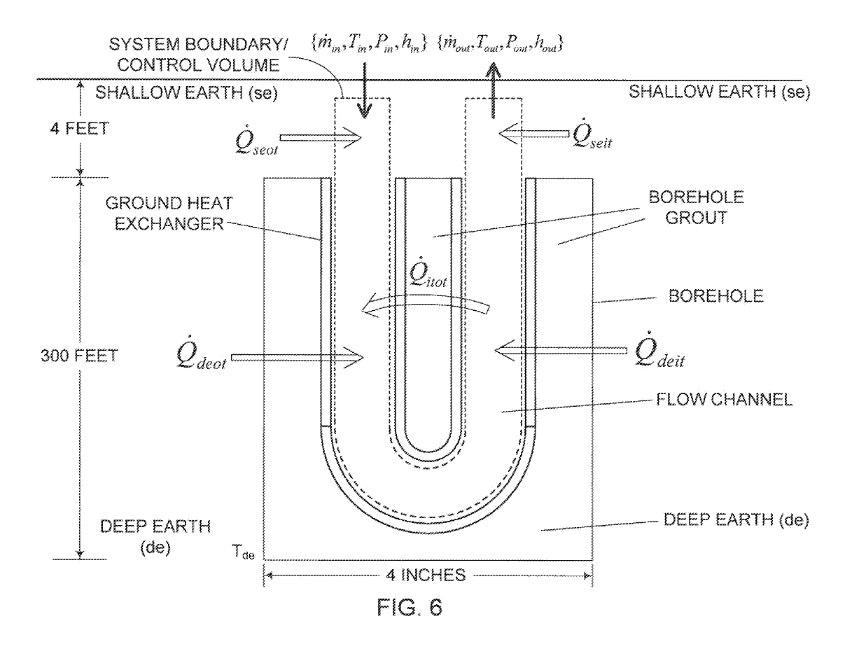

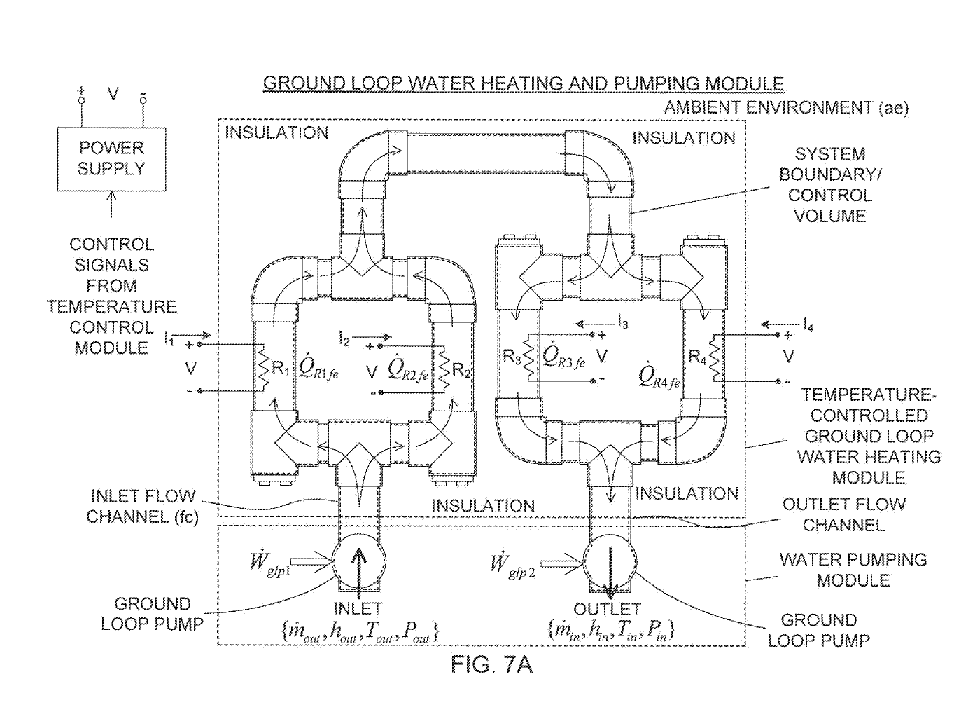

The potential heat transfer rate terms associated with a concentric-tube type ground heat exchanger are identified as \dot{Q}_{seic} \dot{Q}_{icoc} \dot{Q}_{icoc} \dot{Q}_{seoc} as shown in FIG. 5B, and graphically illustrated in the model of FIG. 6.

Notably, the terms \dot{Q}_{seic} and \dot{Q}_{seoc} will be negligible in concentric-tube ground heat exchanging systems constructed using HPDE header/distributor components and HDPE piping between ground heat exchangers, because HDPE plastic has an extremely low thermal conductivity (i.e. high thermal resistivity). Also, the cross flow channel heat transfer term \dot{Q}_{icoc} will be negligible when concentric-tube ground heat exchanging systems employ PVC inner tubes and supports laminar flows along the inner flow channel, as taught in U.S. Pat. No. 7,343,753, supra, incorporated herein by reference. The reason is because PVC has an extremely low thermal conductivity (i.e. high thermal resistivity) and laminar flow along the inner flow channel (oc) of the inner tube of the concentric-tube ground heat exchanger will create sufficient thermal boundary layers, and establish very low heat transfer coefficients for convective and conductive forms of heat flow, from the inner flow channel to the outer flow channel (via the inner tube wall). Based on such rational analysis, the energy balance equation for the concentric-tube ground heat exchangers employing laminar and turbulence flows, as taught in U.S. Pat. No. 7,343,753, reduces to the following expression:

\dot{Q}_{deoc}=\dot{m}(hₒᵤₜ−hᵢₙ)

By definition, the heat transfer rate for the concentric-tube ground heat exchanger can be then defined as \dot{Q}_{ghe} and provided by the following equation:

\dot{Q}_{ghe}=\dot{m}(hₒᵤₜ−hᵢₙ)

This enthalpy-based heat transfer rate formula will hold for values of mass flow rates, and entering and leaving temperatures and pressures for which the U-tube ground heat exchanger has been designed to operate. Also this enthalpy-based heat transfer rate equation will be used in the method of heat transfer rate testing described in FIGS. 10A through 101 when testing the heat transfer rate performance of any concentric-tube ground heat exchanger in accordance with the principles of the present invention.

The potential heat transfer rate terms associated with a U-Tube type ground heat exchanger include \dot{Q}ₛₑᵢₜ \dot{Q}ᵢₜₒₜ \dot{Q}_{deit} \dot{Q}_{deot} \dot{Q}ₛₑₒₜ as shown in FIG. 5C, and graphically illustrated in the model of FIG. 6.

Notably, the terms \dot{Q}ₛₑᵢₜ and \dot{Q}ₛₑₒₜ will be negligible in U-tube type ground heat exchanging systems constructed using HDPE piping between ground heat exchangers, because HDPE plastic has an extremely low thermal conductivity (i.e. high thermal resistivity). However, the cross tube heat transfer term \dot{Q}ᵢₜₒₜ will not be negligible when U-tube ground heat exchanging systems employ HDPE and thermally conductive grouting, resulting in thermal short-circuiting and reduction in efficiency of the U-tube ground heat exchanger. This is because typically the temperature gradient between the HDPE inlet tube (it) and the HPDE outlet tube (ot) will not be insignificant due to the relatively close spacing between these tubes and the presence of thermally-conductive grouting disposed therebetween. In effect, such thermal short-circuiting caused by heat transfer rate will reduce the net effect of positive heat transfer rates \dot{Q}_{deit} and \dot{Q}_{deot} supported between the deep Earth (at temperature T_{de}) and the inlet tube (it) and outlet tube (ot) of any U-tube ground heat exchanger construction, and can be considered a net heat transfer rate between the U-tube ground heat exchanger and the deep Earth, represented by the net heat transfer rate term \dot{Q}_{ghe}=\dot{Q}_{deit}+\dot{Q}_{deot}+\dot{Q}ᵢₜₒₜ. Based on such rational analysis, the energy balance equation for the U-tube ground heat exchanger also reduces to the following expression:

\dot{Q}_{ghe}=\dot{m}(hₒᵤₜ−hᵢₙ)

This enthalpy-based heat transfer rate formula will hold for values of mass flow rates, and entering and leaving temperatures and pressures for which the U-tube ground heat exchanger has been designed to operate. This same heat transfer rate equation will be also used in the method of heat transfer rate testing illustrated in FIGS. 10A through 10I when testing the performance of any U-tube type ground heat exchanger, or other type of geothermal ground heat exchanger, in accordance with the principles of the present invention.
Defining the Control Volume for the Portable Enthalpy-Based Ground Heat Exchanger (GHE) Performance Test Instrumentation System of the Present Invention, and then Constructing an Energy Balance Equation According to the First Law of Thermodynamics

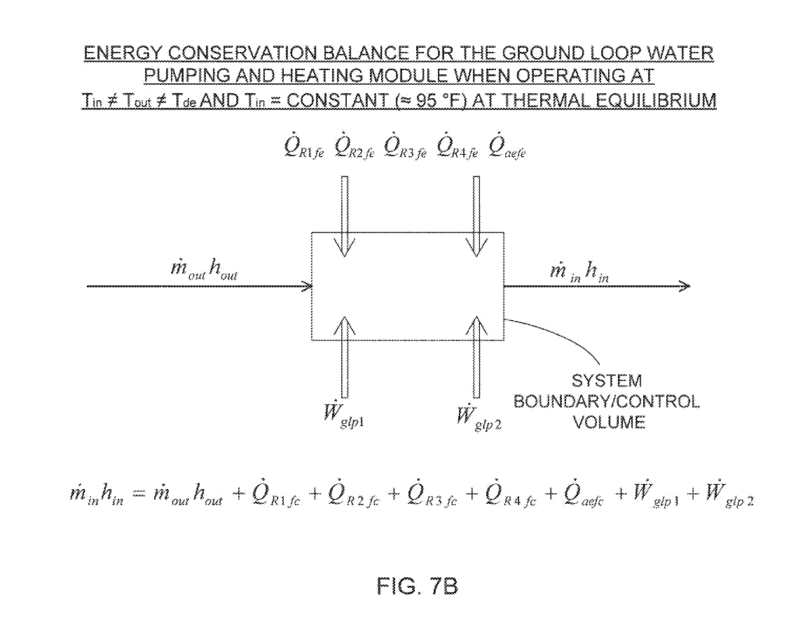

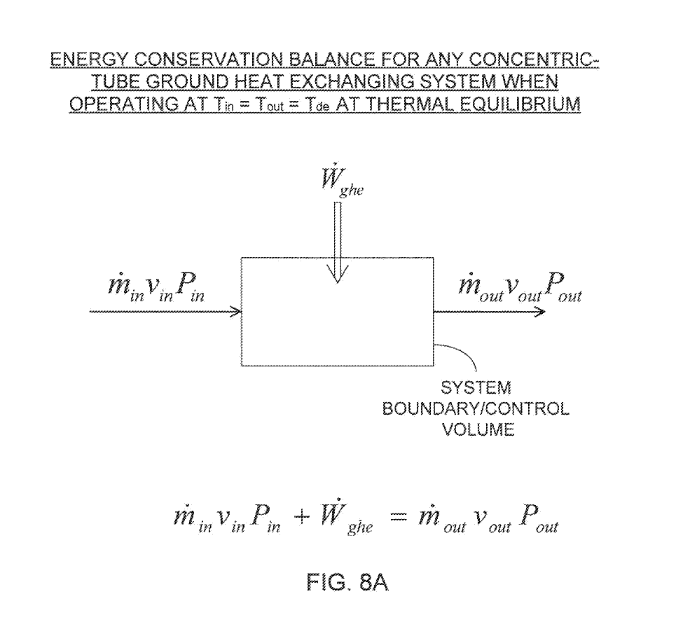

The control volume approach will be used to analyze the Portable Enthalpy-Based GHE Performance Test Instrumentation System of FIG. 7A, and then an energy balance equation will be derived for the system. From the energy balance equation, a heat transfer rate equation will be derived which describe the rate of heat energy which will need to be generated by the electrically-driven heating elements R₁ through R₄, supplied with electrical power supplies P₁ through P₄, respectively, so that the temperature state of the water entering the ground heat exchanger will remain substantially constant during the long-term HTR performance testing operations in a ground loop field test site.

As shown in FIG. 7A the control volume of the GHE Performance Test System are defined as the surfaces coincident with the outer surfaces of flow tube sections of ground loop heating module, which are surrounded by thermal insulation material to minimize heat transfers between the flow channels and the ambient environment (ae). Along these flow channels (fe), the four heating elements are mounted so that water flows thereabout at a constant mass flow rate \dot{m}ₒᵤₜ=\dot{m}ᵢₙ controlled by the pair of water pumps provided in the HTR test system.

As illustrated in FIG. 7A, the state properties of water returning from the ground loop heat exchanger, and entering the temperature-controlled ground loop water heating module, are defined by {\dot{m}ₒᵤₜ,Tₒᵤₜ,Pₒᵤₜ,hₒᵤₜ}, whereas the state properties of water exiting the water heating module and entering the ground heat exchanger under testing, are defined by {\dot{m}ᵢₙ,Tᵢₙ,Pᵢₙ,hᵢₙ}.

As shown in FIG. 7B, applying the rate form of the First Law of Thermodynamics to the control volume of this system results in the following energy balance equation:

\dot{m}ᵢₙhᵢₙ=\dot{m}ₒᵤₜhₒᵤₜ+\dot{Q}_{R1 fc}+\dot{Q}_{R2 fc}+\dot{Q}_{R3 fc}+\dot{Q}_{R4 fc}+\dot{Q}_{aefc}+\dot{W}_{glp1}+\dot{W}_{glp2}

The heat transfer flow rate from the ambient environment to the flow channels of the water heating apparatus, \dot{Q}_{aefc} will be negligible when packing the tubes of the apparatus in thermal insulation, as specified in FIG. 7A. Also, the heat generation rates for each of the four heating elements along the flow channels of the water pumping and heating module, are denoted by \dot{Q}_{R1 fc} \dot{Q}_{R2 fc} \dot{Q}_{R3 fc} \dot{Q}_{R4 fc}, respectively.

Through excellent heat convection design, and material science, very high energy conversion rates can be achieved, to efficiently introduce heat energy into the constant mass flow of the system (across its control volume), according to the following electrical-thermal energy conversion formulas:

$${VI}_{1} = \frac{{V}_{2}}{{R}_{1}} = {\dot{Q}}_{R 1 fc} {VI}_{2} = \frac{{V}_{2}}{{R}_{2}} = {\dot{Q}}_{R 2 fc}$$

$${VI}_{3} = \frac{{V}_{2}}{{R}_{3}} = {\dot{Q}}_{R 3 fc} {VI}_{4} = \frac{{V}_{2}}{{R}_{4}} = {\dot{Q}}_{R 4 fc}$$

wherein total power supplied to the water heating elements R₁, R₂, R₃ and R₄ is equal to the total power supplied to the water heating module, providing the power equation P_{Heater}=VI₁+VI₂+VI₃+VI₄, where V is a constant voltage supplied across each heating element, and electrical currents I₁, I₂, I₃ and I₄ flow through heating elements R₁, R₂, R₃ and R₄, respectively, during water heating operations.

Also, ignoring heat losses and inefficiencies associated with the pump modules, the total power supplied to the pump modules is equal to \dot{W}_{glp1,2}=VI_{glp1}+VI_{glp2} where V is a constant voltage supplied across each pump module, and electrical currents I_{glp1},I_{glp2} flow through the respective pump modules during water pumping conditions.

The sum of the four heat generation processes \dot{Q}_{R1 fc} \dot{Q}_{R2 fc} \dot{Q}_{R3 fc} \dot{Q}_{R4 fc} can be denoted as \dot{Q}ₕₑₐₜₑᵣ and the energy balance equation for the Portable Enthalpy-Based GHE Performance Test System be expressed as:

\dot{m}ᵢₙhᵢₙ=\dot{m}ₒᵤₜhₒᵤₜ+\dot{Q}ₕₑₐₜₑᵣ+\dot{W}_{glp1}+\dot{W}_{glp2}

As the inlet and outlet mass flow rates are constant, \dot{m}₁=\dot{m}₂=\dot{m}, the energy balance equation above can be expressed as follows:

\dot{Q}ₕₑₐₜₑᵣ=\dot{m}(hᵢₙ−hₒᵤₜ)−\dot{W}_{glp1}−\dot{W}_{glp2}

Using algebraic manipulation, the energy balance equation can be expressed as:

\dot{Q}ₕₑₐₜₑᵣ+\dot{W}_{glp1}+\dot{W}_{glp2}=−\dot{m}(hₒᵤₜ−hᵢₙ)

Recognizing that \dot{Q}_{ghe}=\dot{m}(hₒᵤₜ−hᵢₙ), the energy conservation balance can be reduced to the expression:

\dot{Q}ₕₑₐₜₑᵣ+\dot{W}_{glp1}+\dot{W}_{glp2}=−\dot{Q}_{ghe}

which states that the rate of “heat energy” introduced into the ground loop water stream by the heater, \dot{Q}ₕₑₐₜₑᵣ plus the rate of work done by (i.e. flow energy introduced into) the ground loop pumps in the Portable Enthalpy-Based GHE Performance Test System, \dot{W}_{glp1}+\dot{W}_{glp2}, equals the rate of heat energy exchanged by the test ground heat exchanger (GHE) with the deep Earth, \dot{Q}_{ghe}, during ground heat exchanger test operations. However, as the expected rate of heat energy introduced into the water stream by the heating elements will be substantially greater than the rate of “flow energy” introduced into the water stream by the pumps (e.g. by a factor of 10 or more), the above energy balance equation can be formulated by the following approximation:

\dot{Q}ₕₑₐₜₑᵣ−\dot{Q}_{ghe}

Notably, this approximated energy balance equation governs the resultant system formed by the GHE Performance Test System connected to the ground heat exchanger (GHE) under testing, and states that: during ground heat exchanger test operations, when the GHE Performance Test System is operating in its cooling mode where Tᵢₙ>Tₒᵤₜ>T_{de}, the rate of heat energy \dot{Q}ₕₑₐₜₑᵣ introduced into the constant water (mass) flow (i.e. control volume) by the water pumping and heating module, is substantially equal to the rate of heat energy −\dot{Q}_{ghe} moving away from the heated water in the ground heat exchanger and into the deep Earth, in accordance with the First Law of Thermodynamics and consistent with design specifications for the Portable Enthalpy-Based GHE Performance Test System. This energy balance holds true for any type ground heat exchanger connected to the GHE Performance Test System during performance testing operations.
Modeling the Energy and Mass Balances Across the Control Volume for a Concentric-Tube Ground Heat Exchanger when Operating in a State of Thermal Equilibrium where Inlet and Output Temperatures Equal the Deep Earth Temperature

In addition to measuring the actual heat transfer rate (HTR) of a ground heat exchanger \dot{Q}_{ghe} during ground loop design process, the designer and engineer also have a need to know exactly the rate of work expressed in [BTUs/Hr] \dot{W}_{pghe} which the ground loop water circulation pump(s) must perform to push and/or pull water through each ground heat exchanger (GHE) in the ground loop design, so as to maintain a particular volume/mass flow rate through each ground heat exchanger. Also, it is noted that this flow work rate (FWR) for each ground heat exchanger \dot{W}_{pghe} will depend on the frictional and other fluid pressure losses generated within the ground heat exchanger, during performance testing operations.

At this stage, it is essential to derive a formula for the flow work rate (FWR) of any ground heat exchanger \dot{W}_{pghe} that might be tested by the GHE Performance Testing System of the present invention, in accordance with the First Law of Thermodynamics and energy and mass conservation principles, reviewed in detail above.

For any closed thermodynamic system, in which the rate of increase of thermal and mechanical energy stored in its control volume is zero, the First Law of Thermodynamics can be expressed in rate form as a generalized energy conservation balance, shown in FIG. 5 and given by the previously defined expression set forth again below for convenience:

$$\dot{Q} + \dot{W} + {\dot{m}}_{in} ( {u}_{in} + {P}_{in} {v}_{in} + \frac{{\overline{V}}_{in}^{2}}{2 {g}_{c}} + \frac{g {Z}_{in}}{{g}_{c}} ) = {\dot{m}}_{out} ( {u}_{out} + {P}_{out} {v}_{out} + \frac{{\overline{V}}_{out}^{2}}{2 {g}_{c}} + \frac{g {Z}_{out}}{{g}_{c}} )$$

For modeling purposes, there is a need to express all assumptions relating to the ground heat exchanger when it is connected to the Portable Enthalpy-Based GHE Performance Test Instrumentation System of the present invention, and operating in its flow work rate (FWR) test mode.

Firstly, the water circulation pumps that will be employed in the ground loop system under design will be mounted at ground level along with the ground heat exchanger(s), so that the potential energy terms (PEᵢₙ and PEₒᵤₜ) associated with the water flow through the ground heat exchanger will be negligible and thus reduce KEᵢₙ=KEₒᵤₜ=0. Consequently, during testing operations, the Portable GHE Performance Test Instrumentation System will also be located at ground level (Zᵢₙ=Zₒᵤₜ=0) where the ground heat exchanger under testing has been installed, to simulate actual circulation pump operations.

Secondly, during FWR testing operations, the heating section of the Enthalpy-Based GHE Performance Test Instrumentation System will be de-energized (i.e. not powered), and the water circulation pumps fully energized and operated so that water circulates through the ground heat exchanger at a constant mass/volume flow rate such that V̅ᵢₙ= V̅ₒᵤₜ, \dot{m}=\dot{m}₁=\dot{m}₂, and thus reducing the kinetic energy terms KEᵢₙ and KEₒᵤₜ also to zero.

Thirdly, during the FWR test mode, the circulation pumps in the Portable Enthalpy-Based GHE Performance Test Instrumentation System will circulate the water through the test loop so that steady-state temperature conditions are attained when the condition Tᵢₙ=Tₒᵤₜ=T_{de} exists, indicating that the temperature of water leaving the ground heat exchanger equals the temperature of the water leaving the ground heat exchanger, which is equal to the deep Earth temperature. Under such operating conditions, the heat transfer rate for the system in this state is negligible \dot{Q}=0, and the temperature-dependent internal energy states (U) of the flow of KE water entering and leaving the ground heat exchanger will be equal, i.e. \dot{m}ᵢₙuᵢₙ=\dot{m}ₒᵤₜuₒᵤₜ.

Fourthly, water entering and leaving the system during such conditions is essentially incompressible and therefore vᵢₙ=vₒᵤₜ=v.

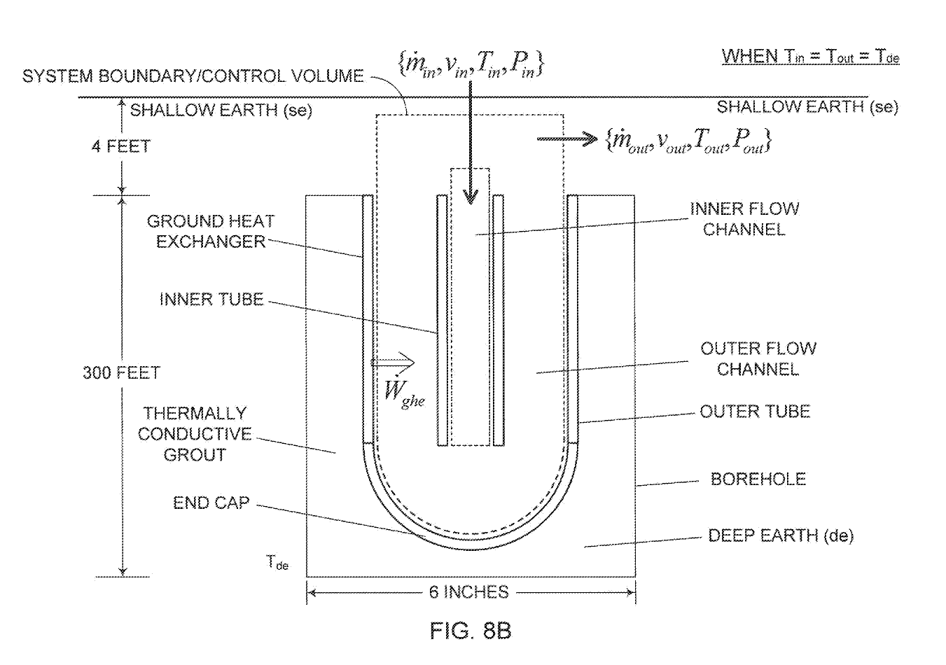

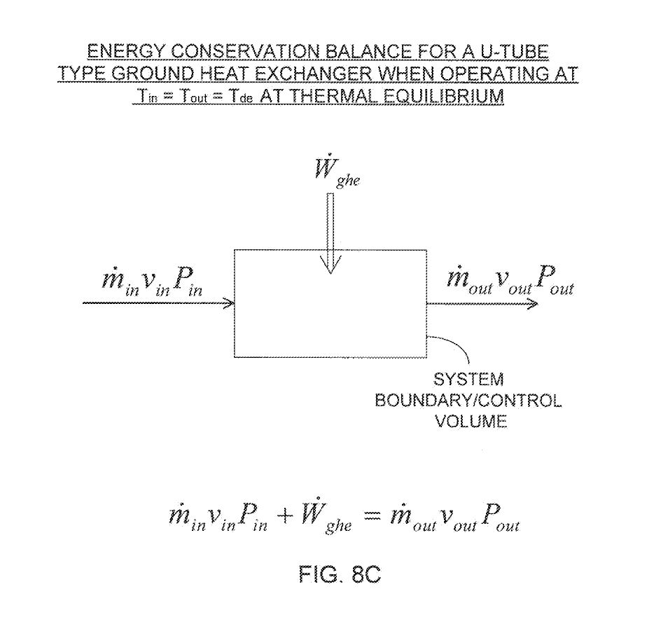

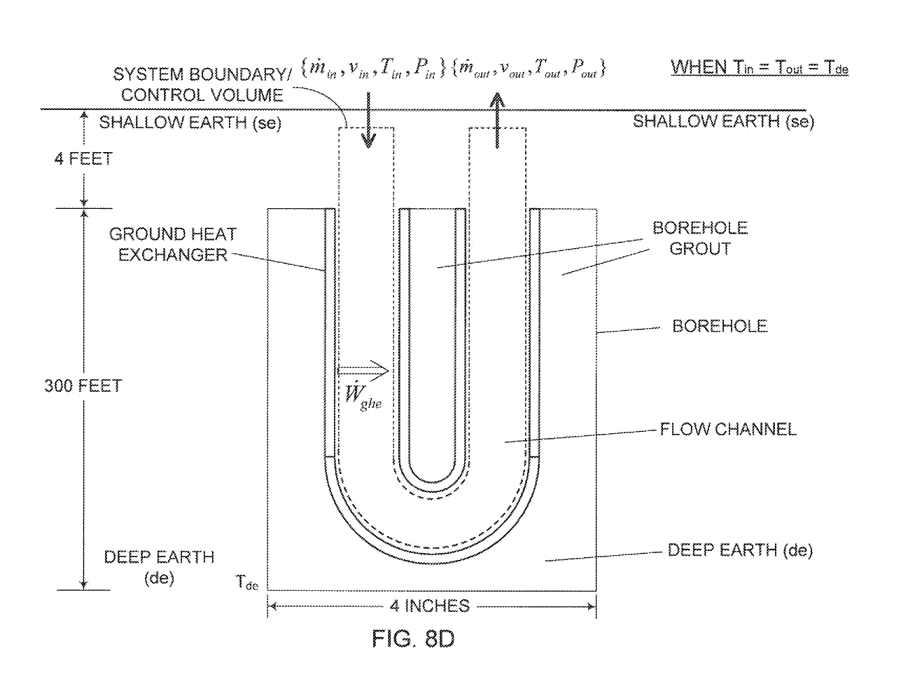

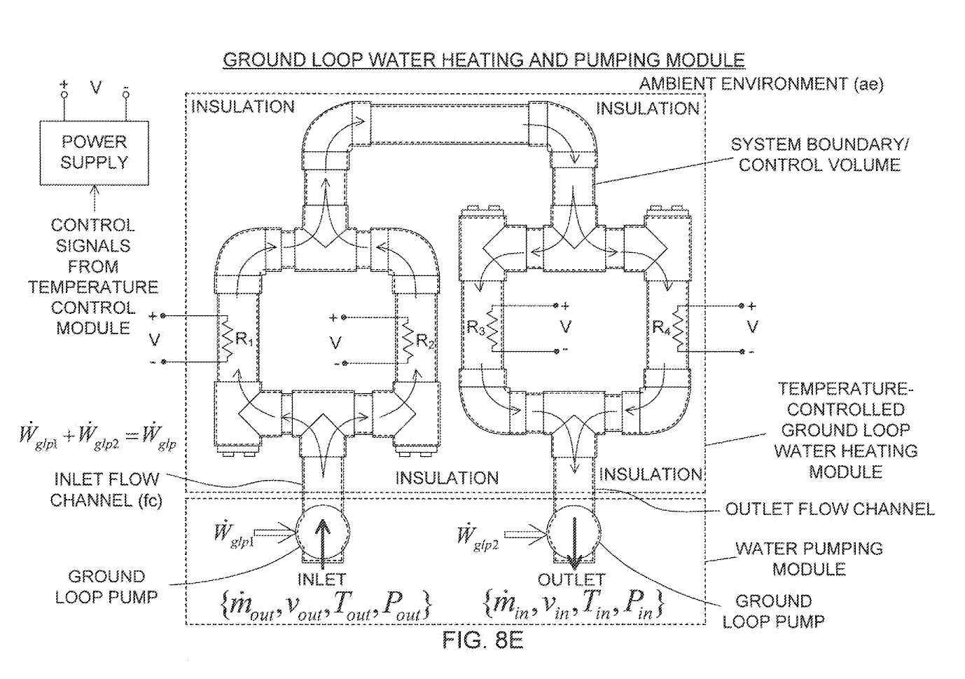

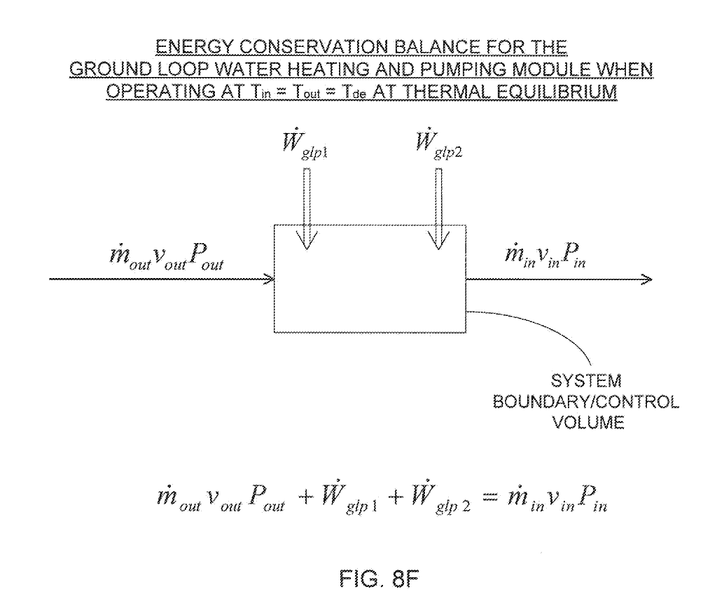

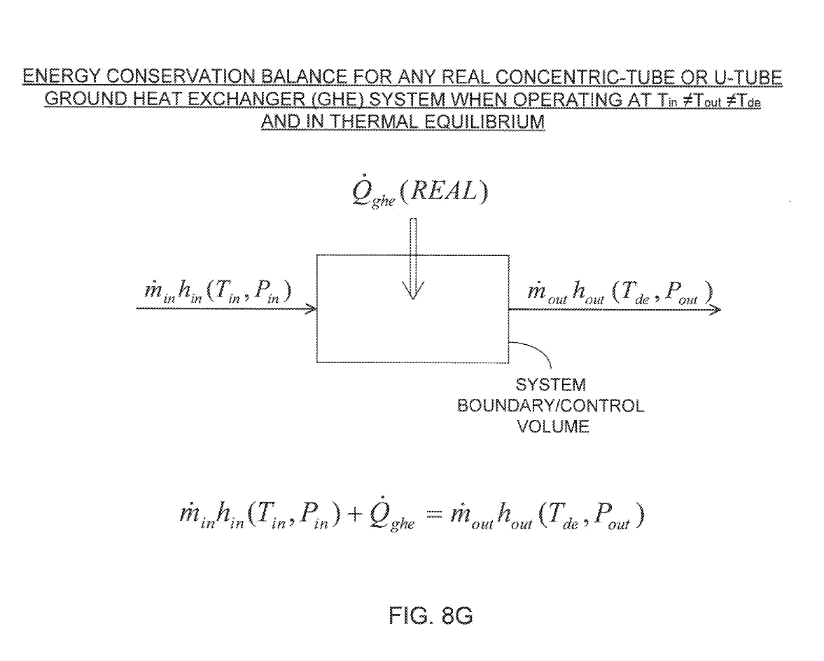

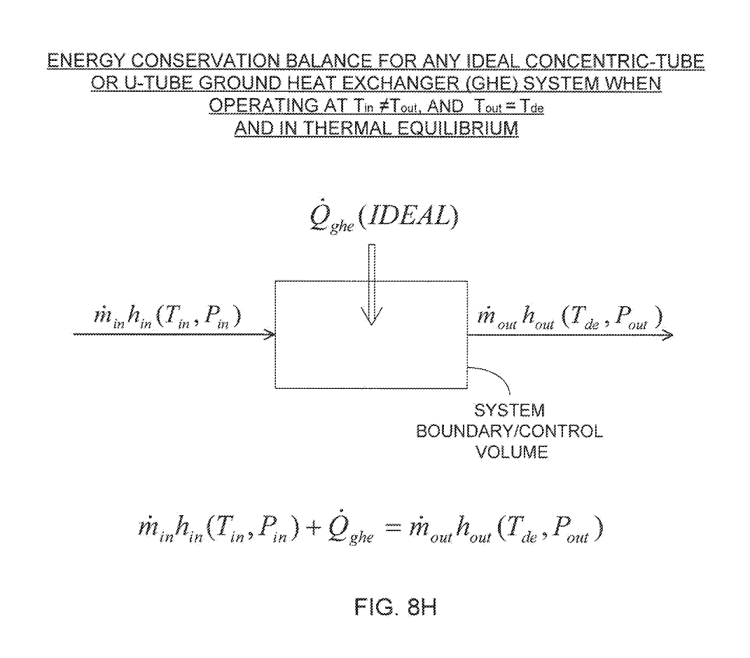

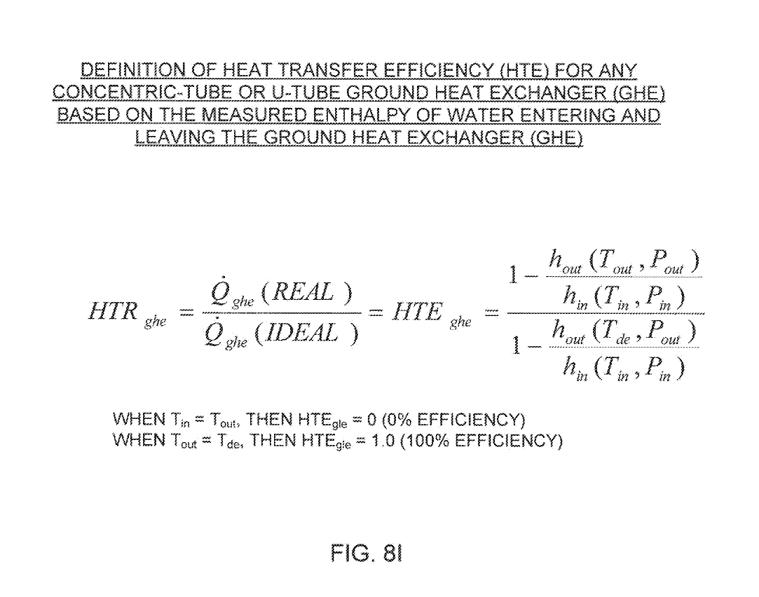

Taking the above assumptions into consideration, the energy balance equation for a control volume drawn about the water flow path through the GHE is illustrated in FIGS. 8A and 8B and expressed as:

\dot{m}ᵢₙvᵢₙPᵢₙ+\dot{W}_{ghe}=\dot{m}ₒᵤₜvₒᵤₜPₒᵤₜ

where \dot{W}_{ghe} is the work rate performed by the GHE upon the flowing water mass, entering the GHE with input flow energy rate \dot{m}ᵢₙ(Pᵢₙvᵢₙ), and leaving the GHE with an output flow energy rate \dot{m}ₒᵤₜ(Pₒᵤₜvₒᵤₜ), reduced in energy rate by the frictional and viscous forces presented \dot{W}_{ghe}=\dot{m}v(Pₒᵤₜ−Pᵢₙ) along the flow path of the GHE.

After algebraically manipulating the above energy balance/conservation equation and making substitutions based on the assumptions above, the work rate expression for the ground heat exchanger is derived as follows:

\dot{W}_{ghe}=\dot{m}v(Pₒᵤₜ−Pᵢₙ)

Under normal HTR and FWR test conditions, Pᵢₙ>Pₒᵤₜ and the net work done by the GHE on the water flowing through the GHE will be a negative figure, indicating that the ground heat exchanger (GHE) performed negative work against the water flow, decreasing its flow energy rate (through frictional, viscous and other fluid pressure losses) as the fluid moves through the GHE, without a change in its potential or kinetic energies.

A similar energy balance can be performed for a U-tube GHE installation, modeled in FIGS. 8C and 8D, which also results in a similar work rate expression for the ground heat exchanger as follows:

\dot{W}_{ghe}=\dot{m}v(Pₒᵤₜ−Pᵢₙ)

Notably, while the same mathematical expression is derived for the work rate of the concentric-tube ground heat exchanger and any U-tube ground heat exchanger, one can expect such work rate figures to be significantly less for the concentric-tube ground heat exchanger designs than for U-tube GHE designs, due to the fact that a concentric-tube GHE construction, as represented by Kelix's Thermacouple® GHE Model TC50, produces a significantly lower pressure drop across its inlet and outlet ports, on a per linear foot basis, than does a conventional U-tube GHE installation.
Modeling the Energy and Mass Balances Across the Control Volume for the Ground Loop Water Pumping and Heating Module of the Enthalpy-Based GHE Performance Test System, when Operating in a State of Thermal Equilibrium where Inlet and Output Temperatures Equal the Deep Earth Temperature

Referring to FIG. 8E, the control volume is defined for the water pumping and heating modules in the Portable Enthalpy-Based GHE Performance Test Instrumentation System is schematically depicted during the FWR test mode, when the circulation pumps in the GHE Performance Test Instrumentation System circulate the water through the test loop so that steady-state temperature conditions are attained when the condition Tᵢₙ=Tₒᵤₜ=T_{de} exists, indicating that the temperature of water leaving the ground heat exchanger equals the temperature of the water leaving the ground heat exchanger, which is equal to the deep Earth temperature.

During such steady-state thermal equilibrium conditions, and using notation and naming conventions used in representing the energy balance of the ground heat exchanger(s), the energy balance equation for the system depicted in FIG. 8E is represented in FIG. 8F and expressed below as follows:

\dot{m}ₒᵤₜvₒᵤₜPₒᵤₜ+\dot{W}_{glp1}+\dot{W}_{glp2}=\dot{m}ᵢₙvᵢₙPᵢₙ

Applying algebraic manipulation, and the relations \dot{m}ᵢₙ=\dot{m}ₒᵤₜ=\dot{m},vᵢₙ=vₒᵤₜ=v, the following expression can be expressed as:

\dot{W}_{glp1}+\dot{W}_{glp2}=\dot{m}v(Pᵢₙ−Pₒᵤₜ)

Renaming \dot{W}_{glp1}+\dot{W}_{glp2}=\dot{W}_{pghe}, the total rate of work done by the pumps can be computed to push/pull fluid through the single ground heat exchanger under testing, the following formula is obtained:

\dot{W}_{pghe}=\dot{m}v(Pᵢₙ−Pₒᵤₜ)

This formula is used in the Spreadsheet GHE Performance Calculator of FIGS. 9A1 and 9A2, to compute the performance figure (FWR) from actually measured variables {m,Pᵢₙ,Pᵢₙ} and {m,Pₒᵤₜ,Pₒᵤₜ} and the specific volume of water v which is constant for water in its incompressible liquid state over the operating pressures and temperatures during performance testing. This performance figure provides a precise measure of the actual power required by a ground loop pump to circulate (push/pull) water through the single test ground loop exchanger, during the FWR test operations, indicated in Step 28 in FIG. 10G, to overcome frictional, viscous and other losses in the GHE to maintain the continuous flow of the water through the control volume of the GHE without any change in kinetic or potential energy of the water flowing through the GHE.

Expressed in units of [BTU/hr], this computed FWR figure will appear significantly low in most practical GHE applications, as it only represents the rate of work required by the pump to overcome frictional, viscous and other losses along a single GHE, and does not account for the work rate (and time duration) that was actually required to move the volume of water in the GHE from an original stationary state, to a state in which the water is flowing through the GHE at a specified volume flow rate (e.g. 16 GPM). For this reason, it should be clearly understood that the FWR figure for a given GHE is, by itself, insufficient to specify the horsepower and mass/volume pump rate that will be actually required by the ground loop circulation pumps, to adequately transport water through the overall ground loop subsystem under design and construction, at the required rates required by any given application. Engineers skilled in the fluid transfer and hydraulic arts will know how to properly design for the water pumping requirements of any particular ground loop system, taking into consideration: pressure drops across all piping components employed in the ground loop subsystem, including ground heat exchangers; necessary work rates required to overcome changes in potential and/or kinetic energy that may exist along the ground loop under design and construction; and other factors well known in the fluid transfer and hydraulic arts.

Engineers should appreciate that the FWR figure, measured in situ for each ground heat exchanger (GHE) under performance testing, is used in computing the Energy Efficiency Ratio (EER) for a GHE installed at a particular test site, as taught herein below. This empirically-determined FWR figure has been selected for the EER definition as it represents the actual rate of work (energy) that the ground loop pump must do on the water flowing through the GHE, to overcome frictional, viscous and other energy losses and maintain the continuous flow of water through the control volume of the GHE, without incurring losses in kinetic or potential energy as water flows through the GHE.

Defining an Energy Efficiency Ratio (EER) for the Ground Heat Exchanger (GHE) in Accordance with the Principles of the Present Invention

Having derived equations for both the heat transfer rate (HTR) and the power work rate (FWR) functions of concentric-tube and U-tube ground loop exchangers, it is appropriate to point out that ground loop engineers also need to know, in quantitative terms, how much more or less energy efficient any particular ground heat exchanger (GHE) construction is (i) relative to the same type of ground heat exchanger construction but installed at a different geological environment, (ii) relative to a different type of ground heat exchanger construction installed at the same geological location, and/or (iii) relative to a different type of ground heat exchanger construction installed at a different geological location. Such a third figure of performance should assist the ground loop engineers in rationally deciding on a particular type of ground loop heat exchanger technology for any particular geothermal system project, as well as for a particular geological ground loop location where a ground loop subsystem has been planned out for design and construction.

In order to determine how many units of heat energy are actually transferred between an installed ground heat exchanger and the Earth, for each unit of energy utilized by the ground loop pump to circulate water through the ground heat exchanger, per unit length of drilled borehole, it will be helpful to define a new performance figure, called the Energy Efficiency Ratio (EER_{ghe}), which is similar to a Coefficient of Performance (COP_{ghe}) shall be an empirically measured figure of performance for each and every ground heat exchanger installation, defined by the following formula:

$${EER}_{ghe} = \frac{{\dot{Q}}_{ghe}}{{\dot{W}}_{pghe}} = {COP}_{ghe}$$

where both \dot{Q}_{ghe} and \dot{W}_{pghe} are calculated on a “per linear foot of drilled borehole” basis, to normalize the EER figure and enable fair and reliable comparisons between different types of ground source heat exchangers installed at the same geological location.

The EER figure above can be expressed in terms of measured inlet and outlet temperatures and pressures, as follows:

$${EER}_{ghe} = \frac{{\dot{Q}}_{ghe}}{{\dot{W}}_{pghe}} = \frac{\dot{m} ( {h}_{out} - {h}_{in} )}{\dot{m} v ( {P}_{in} - {P}_{out} )}$$

Through simple factoring, the empirically determined ground heat exchanger Energy Efficiency Ratio (EER_{ghe}) is measured by the following formula, expressed only as a function of measured inlet and outlet temperatures and pressures, independent of the mass/volume flow rate of the water passing through the ground heat exchanger.

$${EER}_{ghe} = \frac{{\dot{Q}}_{ghe}}{{\dot{W}}_{pghe}} = \frac{1}{v} \frac{( {h}_{out} - {h}_{in} )}{( {P}_{in} - {P}_{out} )}$$

### Defining the Heat Transfer Efficiency (HTE) for any Ground Heat Exchanger (GHE) Installed in a Deep Earth Environment, Based on the Empirically Measured Enthalpies of Water Entering and Leaving the Ground Heat Exchanger (GHE)

In addition to the figures of GHE performance, such as heat transfer rate (HTR), the flow work rate (FWR), and Energy Efficiency Ratio (EER_{ghe}), engineers also need to know, in quantitative terms, how efficient any “real” ground heat exchanger (GHE) construction is, in the “heat transfer” sense, relative to an “ideal” ground heat exchanger installed in the same deep Earth environment, and operating at similar ground loop conditions (i.e. having the same inlet water temperature T_{de}).

What is meant by an “ideal” ground heat exchanger (GHE) is a GHE that is installed in a deep Earth temperature having a deep Earth temperature T_{de} which is fed with water at an inlet water temperature Tᵢₙ and where the outlet water temperature Tₒᵤₜ is always equal to the deep Earth temperature Tₒᵤₜ (i.e. Tₒᵤₜ=T_{de}).

Such operating characteristics exemplify ideal heat transfer performance in a GHE (i.e. independent of the size or dimensions of the heat exchanging surfaces or heat transfer fluid flow rates might be necessary to achieve such ideal heat transfer performance characteristics) causing the heat energy of the inlet water, at temperature Tᵢₙ, to be exchanged with the deep Earth environment so that the temperature of outlet water Tₒᵤₜ is equal to the temperature of the deep Earth environment T_{de}.

In essence, the heat transfer performance of an idea GHE is limited only by the difference in temperature between (i) the inlet water temperature Tᵢₙ and (ii) the deep Earth temperature T_{de}, and nothing else—which is why the ideal GHE is selected as the reference for measuring heat transfer efficiency (HTE) of any ground heat exchanger (GHE) installed in a deep Earth environment.

This fourth figure of performance should assist engineers in better understanding how well any particular ground heat exchanger (GHE) installation is in harnessing the available potential energy existing between the entering water flowing into a ground heat exchanger, and its deep Earth temperature.

Referring now to FIG. 7G, an energy conservation balance is shown for any type of “real” concentric-tube or U-tube ground heat exchanger (GHE) operating in thermal equilibrium when the inlet water temperature Tᵢₙ is not equal to the outlet water temperature Tₒᵤₜ, which is not equal to the deep Earth temperature T_{de} (i.e. Tᵢₙ≠Tₒᵤₜ≠T_{de}).

As shown, the energy and mass balance equation for the control volume of this real GHE system is given by the following expression:

\dot{Q}_{ghe}^{real}=\dot{m}[hₒᵤₜ(Tₒᵤₜ,Pₒᵤₜ)−h(Tᵢₙ,Pᵢₙ)]

where hᵢₙ(Tᵢₙ,Pᵢₙ) is the enthalpy of the inlet water to the real GHE obtained from the steam table using state variables (Tᵢₙ,Pᵢₙ), and where hₒᵤₜ(Tₒᵤₜ,Pₒᵤₜ) is the enthalpy of the outlet water to the real GHE obtained from the steam table using state variables (Tₒᵤₜ,Pₒᵤₜ).

For this closed system, \dot{m}ᵢₙ=\dot{m}ₒᵤₜ=\dot{m}, and the above expression can be rewritten as follows:

\dot{Q}_{ghe}^{real}=\dot{m}[hₒᵤₜ(Tₒᵤₜ,Pₒᵤₜ)−hᵢₙ(Tᵢₙ,Pᵢₙ)]=HTR_{ghe}^{real}

where the heat transfer rate between the GHE and the deep Earth environment can be represented as:

\dot{Q}_{ghe}^{real}=HTR_{ghe}^{real}

Referring to FIG. 7H, an energy conservation balance is shown for an “ideal” concentric-tube or U-tube ground heat exchanger (GHE) operating in thermal equilibrium when the inlet water temperature Tᵢₙ is not equal to the outlet water temperature Tₒᵤₜ but where the outlet water temperature Tₒᵤₜ is equal to the deep Earth temperature T_{de} (i.e. Tᵢₙ≠Tₒᵤₜ=T_{de}).

As shown, the energy and mass balance equation for the control volume of this ideal GHE system is given by the following expression:

\dot{m}ᵢₙhᵢₙ(Tᵢₙ,Pᵢₙ)+\dot{Q}_{ghe}^{ideal}=\dot{m}ₒᵤₜhₒᵤₜ(T_{de},Pₒᵤₜ)

where hᵢₙ(Tᵢₙ,Pᵢₙ) is the enthalpy of the inlet water to the ideal GHE obtained from the steam table using state variables (Tᵢₙ,Pᵢₙ), and where hₒᵤₜ(T_{de},Pₒᵤₜ) is the enthalpy of the outlet water to the ideal GHE obtained from the steam table using state variables (T_{de},Pₒᵤₜ).

For this closed system, \dot{m}ᵢₙ=\dot{m}ₒᵤₜ={dot over (\dot{m}, and the above expression can be rewritten as follows:

\dot{Q}_{ghe}^{ideal}=\dot{m}[hₒᵤₜ(T_{de},Pₒᵤₜ)−hᵢₙ(Tᵢₙ,Pᵢₙ)]

where the heat transfer rate between the GHE and the deep Earth environment can be represented as: \dot{Q}_{ghe}^{real}=HRT_{ghe}^{real}.

Now, as shown in FIG. 7I, by definition, the heat transfer efficiency of any real GHE, notated as HTE_{ghe}(Tᵢₙ,T_{de}), or simply HTE_{ghe}, shall be defined as the ratio of:

(i) the heat transfer rate HTR_{ghe}^{real}=\dot{Q}_{ghe}^{real} of the real GHE installed in a deep Earth environment, and

(ii) the heat transfer rate HTR_{ghe}^{ideal}=\dot{Q}_{ghe}^{ideal} of the ideal GHE installed in a deep Earth environment;

wherein the real GHE is operated at the temperature differential defined by the inlet water temperature and the deep Earth temperature (Tᵢₙ,T_{de}), and ideal GHE is also operated at the same temperature differential defined by the inlet water temperature and the deep Earth temperature (Tᵢₙ,T_{de}).

Formally, the heat transfer efficiency HTE can be expressed as follows:

$${HTE}_{ghe} = \frac{{\dot{Q}}_{ghe}^{real}}{{\dot{Q}}_{ghe}^{ideal}} = \frac{\dot{m} [ {h}_{out} ( {T}_{out} , {P}_{out} ) - {h}_{in} ( {T}_{in} , {P}_{in} ) ]}{\dot{m} [ {h}_{out} ( {T}_{de} , {P}_{out} ) - {h}_{in} ( {T}_{in} , {P}_{in} ) ]}$$

This expressed can be simplified to provide:

$${HTE}_{ghe} = \frac{[ {h}_{out} ( {T}_{out} , {P}_{out} ) - {h}_{in} ( {T}_{in} , {P}_{in} ) ]}{[ {h}_{out} ( {T}_{de} , {P}_{out} ) - {h}_{in} ( {T}_{in} , {P}_{in} ) ]}$$

And with some algebraic manipulation, the above equation can be rewritten as a complex ratio of enthalpy values for the inlet and outlet water streams into the real and ideal GHEs, given as follows:

$${HTE}_{ghe} = \frac{[ \frac{{h}_{out} ( {T}_{out} , {P}_{out} )}{{h}_{in} ( {T}_{in} , {P}_{in} )} - 1 ]}{[ \frac{{h}_{out} ( {T}_{de} , {P}_{out} )}{{h}_{in} ( {T}_{in} , {P}_{in} )} - 1 ]}$$

Let's consider two extreme operating conditions and see how this performance figure works.

When Tᵢₙ=Tₒᵤₜ then HTE_{ghe}=0 and this represents the lowest performance case where a real GHE is operating at 0.0% heat transfer efficiency with the deep Earth environment. When Tₒᵤₜ=T_{de} then HTE_{ghe}=1.0 and this represents the highest (ideal) performance case where a real GHE is operating at 100.0% heat transfer efficiency with the deep Earth environment, which is not attainable in reality, but does represent the ideal case towards which all GHE designs and constructions should strive. In practice, real GHEs will perform somewhere between these two extremes (i.e. 0.0<HTE_{ghe}<1.0)

To provide a sense for this figure of performance consider the case of Kelix's 300 foot Thermacouple® GHE (Model TC50) installed in a deep Earth environment having an average deep Earth temperature about the borehole of about T_{de}=55 F. Based on performance testing, the average empirically-determined HTR_{ghe} for the Thermacouple® GHE TC50 is about 60,000 [BTU/Hr] or 5 [Tons]. When operating the Thermacouple® TC50 GHE at an inlet water temperature Tᵢₙ=95 F, with a resulting outlet water temperature of Tₒᵤₜ=85 F when the mass flow rate into and of the TC50 GHE is about 8012 [LBM/HR] (i.e. when the volumetric flow rate is 16 [GPM]), the heat transfer efficiency for the GHE measures HTE_{ghe} 0.248 representing about 25% heat transfer efficiency, measured against the ideal GHE standard depicted in FIG. 7H, which would have a 100% HTE.

In summary, the empirically measurable figures for the HTR of the ground heat exchanger, its associated flow work rate (FWR), its Energy Efficiency Ratio (EER) and Heat Transfer Efficiency (HTE) defined above provides ground loop engineers with three new and essential GHE performance figures for use in rationally deciding on a particular type of ground loop heat exchanger technology to implement on a particular geothermal system project, and how to accurately size the actual energy requirements for pumping water through the ground heat exchanger during its heat transfer operations with its deep Earth environment.

For further details regarding thermodynamics, heat transfer and fluid and mass flow principles related to the present invention, reference is made to: DOE Fundamentals Handbook: Thermodynamics, Heat Transfer, And Fluid Flow, Volumes 1, 2 and 3, DOE-HDBK-1012/1-92, June 1992, DOE-HDBK-1012/2-92, June 1992 and DOE-HDBK-1012/3-92, June 1992; Thermodynamics: An Engineering Approach (Seventh Edition) by Yunus A. Cengel and Michael A. Boles, McGraw-Hill, 2010; Thermodynamics: Concepts and Applications, by Stephen R. Turns, Cambridge University Press 2006; Fundamentals of Heat and Mass Transfer (Sixth Edition) by F. P. Incropera, D. P. Dewitt, T. L. Bergmann, and A. S. Lavine, John Wiley & Sons, 2007; and A Heat Transfer Textbook (Third Edition) by John H. Lienhard IV and John H. Lienhard V, Phlogiston Press, Cambridge Mass., 2008; wherein each said reference is incorporated herein by reference.

Defining and Measuring Thermal Equilibrium Indices for Use with the Enthalpy-Based GHE Performance Calculator, and the Enthalpy-Based Ground Loop Performance Monitoring Module

The energy-based performance figures disclosed herein are based on measurements taken during thermal equilibrium conditions of the system under analysis. Thus, it will be helpful to provide engineers with several empirical indices which indicate when “thermal equilibrium” conditions exist for any given GHE installation or GLHE subsystem under performance analysis, and when computed performance figures are true and accurate.

When determining that a system is in a state of thermal equilibrium, and confirming that there is no net change in the internal energy of the system, it is important to carefully analyze both the driving and response functions of the system.

In the case of a GHE installation, the driving function is the thermal potential difference (TPD_{driving}) driving the GHE installation, namely, the difference in thermal potential (i.e. temperature) between the inlet of the GHE installation and its deep Earth environment, which is given by the following expression:

ΔT_{driving}=ΔT_{in,de}=Tᵢₙ−T_{de}

In the case of a GHE installation, the response function is the thermal potential difference (TPDᵣₑₛₚₒₙₛₑ) measured between the inlet and outlet ports of the GHE installation, namely, the difference between the inlet and outlet water temperature of the GHE installation, which is given by the following expression:

ΔTᵣₑₛₚₒₙₛₑ=ΔT_{in,out}=Tᵢₙ−Tₒᵤₜ

At each sampling/measuring period (e.g. 60 seconds), the Driving TPD is represented by as: ΔT_{driving}(tᵢ)=ΔT_{in,de}(tᵢ)=Tᵢₙ(tᵢ)−T_{de}(tᵢ) and the Response TPD is represented by ΔTᵣₑₛₚₒₙₛₑ(tᵢ)=ΔT_{in,out}(tᵢ)=Tᵢₙ(tᵢ)−Tₒᵤₜ(tᵢ).
Also, at each previous sampling/measuring period, the Driving TPD is represented by ΔT_{driving}(tᵢ₋₁)=ΔT_{in,de}(tᵢ₋₁)=Tᵢₙ(tᵢ₋₁)−T_{de}(tᵢ₋₁) while the Response TPD is represented by ΔTᵣₑₛₚₒₙₛₑ(tᵢ₋₁)=ΔT_{in,out}(tᵢ₋₁)=Tᵢₙ(tᵢ₋₁)−Tₒᵤₜ(tᵢ₋₁)
As the GHE installation (system) approaches a state of thermal equilibrium, two conditions will be observed through empirical measurement:
(1) the normalized difference between consecutively measured Driving TPD figures will converge to zero, mathematically represented as:

$${TEI}_{response} = 1 - \frac{[ {T}_{in} ( {t}_{i} ) - {T}_{out} ( {t}_{i} ) ] - [ {T}_{in} ( {t}_{i - 1} ) - {T}_{out} ( {t}_{i - 1} ) ]}{[ {T}_{in} ( {t}_{i} ) - {T}_{out} ( {t}_{i} ) ]}$$

(2) the normalized difference between consecutively measured Response TPD figures will also converge to zero, mathematically represented as:

$$\frac{Δ {T}_{response} ( {t}_{i} ) - Δ {T}_{response} ( {t}_{i - 1} )}{Δ {T}_{response} ( {t}_{i} )} = \frac{[ {T}_{in} ( {t}_{i} ) - {T}_{out} ( {t}_{i} ) ] - [ {T}_{in} ( {t}_{i - 1} ) - {T}_{out} ( {t}_{i - 1} ) ]}{[ {T}_{in} ( {t}_{i} ) - {T}_{out} ( {t}_{i} ) ]} \to ZERO$$

Using these two figures, a pair of Thermal Equilibrium Indices (TEIs) can be defined as follows:

$${TEI}_{driving} = 1 - \frac{[ {T}_{in} ( {t}_{i} ) - {T}_{de} ( {t}_{i} ) ] - [ {T}_{in} ( {t}_{i - 1} ) - {T}_{de} ( {t}_{i - 1} ) ]}{[ {T}_{in} ( {t}_{i} ) - {T}_{de} ( {t}_{i} ) ]}$$

$${TEI}_{response} = 1 - \frac{[ {T}_{in} ( {t}_{i} ) - {T}_{out} ( {t}_{i} ) ] - [ {T}_{in} ( {t}_{i - 1} ) - {T}_{out} ( {t}_{i - 1} ) ]}{[ {T}_{in} ( {t}_{i} ) - {T}_{out} ( {t}_{i} ) ]}$$

When the GHE installation approaches a state of thermal equilibrium, both the driving and response function indices defined above will converge to 1. Whenever the GHE installation is dynamically changing its state, in response to changes in the driving function (TPD_{driving}), these indices will move in the direction of zero and then after some time, converge towards 1. How quickly these indices change will depend on various parameters within the system.

Whenever, these indices are both close to 1, the corresponding GHE performance figures will represent true and reliable performance measures. Whenever, any one of these indices are close to 0, or far from 1, the corresponding GHE performance figures will not represent true and reliable performance measures, and should not be relied upon.

These TEIs should be used whenever any of the energy-based performance figures disclosed herein are measured, to ensure thermal equilibrium conditions have been attained when such measurements are made.

### Calculating the Projected Thermal Load Requirements of the Geothermal System Under Design

Before designing a GLHE subsystem, engineers should calculate the thermal load requirements of the geothermal system under design, across all four seasons of the year. This important task can be done in a conventional manner using conventional software tools and techniques. Typically, this results in a thermal load chart illustrating the thermal load requirements for a building during both heating and/or cooling season.

To determine the peak and block load requirements of the building, expressed in [Btu/hr] over periods of time, it is suggested that the Manual J® residential load calculation procedure is used, or other standard load calculation software product, required by many building codes around the country.

Once an accurate Manual J load calculation has been made on the building, the peak heat transfer rate (HTR) requirements of the geothermal equipment (GTE) \dot{Q}_{gte}(max) have been determined, and expressed in [BTU/hr]; geothermal heat pump or chiller equipment can be selected in ways compatible with the calculated heating and cooling requirements of the building.

### Determining the Limits for a Ground Heat Exchanger (GHE) Performance Test Based on the “Earth-Side” Operating Conditions Specified by the Manufacturer of the Geothermal Equipment Selected for Use in Constructing the Geothermal System Under Design

After selecting the geothermal equipment (GTE) to be used to construct the geothermal system, but before conducting any performance test on a ground heat exchanger (GHE) installation, the GLE Process requires the engineer to determine the “earth-side” operating conditions that have been specified by the manufacturer of the geothermal equipment (GTE), e.g. heat pump or chiller unit, selected for constructing the geothermal system under design.

These “earth-side” operating conditions or limits will include: (i) the maximum entering water temperature (EWT) into the geothermal heat pump or chiller; (ii) the maximum temperature rise across the (tube-in-shell) condenser of the chiller, or (tube-in-shell) heat exchanger in the geothermal heat pump during its cooling mode; and (iii) the minimum and maximum volumetric flow rates of water through the geothermal heat pump or chiller.

Typically, these operating conditions or limits can be found in the manufacturer's installation and/or operating instructions that ship with the geothermal heat pump or chiller unit. When the geothermal heat pump or chiller is operated within these specified operating conditions/limits, maximum performance will be achievable, and the longevity of the geothermal equipment maximized.

Using these operating conditions/limits, the engineer simply determines the minimum and maximum limits on inlet water temperature into the GHE installation as follows:

(i) the minimum inlet water temperature into the GHE installation Tᵢₙ(min) is typically taken to be the average deep Earth temperature, which provides the starting temperature at which performance testing should be conducted in accordance with the method specified in FIGS. 10A through 10I; and

(ii) the maximum inlet water temperature into the GHE installation Tᵢₙ(max) can be found by adding together (i) the maximum entering water temperature (EWT) into the geothermal heat pump or chiller and (ii) the maximum temperature rise across the condenser during the cooling mode, i.e. Tᵢₙ(max)=T_{EWT}(max)+Tᵣᵢₛₑ.

Once determined, the engineer records these minimum and maximum inlet water temperature limits Tᵢₙ(min), Tᵢₙ(max), and determines how many 5° F. temperature intervals exist between these two limits, and records these inlet water temperature values as test points for the GHE performance test to be conducted in accordance with FIGS. 10A through 10I.

FIGS. 11A through 11D show exemplary GHE Performance Charts plotted at five sampling points taken between the inlet water temperature range {Tᵢₙ(85° F.),Tᵢₙ(105° F.)}, for four fixed values of volumetric water flow rate between the range {\dot{V}(9.0 gpm),\dot{V}(18 gpm)} recommended by Kelix Heat Transfer Systems, LLC as the upper and lower volumetric flow rate limits for its Thermacouple® TC50 GHE system.

The manufacturer's minimum and maximum limits on the volumetric flow rate of water through the geothermal heat pump or chiller will typically differ from the minimum and maximum volumetric flow rates through a Thermacouple® GHE installation. Thus, it would be helpful for the engineer to conduct the GHE performance test, specified in FIGS. 10A through 10I, at volumetric flow rates within the range of {\dot{V}(9.0 gpm),\dot{V}(18 gpm)}. FIGS. 12A through 12D show exemplary GHE Performance Charts plotted at four sampling points taken between the volumetric flow rate range {\dot{V}(9.0 gpm),\dot{V}(18 gpm)}.

Having made the above determinations, the engineer is now ready to conduct the GHE performance test specified in FIGS. 10A through 10I within boundaries set by “earth-side” operating conditions/limits that have been specified by the manufacturer of the geothermal equipment (e.g. heat pump or chiller unit) selected for constructing the geothermal system under design.

### Measuring and Charting the Performance Characteristics of a Ground Heat Exchanger (GHE) Installation Using the GHE Performance Test Instrumentation

Having determined the upper and lower “limits” for GHE performance testing at the designated site for a particular geothermal project, the engineering team is ready to measure and chart a complete set of performance characteristics of the GHE installation using the GHE Performance Instrument and Performance Test Method specified herein.

Under precisely controlled conditions specified in FIGS. 10A through 10I, the temperature, pressure, and volumetric flow rate of water flowing into and out of the GHE installation, will be accurately measured, logged and recorded during GHE performance testing, and subsequently processed to generate the Performance Charts specified in FIGS. 11A through 12D. These Performance Charts will provide great insight into how a single GHE installation performs at the specific test site, within the operating limits specified by geothermal equipment manufacturer.

As shown in FIGS. 11A through 11E, and 12A through 12D, a pair of Performance Charts are generated for each performance measure defined and specified herein (i.e. HTR, FWR, EER and HTE), using collected test data. These Performance Charts show illustrated two important characteristics, namely:

(i) how the GHE installation measured against a particular energy performance metric (e.g. HTR) as the inlet water temperature Tᵢₙ into the GHE installation was varied across the lower and upper operating limits of the performance test, while the volumetric flow rate of water \dot{V} through the GHE was maintained constant in a controlled manner by the GHE Performance Test Instrument; and

(ii) how the GHE installation measured against the particular performance metric (e.g. HTR) as the volumetric flow rate of water \dot{V} through the GHE was varied across the lower and upper operating limits of the performance test, while the inlet water temperature Tᵢₙ into the GHE installation was maintained constant in a controlled manner by the GHE Performance Test Instrument.

From the empirically generated Performance Charts shown in FIGS. 11A and 12A, the engineering team can determine the maximum heat transfer rate (HTR), \dot{Q}_{ghe}(max,{Tᵢₙ(min),Tᵢₙ(max)}) that a single GHE installation is capable of supporting with the deep Earth environment at deep Earth temperature T_{de}, within the lower and upper operating limits set on the inlet water temperature Tᵢₙ by the manufacturer of the geothermal equipment selected for the geothermal system project.

The engineering team can quickly calculate the total number of GHEs installed at least 20 feet apart at the test site, N_{ghe}(total,d=20 feet), to size, design and construct a GLHE subsystem capable of supporting the peak cooling load of the geothermal system \dot{Q}_{system,cooling}(peak), by the following formula:

$${N}_{ghe} ( total , d = 20 feet ) = \frac{{\dot{Q}}_{system , cooling} ( peak )}{{\dot{Q}}_{ghe} ( max , \{ {T}_{in} ( min ) , {T}_{in} ( max ) \} )}$$

where \dot{Q}_{system,cooling}(peak) is the peak load of the geothermal system under design during its cooling mode, and where \dot{Q}_{ghe}(max,{Tᵢₙ(min), Tᵢₙ(max)}) is the maximum heat transfer rate (HTR) that a single GHE installation is capable of supporting with the deep Earth environment at deep Earth temperature T_{de}, within the lower and upper operating limits set on the inlet water temperature Tᵢₙ by the manufacturer of the geothermal equipment selected for the geothermal system project.

The engineering team can use the other generated Performance Charts, illustrated in FIGS. 11B through 11E and 12B through 12D, to assess the performance of the GHE installation test site against the empirically-determined energy performance measures, and support decisions during the ground loop engineering process.

Before describing the Performance Test Method specified in FIGS. 10A through 10I, it should be noted here that the GHE Performance Test should not be conducted until five (5) days after a GHE test installation has been completely installed in its deep Earth environment. This five day wait period is required to allow sufficient time for thermal energy (e.g. heat of hydration) generated by the thermally-conductive grouting during curing, to dissipate to insignificant levels and attain a state of thermal equilibrium with the surrounding borehole. If this time is not allowed, before conducting a GHE Performance Test, then one can expect inaccurate results when measuring the deep Earth temperature during the method of FIGS. 10A through 10I, due to the release of heat energy associated with the formation of chemical bonds in the thermally-conductive grouting used in the GHE.

Also, field technicians conducting GHE Performance Tests should make certain that all ground fault circuit breaker amperage ratings, line voltages, and ground wire sizes, in connection with GHE performance test instrumentation employed, are in accordance with the National Electrical Code and any local electrical regulations.

### The GHE Performance Test Method of the Preferred Embodiment of the Present Invention

STEP 1: Install a GHE in a borehole drilled in the Earth at a test location where a planned GLHE subsystem is to be constructed using multiple GHEs.

STEP 2: Before conducting a Performance Test on the installed GHE, determine the range of inlet temperature values {Tᵢₙ(min) . . . Tᵢₙ(max)} and volumetric flow rates {\dot{V}_{gle}(min) . . . V_{gle}(max)} over which the Performance Test will be conducted. Enter these test points into the GHE Performance Calculator, as a reminder of the GHE Performance Test limits on the test site.

STEP 3: Connect the Enthalpy-Based GHE Performance Test Instrumentation to the input and output ports of the installed GHE, and charge the resulting test ground loop with a predetermined fixed quantity of water (i.e. heat transferring fluid) with an inlet water pressure Pᵢₙ=15.5 [psig].

STEP 4: Start the water circulation pumps and circulate the predetermined quantity of water through the test loop at a constant volumetric flow rate \dot{V}=9.0 [GPM] through the test ground loop.

STEP 5: Start measuring, logging and recording at 60 second sampling intervals, the controlled volumetric flow rate \dot{V} measured in units of [GPM], the inlet and outlet/return water temperatures Tᵢₙ and Tₒᵤₜ measured in units of [° F.], and inlet and outlet/return water pressures Pᵢₙ and Pₒᵤₜ measured in units of [PSIG, hereinafter collectively referred to as “Test Data”. Periodically, import such test data into the Spreadsheet GHE Performance Calculator Worksheet of the Spreadsheet-Based GLE Workbook.

STEP 6: Monitor the loop water temperatures Tᵢₙ and Tₒᵤₜ and determine when these temperatures are approximately equal Tₒᵤₜ=Tᵢₙ which will be deemed a steady-state thermal equilibrium value approximating the deep Earth temperature T_{de}=Tₒᵤₜ=Tᵢₙ, which typically will fall within the range of about 45° F. to about 80° F. depending on the borehole location in the Earth.

To ensure that the GHE, surrounding borehole environment, and water flowing through the GHE, have entered a state of thermal equilibrium with each other, where Tᵢₙ=Tₒᵤₜ=T_{de}, the water should be allowed to circulate through the GHE for a sufficient length of time that can only be determined empirically for any give test site. During this time period, one should observe the inlet and outlet temperatures Tᵢₙ,Tₒᵤₜ asymptotically converging towards a steady-state value representing the average deep Earth (surrounding borehole) temperature T_{de}. The ability to monitor such temperature changes in real-time at the test site will be helpful during this phase of performance testing. Once the thermal equilibrium state has been determined, using the assistance of the Thermal Equilibrium Indices (TEIs) automatically calculated in the GHE Performance Calculator Worksheet, using the formulas derived hereinabove, the estimated deep Earth temperature T_{de} should be manually recorded as an Input Data parameter in T_{de} cell provided in the GHE Performance Calculator Worksheet of the Spreadsheet-Based GLE Workbook.

Notably, the performance data collected during Steps 5 and 6 will provide useful insight into the time-response characteristics of the GHE installation, as it stores up thermal energy in the mass of its heat transferring fluid (e.g. water), physical structure and surrounding borehole Earth environment, and attains a state of thermal equilibrium with the GHE test instrument and the deep Earth environment, during thermal loading conditions.

STEP 7: When T_{de}=Tₒᵤₜ=Tᵢₙ, and while the water heating module is still de-energized and not supplying heat energy into the water loop, start monitoring and recording the inlet and outlet temperatures and pressures and volumetric flow rate at 60 second sampling/measuring intervals, for at least a one hour period.

STEP 8: Maintain the volumetric flow rate at 9.0 [GPM] and start the electric-powered water heater module and begin introducing thermal energy/power into the water circulated through the test ground loop so that a constant minimum inlet water temperature \dot{T}ᵢₙ=\dot{T}ᵢₙ(min) in the test range is maintained by the GHE Performance Test Instrument.

STEP 9: Measure, log and record Test Data for a test period of 4 hours once thermal equilibrium steady state conditions \dot{T}ᵢₙ=\dot{T}ᵢₙ(min) have been attained by the GHE system under controlled performance testing conditions.

STEP 10: Increase the volumetric flow rate \dot{V} to 12 [GPM] while maintaining inlet temperature Tᵢₙ constant and continue to measure, log and record Test Data for 4 hours once thermal equilibrium has been attained at the test site.

STEP 11: Repeat the test for volumetric flow rates \dot{V}=15 [GPM] and \dot{V}=18 [GPM] while maintaining the inlet temperature Tᵢₙ constant, and collecting 4 hours of Test Data for each GPM setting once thermal equilibrium has been detected.

STEP 12: Increment inbtlet temperature Tᵢₙ by 5 [° F.], and repeat the test for values of volumetric flow rates 9, 12, 15 and 18 [GPM], collecting 4 hours of Test Data for each volumetric flow rate setting once thermal equilibrium has been detected, and repeat the test for increments of inlet temperature Tᵢₙ by 5 [° F.], until \dot{T}ᵢₙ=\dot{T}ᵢₙ(max) has been reached at the test site.

STEP 13: Maintain the volumetric flow rate \dot{V} at 18 [GPM], and Tᵢₙ=Tᵢₙ(max), and collect and record Test Data for 4 hours Tᵢₙ(min), and collect and record Test Data for 48 hours once thermal equilibrium has been detected.

STEP 14: Decrease Tᵢₙ by 5 [° F.], while maintaining a volumetric flow rate \dot{V}=18 [GPM], and collect 4 hours of Test Data once thermal equilibrium has been detected.

STEP 15: Repeat Step 14, each time collecting 4 hours of Test Data (at thermal equilibrium), and stop after \dot{T}ᵢₙ=\dot{T}ᵢₙ(min) has been attained and Test Data collected at this test point.

STEP 16: Decrease the volumetric flow rate by 3 [GPM] to \dot{V}=15 [GPM], and reset Tᵢₙ to Tᵢₙ(min) and collect 4 hours of Test Data once thermal equilibrium has been detected at the test site.

STEP 17: Maintain the volumetric flow rate \dot{V} that has been set at STEP 16, and increase the inlet water temperature Tᵢₙ by 5 [° F.], and collect Test Data for 4 hours once thermal equilibrium has been detected; repeat the test for increments in Tᵢₙ by 5 [° F.], while the volumetric flow rate \dot{V} is maintained constant, until \dot{T}ᵢₙ=\dot{T}ᵢₙ(max) has been reached at the test site.

STEP 18: While \dot{T}ᵢₙ=\dot{T}ᵢₙ(max), decrease the volumetric flow rate \dot{V} by 3 [GPM] to 12 [GPM], and collect Test Data for 4 hours once thermal equilibrium has been detected.

STEP 19: Maintain the volumetric flow rate \dot{V} set at STEP 18, and decrease Tᵢₙ by 5 [° F.], then collect Test Data for 4 hours once thermal equilibrium has been detected at the test site.

STEP 20: Repeat STEP 19, each time collecting 4 hours of Test Data at thermal equilibrium conditions, and stop after \dot{T}ᵢₙ=\dot{T}ᵢₙ(min) has been attained and Test Data has been collected at this test point.

STEP 21: Decrease the volumetric flow rate \dot{V} by 3 [GPM] to V=9 [GPM] and set \dot{T}ᵢₙ=\dot{T}ᵢₙ(max) and collect 4 hours of Test Data once thermal equilibrium has been detected.

STEP 22: Maintain the volumetric flow rate \dot{V} set at STEP 21, and increase Tᵢₙ by 5 [° F.], then collect Test Data for 4 hours once thermal equilibrium has been detected at the test site; then repeat the test for increments in Tᵢₙ while the volumetric flow rate \dot{V} is maintained constant until \dot{T}ᵢₙ=\dot{T}ᵢₙ(max).

STEP 23: Maintain the volumetric flow rate \dot{V} at 9 [GPM], de-energize the water heating module and continue to circulate water through the GHE while collecting Test Data.

STEP 24: Monitor the inlet and outlet water temperatures into and out of the GHE, and determine when these temperatures are approximately equal, Tᵢₙ=Tₒᵤₜ, at thermal equilibrium conditions, approximating the deep Earth temperature about the GHE, i.e. Tᵢₙ=Tₒᵤₜ=T_{de}.

To ensure that the GHE, surrounding borehole environment, and water flowing through the GHE, have returned to a state of thermal equilibrium with each other, where Tᵢₙ=Tₒᵤₜ=T_{de}, the water should be allowed to circulate through the GHE for at least five (5) hours. During this time period, one should observe the inlet and outlet temperatures Tᵢₙ,Tₒᵤₜ asymptotically converging towards a steady-state value representing the average deep Earth (surrounding borehole) temperature T_{de}, and that this value should be substantially the same value as the average deep Earth temperature measured during STEP 7, above.

STEP 25: When Tᵢₙ=Tₒᵤₜ=T_{de} indicating thermal equilibrium conditions, and while the water heating module is still de-energized, monitor, log and record Test Data for at least a one hour period.

STEP 26: After recording one hour of Test Data while Tᵢₙ=Tₒᵤₜ=T_{de}, stop the water circulation pumps and conclude the performance of the test.

STEP 27: For sampling intervals where thermal equilibrium conditions are indicated (i.e. by TEI=1.0 values in the Spreadsheet-based GHE Performance Calculator) use the Spreadsheet GHE Performance Calculator to:

(i) determine the specific enthalpy values for inlet and outlet water flows in the ground loop, hᵢₙ,hₒᵤₜ, expressed in units of [BTU/lbm];

(ii) calculate the actual rate of heat energy transfer being exchanged between the GHE and its deep Earth environment, \dot{Q}_{ghe} measured in units of [BTUs/Hr], using the enthalpy-drop based Heat Transfer Rate (HTR) formula \dot{Q}_{ghe}=\dot{m}(hₒᵤₜ−hᵢₙ) and specific enthalpy table for water shown in FIG. 9B, automated by the Spreadsheet-based GHE Performance Calculator shown in FIGS. 9A1 and 9A2;

(iii) calculate the Driving Thermal Potential Difference (TPD) ΔT_{in,de}=Tᵢₙ−T_{de} between inlet ports of the GHE, and the deep Earth environment in the vicinity of the GHE, expressed in units of [F];

(iv) calculate the Response Thermal Potential Difference (TPD) ΔT_{in,out}=Tᵢₙ−Tₒᵤₜ between inlet and outlet ports of the GHE, expressed in units of [° F.]; and

(v) record the computed \dot{Q}_{ghe} and Driving and Response TPD values into the Spreadsheet Enthalpy-Based GHE Performance Calculator.

The calculated HTR figure provides the engineer with an empirical measure on the rate of heat energy (expressed in BTU/Hour) that a single installed GHE of specific borehole length can be expected to actually transfer (i.e. exchange) between the Earth and the geothermal heat pump or chiller system to which the GHE is connected, where such in situ heat transfer rate testing is performed. Also, such HTR measurements provide the ground loop engineer with an empirical measure on the rate of heat energy that a linear foot of GHE can be expected to actually transfer (i.e. exchange) between the heat transferring fluid and the Earth, expressed in units of [BTU/hr ft].

STEP 28: For sampling intervals where thermal equilibrium conditions are indicated, calculate the Flow Work Rate (FWR) of the GHE using the formula \dot{W}_{pghe}=\dot{m}v(Pᵢₙ−Pₒᵤₜ) expressed in units of BTU/Hr, and record the results of the calculation. This FWR figure represents the rate of work performed by the water circulation pumps on the heat transferring fluid (i.e. water) in order to overcome frictional, viscous and other energy losses and maintain the flow of the heat transferring fluid through the GHE, without any change in kinetic or potential energy of the water while flowing through the control volume of the GHE. This calculated figure provides a performance measure indicating how much (or little) work, measured in [BTUs/Hr], is actually required by the ground loop pump to push and pull water through the inlet and outlet ports of each tested GHE. While typically not a significant figure with respect to other pressure-dissipating components in a GLHE subsystem, this figure provides an actual measure of work continuously supplied to a GHE, which is required when computing the EER_{ghe}=COP_{ghe} figure discussed below.

STEP 29: For sampling intervals where thermal equilibrium conditions are indicated, calculate the Energy Efficiency Ratio of the GHE using the formula

$$\begin{matrix}{EER}_{ghe} = {COP}_{ghe} {EER}_{ghe} \\ = \frac{{\dot{Q}}_{ghe}}{{\dot{W}}_{pghe}} \\ = {COP}_{ghe}\end{matrix}$$

where the figures \dot{Q}_{ghe},\dot{W}_{pghe} have been calculated on a per linear foot of drilled borehole basis, and then record the EER_{ghe} value.

The calculated EER_{ghe}=COP_{ghe} figure provides a performance measure indicating how many heat transfer rate (HTR) units are achieved by the GHE for each unit of flow work rate (FWR) supplied by the circulation pump to the working fluid (water) moving through the GHE, and allowing for simple performance comparisons among different GHE technologies tested at any given loop field test site, or between different ground loop field test sites.

STEP 30: For sampling intervals where thermal equilibrium conditions are indicated, calculate the Heat Transfer Efficiency (HTE) of the GHE using the formula:

$$\begin{matrix}{HTE}_{ghe} = \frac{{\dot{Q}}_{ghe}^{real}}{{\dot{Q}}_{ghe}^{ideal}} \\ = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}\end{matrix}$$

Then, record the calculated HTE_{ghe} value. This calculated HTE_{ghe} figure provides the engineer with a performance measure indicating how close to an “ideal” GHE, a particular “real” GHE is performing in its deep Earth environment, under particular test or operating conditions. Notably, this energy-based performance figure is a function of inlet water temperature and deep Earth temperature, and thus varies when these parameters change.

STEP 31: Generate a GHE Performance Chart (\dot{Q}_{ghe} vs. Tᵢₙ) for constant values of volumetric flow rate \dot{V} within the operating limits of the performance test, as illustrated in FIG. 11A.

STEP 32: Generate a GHE Performance Chart (\dot{Q}_{ghe} vs. ΔT_{driving}) for constant values of volumetric flow rate \dot{V} within the operating limits of the performance test, as illustrated in FIG. 11B.

STEP 33: Generate a GHE Performance Chart (\dot{W}_{ghe} vs. Tᵢₙ) for constant values of volumetric flow rate \dot{V} within the operating limits of the performance test, as illustrated in FIG. 11C.

STEP 34: Generate a GHE Performance Chart (EER_{ghe} vs. Tᵢₙ) for constant values of volumetric flow rate \dot{V} within the operating limits of the performance test, as illustrated in FIG. 11D.

STEP 35: Generate a GHE Performance Chart (HTE_{ghe} vs. Tᵢₙ) for constant values of volumetric flow rate \dot{V} within the operating limits of the performance test, as illustrated in FIG. 11E.

STEP 36: Generate a GHE Performance Chart (\dot{Q}_{ghe} vs. \dot{V}_{ghe}) for constant values of inlet water temperature Tᵢₙ within the operating limits of the performance test, as illustrated in FIG. 12A.

STEP 37: Generate a GHE Performance Chart (\dot{W}_{ghe} vs. \dot{V}_{ghe}) for constant values of inlet water temperature Tᵢₙ within the operating limits of the performance test, as illustrated in FIG. 12B.

STEP 38: Generate a GHE Performance Chart (EER_{ghe} vs. \dot{V}_{ghe}) for constant values of inlet water temperature Tᵢₙ within the operating limits of the performance test, as illustrated in FIG. 12C.

STEP 39: Generate a GHE Performance Chart (HTE_{ghe} vs. \dot{V}_{ghe}) for constant values of inlet water temperature Tᵢₙ within the operating limits of the performance test, as illustrated in FIG. 12D.

STEP 40: Compile a Performance Report for the completed performance test period, including the generated Performance Charts for the GHE, illustrated in FIGS. 11A through 12D above.

### Overview on Engineering Ground Loop Heat Exchanging (GLHE) Subsystems Using the Ground Loop Engineering (GLE) Process and Technology

While is a fact that the specific heat transfer rate (HTR) performance of any GHE will depend on the various factors considered hereinabove, it is highly recommended that enthalpy-based performance testing be conducted on all medium-to-large scale geothermal projects specifying the use of GHE technology. The recommended method for engineering such GLHE subsystems using GHE technology is described herein below.

However, it has been discovered that some very useful generalizations can be made about the use of GHE technology when constructing small-scale GLHE subsystems in deep Earth environments characterized by average deep Earth temperatures below about 60 [° F.], and connected to geothermal equipment (GTE) producing maximum inlet water temperatures Tᵢₙ(max)>105° F., during full load operating conditions, so that the TPD “driving” function for the GLHE subsystem will be 45 [° F.] or greater.

Based on experience with such geological/hydro-geological environments and conditions, a GHE Design Library can be developed listing average (empirically determined) heat transfer rate (HTR) values that are achievable in deep Earth environments having aquifers and deep Earth temperatures below about 60 [° F.]. When using this GLE Method, particularly developed for small-scale geothermal projects, the engineer works with average empirically determined HTR figures of performance for GHEs listed in the GHE Design Library, and representing the “estimated” capacity of a particular Thermacouple® GHE model to extract heat energy from or inject heat energy into a deep Earth environment (i.e. 30-300 feet deep) with T_{de}≦60 [° F.], at the specified rate, expressed in units of Tons, or BTU/Hr, and alternatively, in units of BTU/Hr, per linear foot of the GHE [BTU/Hr-ft]. Designers and engineers use such published heat transfer rate (HTR) figures to estimate how many 300 foot GHEs will be required when installed 20 or more feet apart from each other in the loop field, to construct a GLHE subsystem having a sufficient capacity to exchange heat energy with the deep Earth environment at rates which meet the requirements of the geothermal heat pump system to which it is connected. This average or estimated heat energy transfer rate Q_{ghe} of a single GHE, provides a reliable measure on the heat transfer rate (HTR) capacity of a single GHE.

For medium-to-large scale projects (e.g. greater than 15 Tons of heating or cooling and/or where the deep Earth temperature is less than 60° F.), the ground loop engineer is urged to conduct an in situ heat transfer rate (HTR) test on a single 300 foot test GHE installed at the loop field test site, using the GHE Performance Test Instrument disclosed herein, employing the enthalpy-based GHE performance test method taught herein. The purpose of the in situ performance test is to empirically determine the “actual” rate of heat transfer performance of a single foot GHE test installation, expressed in units of [BTU/Hr], when constructed/installed in the particular loop field under construction. Using this empirically determined (actual) heat transfer rate figure for the given loop field under construction expressed in [BTU/Hr], or alternatively in an equivalent heat transfer rate per linear foot of GHE [BTUs/hr-ft], the designer/engineer can quickly determine the optimal number (or linear feet) of GHE that must be installed in the specified loop field to construct a GLHE subsystem having a sufficient heat transfer rate capacity, in the most economical manner possible. Ground loop engineers are encouraged to allow for extra heat transfer rate (HTR) capacity in each GLHE subsystem design, as this extra HTR capacity will provide a desired degree of thermal storage/banking to the resulting GLHE subsystem under design and construction.

### Engineering Small-Scale Ground Loop Heat Exchanging (GLHE) Subsystems Using the Ground Loop Engineering Process and Technology of the Present Invention

Multiple GHEs can be coupled together to construct small-scale GLHE subsystems (e.g. requiring less than 15 Tons of heat transfer rate performance). In such size geothermal system projects, a “library-based” design/engineering method is recommended.

STEP 1: Determine the total thermal load of the geothermal system under design. In cooling dominant locations, this is achieved by computing the total HVAC thermal energy load (including Peak and Block Load calculations) of the building project, \dot{Q}_{gte}(max)=\dot{Q}_{system,cooling}(peak).

STEP 2: Divide the total HVAC thermal energy load by the average empirically-determined heat transfer rate (HTR) of a single GHE (i.e. 5 Tons or 60,000 BTU/Hr), to compute ground loop design parameter N—the total number of GHEs required to construct a small-scale GLHE subsystem that meets the maximum heat transfer rate requirements of the building project, in the cooling or heating dominant location, as the case may be.

The average empirically-determined HTR value for a particular GHE is specified in a GHE Library, for aquifer rich environments characterized by average deep Earth temperatures under 60 [° F.].

For a given GHE, its HTR value is used to compute the total number of 300 foot Thermacouple® GHEs (Model TC50) that will be required to construct a small-scale Thermacouple® GLHE subsystem that will meet the maximum heat transfer rate requirements of the building project, in the cooling dominant location.

When designing a GLHE subsystem for heating dominant locations, the ground loop designer or engineer should confirm that the total factory-specified heating capacity of the ground source heat pump(s), and other supplementary, or auxiliary heating equipment sources to be used, are added up to meet the building heating load requirement.

The ground loop designer or engineer then computes N—the total number of GHEs required to meet the maximum heat transfer rate requirements of the building project in the heating dominant location. This number N is computed using the following formula:

$$N = \frac{{\dot{Q}}_{gte} ( peak )}{{\dot{Q}}_{ghe} ( average )}$$

where the peak thermal load figure of the building (or its geothermal equipment) is represented by \dot{Q}_{gte}(max)=\dot{Q}_{gte}(peak) and the average empirically-determined HTR value for a single GHE model, specified in the GHE Library, is represented by \dot{Q}_{ghe}(average).

At this stage, it is highly recommended that the ground loop engineer consult a local hydro-geologist with expertise in and knowledge of the local hydrogeology of the land on which the GLHE subsystem under design is being planned for construction/installation.

Also, it is highly recommended that the hydro-geologist consult with federal, state and local authorities who may have actual knowledge, and/or recorded evidence of the hydro-geological conditions on the proposed ground loop field, including aquifers and ground water formations and resources present in the terrestrial aquatic environment in which GHEs will be installed.

STEP 3: Use the computed number of GHEs to layout the ground loop field using suitable computer-assisted 2D or 3D geometry modeling tools, such as AUTOCAD MEP® software from Autodesk, Inc.

Ground loop fields are designed in various shapes and sizes, depending on the thermal loading requirements of the geothermal heat pump, chiller or HVAC equipment, to which the ground loops are connected. Also, most ground loop fields are configured to fit within the available real estate property boundaries of the buildings being served.

As a general rule, at least a 20 foot borehole-spacing distance should be established between neighboring boreholes of GHEs, to minimize the effects of thermal influence between neighboring GHEs, in the resulting GLHE subsystem under design and construction.

However, it is understood that greater borehole spacing distances (e.g. 25 feet borehole spacing) is preferred, if and wherever possible. The reason is that additional borehole/GHE spacing beyond 20 feet will increase the capacity of the deep Earth environment about each GHE to quickly absorb and disperse thermal energy within the semi-infinite deep Earth environment in which it is installed, without a measurable or significant change in the average deep Earth temperature T_{de} in the vicinity of the GHE, over long periods of time.

Placing GHEs too closely (i.e. significantly less than 20 feet apart) runs the risk of changing the deep Earth temperature over long periods of time, and degrading the local temperature gradients about each GHE. In accordance with the laws of heat transfer, strong local temperature gradients are required for the rapid transfer of heat energy (i) from GHE into the deep Earth environment during cooling modes, and (ii) from the deep Earth environment into the GHE during heating modes of operation.

Also, at this stage, it is recommended that the ground loop designer or engineer consult a local hydro-geologist with expertise in and knowledge of the local hydrogeology of the land on which the GLHE subsystem under design is being planned for construction/installation. The hydro-geologist should consult with federal, state and local authorities who may have actual knowledge, and/or recorded evidence of the hydro-geological conditions on the proposed ground loop field, including aquifers and ground water formations and resources present in the terrestrial aquatic environment in which GHEs will be installed.

STEP 4: Design a ground loop zoning and piping arrangement that meets the requirements of the ground loop layout designed in STEP 3.

In connection with ground loop layout design, it is understood that there are many ways to layout (i.e. distribute) a predetermined number of GHEs about the premises of a building or building complex. The ground loop field designer should consider the number of “Heating/Cooling Zones” being provided for in the building environment whose space is to be automatically controlled, and also the maximum thermal load that each such Heating/Cooling Zone must handle by design.

The ground loop field designer and engineers should also consider ways of intelligently (i) organizing groups of GHEs into “Ground Loop Zones,” (ii) assigning one or more “Heating/Cooling Zones” to a Ground Loop Zone, and (iii) then connecting these Heating/Cooling Zones to the Ground Loop Zones by networks of fluid piping, including water circulation pumps, valves, manifolds and other controls and measures.

When designing, constructing and testing such underground fluid piping networks, reference should be made to any Installation Instructions, provided by the manufacturer of the GHE system. Such documents will provide technical guidance and instruction required to design, construct and test such underground fluid piping networks using conventional materials, methods and standards.

When properly designed and constructed, such underground fluid piping networks should interconnect installed GHEs together, along with water circulation pumps, valves, manifolds and controls, to form Ground Loop Zones that are connected to geothermal heat pumps, the unloading sections of chillers, or other thermal conditioning equipment, to complete any GLHE subsystem.

STEP 5: Construct the finally designed GLHE subsystem at the specified test site using (i) the number of GHEs determined in STEP 3, (Ii) the ground loop field layout determined in STEP 3, and (iii) ground loop piping arrangement determined in STEP 4.

STEP 6: Test and tune the installed GLHE subsystem as taught hereinafter.

STEP 7: Install and configure an Enthalpy-Based Ground Loop Performance Monitoring Module in accordance with the principles and procedures taught herein.

### Engineering Medium-to-Large Scale Ground Loop Heat Exchanging (GLHE) Subsystems Using the Ground Loop Engineering Process and Technology of the Present Invention

Multiple GHEs can be coupled together to construct medium-to-large scale GLHE subsystems (e.g. requiring more than 15 Tons of heat transfer rate performance). In such size geothermal system projects, a rational performance-driven design/engineering method is recommended, as described below.

During the GHE Performance Test described in FIGS. 10A through 10I, the GHE Performance Test Instrument drives the GHE test installation over a controlled range of inlet water temperatures {Tᵢₙ(min), Tᵢₙ(max)} while the volumetric flow rate \dot{V}_{ghe} is maintained substantially constant during performance testing operations, so that test data can be collected which will allow the GHE Performance Chart of FIG. 11A to be generated using enthalpy-based HTR calculation techniques, and without knowledge of the many unknowns and unknowable parameters beneath the deep Earth environment.

The Performance Chart of FIG. 11A shows the actual heat transfer rate (HTR) performance characteristics of a single GHE Installation during highly-controlled performance testing conditions that emulate a full range of thermal loading effects to be expected by the selected geothermal equipment (GTE) used to construct the geothermal system.

From such empirically-determined values of HTR and controlled values of Tᵢₙ to drive the GHE test installation, the alternative GHE performance Chart of FIG. 11B can be generated as well. From this Performance Chart, the Total Thermal Conductance of the GHE installation can be measured for different values of TPD (ΔT_{driving}=Tᵢₙ−T_{de}) and volumetric flow rate I_{ghe}, which are under the control of the engineers conducting such GHE Performance Testing operations.

Then, engineers will use these Performance Charts, along with the peak thermal load conditions \dot{Q}_{gte}(peak) for the building, to rationally determine (ii) number of GHEs required to meet the heat transfer rate requirements of the geothermal system under design, as well as (ii) the required volumetric flow rates required to support such heat transfer rates on both sides of the geothermal system.

STEP 1: Determine the peak thermal (HVAC) load \dot{Q}_{gte}(max) of the Geothermal System under design (i.e. typically greater than 15 Tons), as explained above.

STEP 2: Determine the “performance or operating limits” of the selected geothermal equipment (e.g. chiller or heat pump equipment) specified by its manufacturer (e.g. maximum outlet water temperature T_{gte}(max)=Tᵢₙ(max) and maximum volumetric flow rate \dot{V}_{gte}(max)).

Consider, for example, a 30 Ton geothermal system project calling for a 30 Ton Reversible Chiller, whose full load operating limits are specified in its Performance Data Table, setting forth, Entering Source (Water) Temperature (EST), Load Flow Rate [GPM], Leaving Source (Water) Temperatures (LST) [° F.], and other performance/operating parameters. Analyzing this Table, the engineer should determine T_{gte}(max)=Tᵢₙ(max) and \dot{V}_{gte}(max). Then T_{gte}(max)=Tᵢₙ(max) should be used as operating limits on inlet water temperature during the GHE Performance Test. Also, \dot{V}_{gte}(max) should be used to design the maximum volumetric flow rate through the geothermal equipment (GTE).

STEP 3: Use the Performance Test Instrument to conduct a GHE Performance Test on a single GHE installed at the ground loop test site, according to the Test Method specified in FIGS. 10A through 10I, and within the Operating Limits determined in STEP 2.

Also, at this stage, it is recommended that the engineering team consult a local hydro-geologist with expertise in and knowledge of the local hydrogeology of the land on which the GLHE subsystem under design is being planned for construction/installation. The hydro-geologist should consult with federal, state and local authorities who may have actual knowledge, and/or recorded evidence of the hydro-geological conditions on the proposed ground loop field, including aquifers and ground water formations and resources present in the terrestrial aquatic environment in which GHEs will be installed.

STEP 4: From Test Data collected during STEP 3, generate a set of Performance Charts for the GHE installation, illustrated in FIGS. 11A through 11E and 12A through 12D.

STEP 5: From the Performance Charts generated in STEP 4, determine:

(i) the maximum Heat Transfer Rate, \dot{Q}_{ghe}(max) which a single GHE installation can support with the deep Earth, at inlet water temperature Tᵢₙ within the Operating Limits determined in STEP 2; and

(ii) the maximum volumetric flow rate of water \dot{V}_{ghe}(max) that must flow through the Thermacouple®GHE to support the maximum HTR figure of performance \dot{Q}_{ghe}(max).

STEP 6: Based on the \dot{Q}_{ghe}(max) figure of performance determined in STEP 5, and using an inter-borehole spacing of at least 20 feet at the ground loop site, determine the N total number of Thermacouple® GHEs required to meet the peak thermal/cooling load of the geothermal system, \dot{Q}_{gte}(max).

To determine the ground loop design parameter N, the first step involves analyzing the empirically-generated Performance Charts shown in FIGS. 11A and 12A, and determining the maximum heat transfer rate (HTR), \dot{Q}_{ghe}(max, {Tᵢₙ(min), Tᵢₙ(max)}) which a single GHE installation is capable of supporting with the deep Earth environment at deep Earth temperature T_{de} (i.e. within the lower and upper operating/performance limits of the selected geothermal equipment, determined by the manufacturer thereof). Typically, operating/performance limits including, entering source water temperature (EST), leaving source water temperature (LST), average temperature rise across the condenser, and volumetric flow rate, are used in STEP 2 to determine the upper and lower limits on the inlet water temperature Tᵢₙ during GHE Performance Testing.

Once \dot{Q}_{ghe}(max,{Tᵢₙ(min), Tᵢₙ(max)}) has been determined from the Performance Charts, the engineering team can quickly calculate N_{ghe}(total,d=20 feet), i.e. the total number of GHEs installed at least 20 feet apart at the test site, required to construct a GLHE subsystem capable of supporting the peak cooling load of the geothermal system, \dot{Q}_{gte}(max)=\dot{Q}_{system,heating}(peak)\dot{Q}_{system,cooling}(peak).

The total number of GHEs, N_{ghe}=N, is determined by the following formula:

$${N}_{ghe} ( total , d = 20 feet ) = \frac{{\dot{Q}}_{system , cooling} ( peak )}{{\dot{Q}}_{ghe} ( max , \{ {T}_{in} ( min ) , {T}_{in} ( max ) \} )}$$

where \dot{Q}_{system,cooling}(peak) is the peak load of the geothermal system under design during its cooling mode, and where \dot{Q}_{ghe}(max,{Tᵢₙ(min), Tᵢₙ(max)}) is the maximum heat transfer rate (HTR) that a single GHE installation is capable of supporting with the deep Earth environment at deep Earth temperature T_{de}, within the operating limits set on the inlet water temperature Tᵢₙ, {Tᵢₙ(min),Tᵢₙ(max)} by virtue of the operating/performance limits of the geothermal equipment, and the average deep Earth temperature T_{de} of the ground loop test field.

The engineering team can use the other generated Performance Charts, illustrated in FIGS. 11B through 11E and 12B through 12D, to assess the performance of the GHE installation test site against the performance measures, and support decisions during the ground loop engineering process.

STEP 7: Based on design parameters N, the total number of GHEs determined in STEP 6, and \dot{V}_{ghe}(max) the maximum volumetric flow rate through each GHE, determine the maximum volumetric flow rate \dot{V}_{glhe}(max) that must flow through the GLHE subsystem constructed from N number of GHEs installed at the ground loop test site, so that the resulting GLHE subsystem is capable of supporting the maximum thermal load \dot{Q}_{gte}(max) required by the geothermal system.

STEP 8: Interfacing The Selected Geothermal Equipment (GTE) And The Designed GLHE subsystem

CASE 1: If the volumetric flow rate \dot{V}_{glhe}(max) required by the GLHE subsystem is equal to the maximum volumetric flow rate \dot{V}_{gte}(max) specified by the manufacturer of the selected geothermal equipment, then plan on directly connecting the selected geothermal equipment (GTE) to the designed GLHE subsystem, without the use of a plate heat exchanger (PHE) or other heat exchanging device.

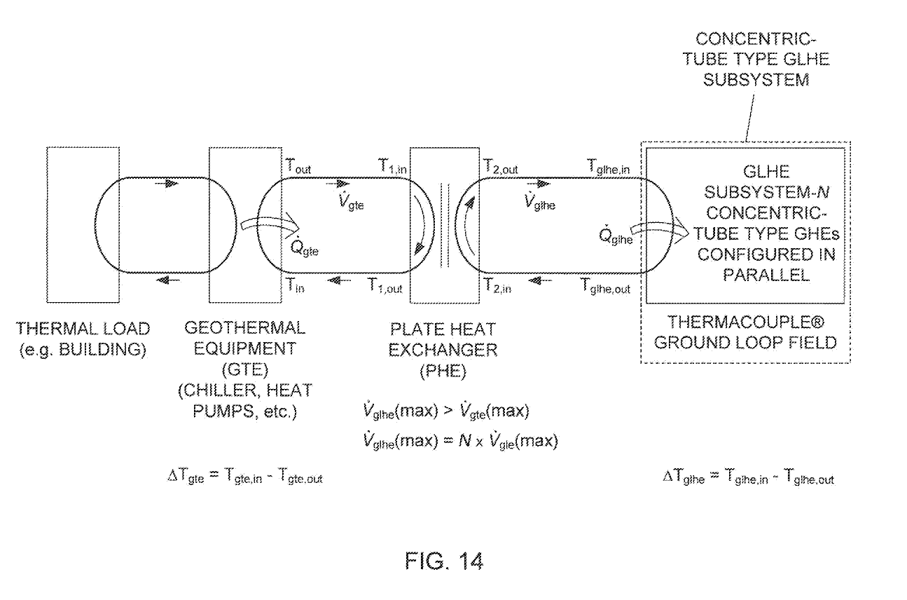

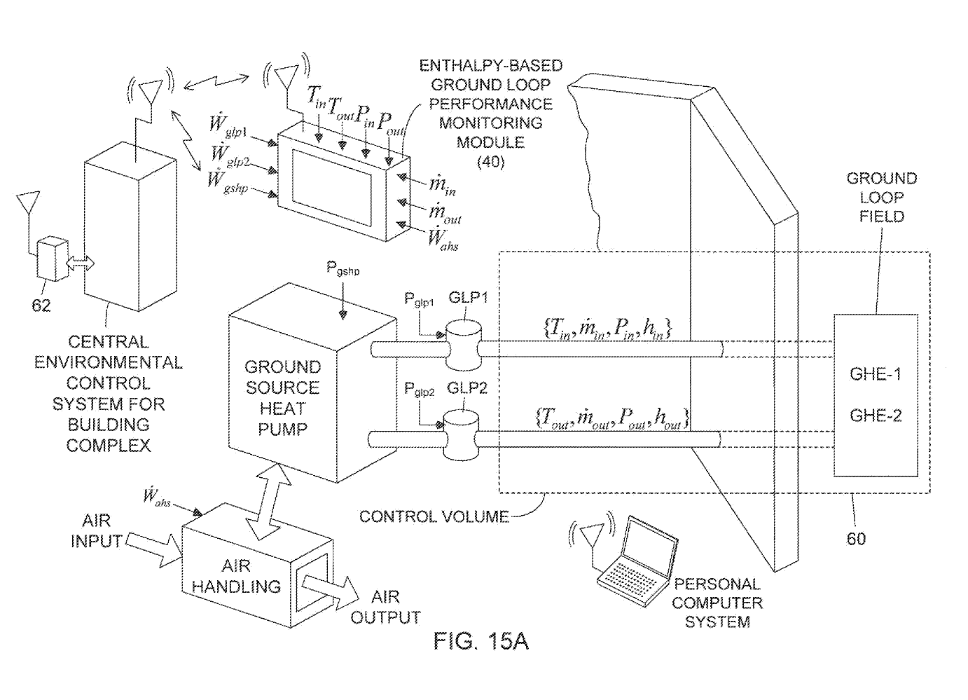

CASE 2: If the volumetric flow rate \dot{V}_{glhe}(max) required by the GLHE subsystem is greater or less than, and not equal to the maximum volumetric flow rate \dot{V}_{gte}(max) specified by the manufacturer of the selected geothermal equipment, then design a Plate Heat Exchanger (PHE) for installation between the selected geothermal equipment (GTE) and the designed GLHE subsystem, as shown in FIG. 14.

As illustrated in FIG. 14, the purpose of the PHE is to provide a first hydraulic loop between the geothermal equipment and the PHE, and a second hydraulic (isolated) loop formed between the PHE and the GLHE subsystem, while along the first hydraulic loop, the PHE should support \dot{V}_{gte}(max) and \dot{T}_{gte}(max), specified by the full load operating conditions of the GTE, and along the second hydraulic loop, the PHE should support \dot{V}_{glhe}(max) and Tᵢₙ(max) specified by the full load operating conditions of the GLHE subsystem. The PHE allows the maximum volumetric flow rate of the GLHE subsystem is be set so as to achieve the maximum heat transfer rate (HTR) required by the geothermal equipment (GTE) to meet its maximum building load.

To determine the inlet water temperature into the PHE along the second hydraulic loop, T_{2,in}=T_{glhe,out}, a reiterative-based method can be applied across the control volume of the GLHE subsystem, employing the following enthalpy-based formula:

\dot{Q}_{glhe}(max)=\dot{m}_{glhe}(max)[h(T_{glhe,in}(max),P_{glhe,in})−h(T_{glhe,out}(max),P_{glhe,out})]

where the volumetric flow rate \dot{V}_{glhe}(max) and the mass flow rate glhe T_{glhe,out}(max)=T_{glhe,in}(max)−ΔT_{phe,approach} through the second hydraulic loop are related by the relation

$${\dot{V}}_{glhe} ( max ) = \frac{{\dot{m}}_{glhe} ( max )}{ρ}$$

where ρ is the specific density of water.

By design, the maximum inlet temperature into the GLHE should be equal to the outlet water temperature on the secondary side of the PHE, i.e. T_{glhe,in}(max)=T_{2,out}(max) and the outlet water temperature from the secondary side of the PHE should be a few degrees (at most) less than the inlet water temperature into the primary side of the PHE, i.e. T_{glhe,in}(max)=T_{2,out}=T_{1,in}(max)−ΔT_{phe,approach}, where the approach range ΔT_{phe,approach} is typically designed to be a few degrees or so depending on the application.

Also, the maximum outlet water temperature produced by the GTE is equal to the maximum inlet water temperature into the primary side of the PHE, i.e. T_{gte,out}(max)=T_{1,in}(max). Also, the maximum entering water temperature into the GTE at full load conditions is equal to the outlet water temperature on the primary side of the PHE, i.e. T_{gte/in}(max)=T_{1,out}(max).

To determine the maximum entering water temperature into the GTE along the first hydraulic loop, T_{gte,in}(max)=T_{1,out}(max), reference should be made to the GTE's Performance Data for such figures. Alternatively, one can apply a reiterative-based method across the control volume of the GTE, and employ the following enthalpy-based formula:

\dot{Q}_{gte}(max)=\dot{m}_{gte}(max)[h(T_{gte,in}(max),P_{gte,in})h(T_{gte,out}(max),P_{gte,out})]

where volumetric flow rate \dot{V}_{gte}(max) and mass flow rate \dot{m}_{gte}(max) through the first hydraulic loop are related by the formula:

$${\dot{V}}_{gte} ( max ) = \frac{{\dot{m}}_{gte} ( max )}{ρ}$$

where ρ is the specific density of water.

After a few number of reiterations using the target \dot{Q}_{gte}(max) and the maximum leaving water temperature from the GTE T_{gte,out}(max), T_{gte,in}(max) can be calculated reiteratively using the Thermacouple™ GHE Performance Calculator, and thus providing an estimated value for T_{1,out}(max)=T_{gte,in}(max).

With these input and output temperature and volumetric flow rate specifications, the engineer order a customized two-fluid stream, counter-flow type PHE, from any one or a number of PHE manufacturers, that will meet these design specifications. In some applications, a multi-pass PHE arrangement might be necessary to achieve the desired approach required by the particular application. For additional information about the design, application and performance of plate heat exchangers (PHEs), reference is made to PLATE HEAT EXCHANGERS: DESIGN, APPLICATIONS AND PERFORMANCE (2007) by L. Wang, B Sunden and R. M. Mangglik, published by WIT Press, Billerica, Mass.

STEP 9: Use the determined N number of GHEs to layout the ground loop field using suitable computer-assisted 2D or 3D geometry modeling tools, such as, for example, AUTOCAD MEP® software from Autodesk, Inc. Ground loop fields are designed in various shapes and sizes, depending on the thermal loading requirements of the geothermal HVAC or chiller systems, to which the ground loops are connected. It understood that there are many ways to layout (i.e. distribute) a predetermined number of GHEs about the premises of a building or building complex. Also, most ground loop fields are configured to fit within the available real estate property boundaries of the buildings being served.

As a general rule, a 20 foot borehole-spacing distance is recommended between neighboring boreholes of GHEs, to achieve sufficient thermal isolation between neighboring GHEs, in the resulting GLHE subsystem under design and construction. Also, it is understood that greater borehole spacing distances (e.g. 25 feet borehole spacing) is preferred, if and wherever possible. Additional borehole/GHE spacing beyond 20 feet will increase the capacity of the deep Earth environment about each GHE, to quickly absorb and disperse thermal energy with the semi-infinite deep Earth environment in which it is installed, without a measurable or significant change in the average deep Earth temperature T_{de} in the vicinity of the GHE, over long periods of time.

Placing GHEs too closely (i.e. significantly less than 20 feet apart) runs the risk of changing the deep Earth temperature over long periods of time, and degrading the local temperature gradients about each GHE. In accordance with the laws of heat transfer, strong local temperature gradients are required for rapid transfer of heat energy (i) from GHE into the thermal mass of the deep Earth environment during cooling modes, and (ii) from the deep Earth environment into the GHE during heating modes of operation.

Only when the thermal conductivity properties of the deep Earth environment have been brought into serious question for a large project planned on a relatively small parcel of land and there is a need to install GHEs substantially less than 20 feet apart, then performing the “Deep Earth Temperature Response Test” specified hereinafter is recommended. The sole purpose of this test, which will require at least two (and possibly more than) two weeks to perform for reliable test results, will assist the ground loop engineer in determining a minimal borehole spacing for GHEs installed in a high-density manner, without significant thermal influences between neighboring GHEs degrading the performance of such GHEs.

STEP 10: Design a ground loop zoning and piping arrangement that meets the requirements of the ground loop layout designed in STEP 9. The ground loop designer or engineer should consider the number of “Heating/Cooling Zones” being provided for in the building environment whose space is to be automatically controlled, and also the maximum thermal load that each such Heating/Cooling Zone must handle by design. The ground loop designer and engineers should also consider ways of (i) intelligently organizing groups of GHEs into “Ground Loop Zones,” (ii) assigning one or more “Heating/Cooling Zones” to a Ground Loop Zone, and (iii) connecting these Heating/Cooling Zones to the Ground Loop Zones by networks of fluid piping, including water circulation pumps, valves, manifolds and other controls and measures.

When designing, constructing and testing such underground fluid piping networks, reference should be made the Installation Instructions of the GHE. Such documents should provide technical guidance and instruction required to design, construct and test such underground fluid piping networks using conventional materials, methods and standards.

When properly designed and constructed, such underground fluid piping networks should interconnect installed GHEs together, along with water circulation pumps, valves, manifolds and controls, to form Ground Loop Zones that are connected to geothermal heat pumps, the unloading sections of chillers or other thermal conditioning equipment, to complete any GLHE subsystem.

STEP 11: Construct the designed GLHE subsystem at the specified ground loop test site using the N determined number of GHEs, and, if necessary the designed PHE indicated in STEP 8, in accordance with the ground loop layout design and zoning and piping arrangement. Construct the finally designed GLHE subsystem in the specified test site using the determined number of GHEs, and ground loop field layout determined in Step 9, and piping arrangement determined in Step 10.

STEP 12: Use the Performance Charts generated in STEP 4, to test and tune the constructed GLHE subsystem operating within the Operating Limits specified in STEP 2. Or Test and tune the installed GLHE subsystem as taught herein. Optionally, the engineer may Install and configure an Enthalpy-Based Ground Loop Performance Monitoring Module in accordance with the principles and procedures taught herein.

Interconnecting Ground Heat Exchangers with Water Circulation Pumps, Plate Heat Exchangers (PHE), and Geothermal Equipment (GTE) Using Conventional Piping Materials, Methods and Standards

Every GLHE subsystem is constructed from one or more GHEs, interconnected with water circulation pumps and geothermal equipment using conventional piping materials, methods and standards. However, the integrity of any fluid piping network, employed in the construction of any GLHE subsystem, will depend on many factors including design and construction considerations, methods, materials, and workmanship.

By virtue of its system composition, a fluid piping network is comprised of many components, including, for example, pipes, flanges, supports, gaskets, bolts, valves, strainers, flexible and expansion joints. In general, such components can be made from a variety of materials, in different types and sizes, and may be manufactured to common national standards or according to a manufacturer's proprietary specifications. Such standards include, but are not limited to piping codes and standards established by ASME, ANSI, ASTM, AGA, API, AW WA, BS, ISO, and DIN.

In any event, when constructing a fluid piping network for a GLHE subsystem, the following guidelines should be followed closely and carefully:

GUIDELINE 1: Refer and conform to the Installation Instructions of the GHE with regard to designing, constructing and testing ground heat exchangers (GHEs).

GUIDELINE 2: Make certain that every GHE installed in a GLHE subsystem is installed in parallel with other GHEs of the same size and supplied with the same volumetric flow rate of water during geothermal system operation.

GUIDELINE 3: Design and install all piping systems in accordance with ASME B31.9 Building Services Piping standards, which relates to piping typically found in institutional, commercial, and public buildings, multi-unit residences, geothermal heating systems, and district heating and cooling systems.

GUIDELINE 4: Install all piping components in accordance with the manufacturer's installation instructions.

GUIDELINE 5: Refer and conform to the International Mechanical and the International Plumbing Codes for useful references to materials and methods used in piping construction.

GUIDELINE 6: refer and conform to the pump manufacturer's installation instructions regarding volume flow rates (GPM settings), electrical specifications, and optimum pump sizing. Standard installation practices are advised in regard to pipe sizing and friction losses.

GUIDELINE 7: Whenever possible, avoid the use of pipe size reducers, and ells, at or near circulation pumps, which contribute to system wide energy efficiency losses.

GUIDELINE 8: Refer and conform to the ASME B31.9 building standard setting forth requirements for Piping that conducts water or antifreeze solutions used for heating and cooling, as such additives can reduce the specific gravity of the heat transferring fluid circulated through a geothermal heat pump system, and may adversely effect the performance of components employed in a GLHE subsystem. Refer to the GHE Installation Instructions concerning antifreeze solutions.

GUIDELINE 9: Underground piping materials and connections must conform to recognized plumbing codes adopted by state and local code rules and regulations.

### The Enthalpy-Based Ground Loop Performance Monitoring Module of the Present Invention

FIG. 15A shows a first completed geothermal heat pump system being monitored by an Enthalpy-Based Ground Loop (GLHE) Performance Monitoring Module constructed in accordance with the principles of the present invention. As shown, the Ground Loop Performance Monitoring Module is mounted within the pump room of a building in which the completed geothermal heat pump system has been installed and is operating. The geothermal heat pump system is connected to an air handling subsystem, under the control of the central environmental control system of the building. As shown, state variables {Tᵢₙ,Pᵢₙ,\dot{m}ᵢₙ} and {Tₒᵤₜ,Pₒᵤₜ,\dot{m}ₒᵤₜ} are monitored for water flowing into and out of the GLHE subsystem and fed into the Ground Loop Performance Monitoring Module for calculation of the net heat transfer rate (HTR) for the control volume about the entire ground loop field (GLHE) using enthalpy-based HTR calculation techniques taught herein.

As shown, the Ground Loop Performance Monitoring Module also uses formulas defined in FIG. 15B to calculate EER and HTE for the system control volume indicated in FIG. 15A.

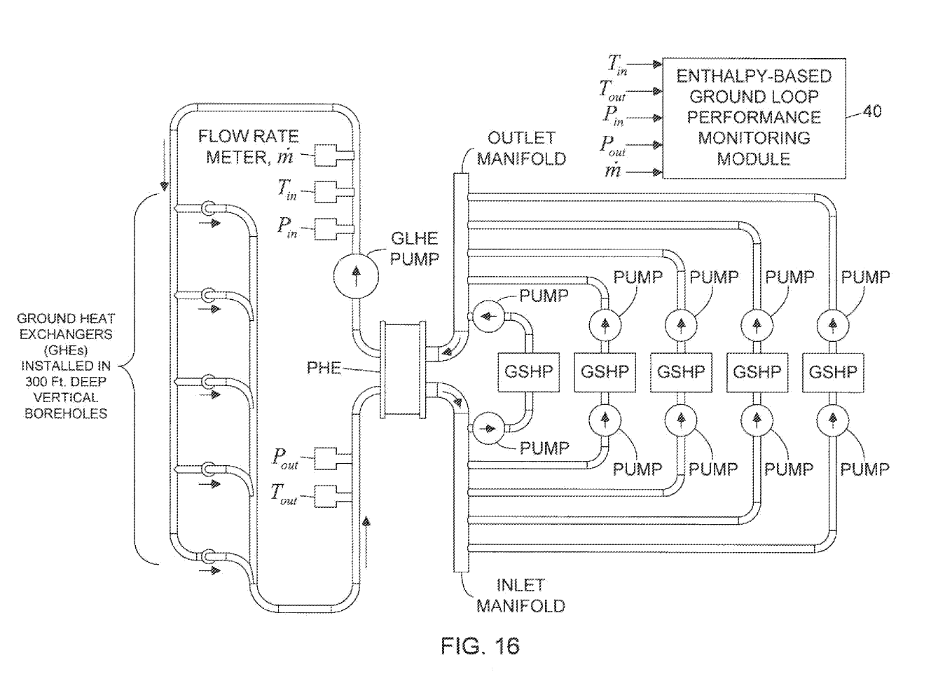

FIG. 16 shows a second completed geothermal heat pump system being monitored by an Enthalpy-Based Ground Loop Performance Monitoring Module constructed in accordance with the principles of the present invention. As shown, the geothermal heat pump system includes a ground loop subsystem constructed from multiple ground heat exchangers (GHEs), connected to multiple, individually zoned ground source heat pumps (GSHPs), by a plate heat exchanger (PHE) as disclosed in FIG. 14, and at which transducers and instruments are installed for measuring the inlet and outlet temperature, pressure and mass flow rates of the heat exchanging fluid (i.e. water), to provide state variables {Tᵢₙ,Pᵢₙ,\dot{m}ᵢₙ} and {Tₒᵤₜ,Pₒᵤₜ,\dot{m}ₒᵤₜ} which are supplied to the Ground Loop Performance Monitoring Module 40 for use in calculating the net heat transfer rate (HTR) for the entire ground loop field (GLHE) using enthalpy-based HTR calculation techniques taught herein.

### Manual Method of Testing and Tuning the Performance of an Installed and Operating Ground Loop Heat Exchanging (GLHE) Subsystem Using Enthalpy-Based GLHE System Performance Measurements

Once a ground loop heat exchanging (GLHE) subsystem has been designed, constructed and installed at a particular location, it is connected to one or more geothermal heat pump, chiller, HVAC equipment, or other type of geothermal equipment (GTE), and then set up for operation in accordance with the manufacturer's installation and operating instructions.

During set up operations, it will be helpful to run through the following “Check Points” to make certain the geothermal system, and its GLHE subsystem has been properly configured and operates in accordance with the manufacturer's specifications.

CHECK POINT 1: Review the geothermal heat pump or chiller installation instructions, building heating and cooling load requirements, and air distribution duct system design, to prevent excessive cooling loads from being imposed on the geothermal heat pump operating in its cooling mode.

CHECK POINT 2: Review the GHE Installation Instructions, available for download at http://www.kelix.com.

CHECK POINT 3: Monitor the full load amperage draw (FLA) of the heat pump compressor during initial start up to prevent long term compressor over-current. Excessive entering water temperature Tᵢₙ into the GLHE subsystem (or leaving the heat pump heat exchanger) can be an indication of a load imbalance where the heat pump has been undersized, other indoor air distribution inefficiencies, and/or inadequate thermostatic controls may exist.

Notably, the operating characteristics of each geothermal heat pump system and chiller will be different from brand to brand, and for different applications, due largely to air distribution ductwork configuration, varying load conditions (use/occupancy), different indoor environmental control schemes, and the variations in energy saving measures taken during building construction, or renovation.

Assuming the geothermal heat pump has been properly sized for the heating and cooling load, and the air distribution ductwork has been installed according to design specifications, several basic measurements should be monitored during start up to insure that the geothermal heat pump is operating under load conditions specified by the heat pump manufacturer.

CHECK POINT 4: Make adjustments to the indoor air distribution blower motor speed to change the volume of air (CFM) passing through the cooling/heating coil, so that the full load amperage of the compressor is achieved under full load conditions. Generally, single-speed refrigerant compressors are designed to operate at constant full load amperages (FLA). Variable-speed refrigerant compressors are designed to operate at amperages that change between compressor operating speeds, and are driven by electronically controlled motors (ECMs), which are typically supplied with variable electrical power by way of SCR-based electronic power controllers, with programmable modes of power output operation, well known in the art. Typically, variable-speed refrigerant compressors operate within a specified range of operating amperages, e.g. full-load amperage (FLA) to half-load amperage (HLA) specified by the compressor manufacturer. Factory specified amperage ratings for indoor air distribution air blower motors, and compressors, are normally documented in geothermal heat pump and chiller installation instructions.

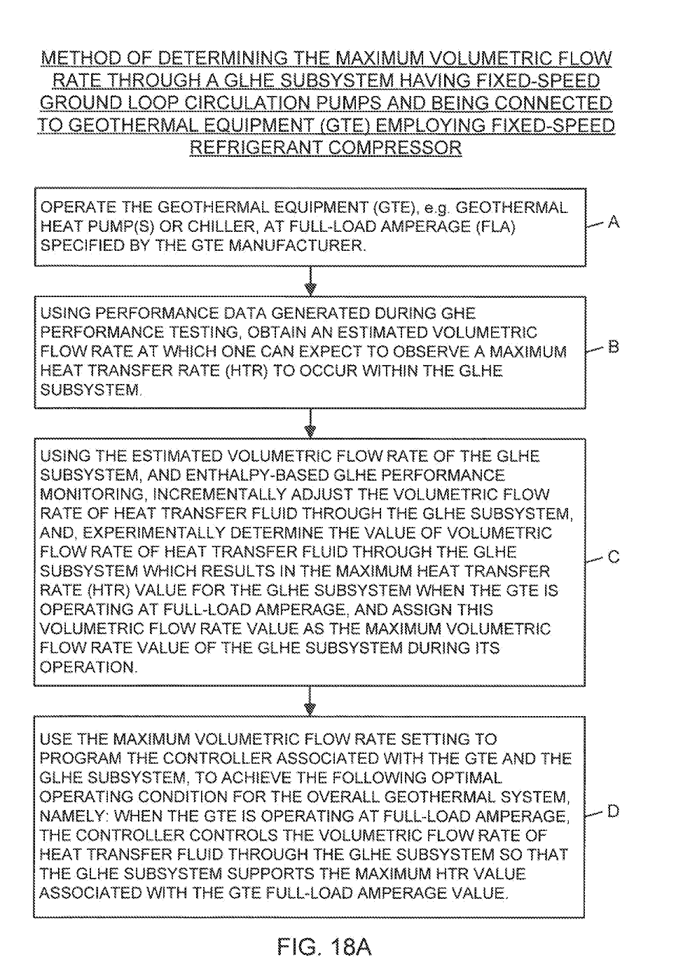

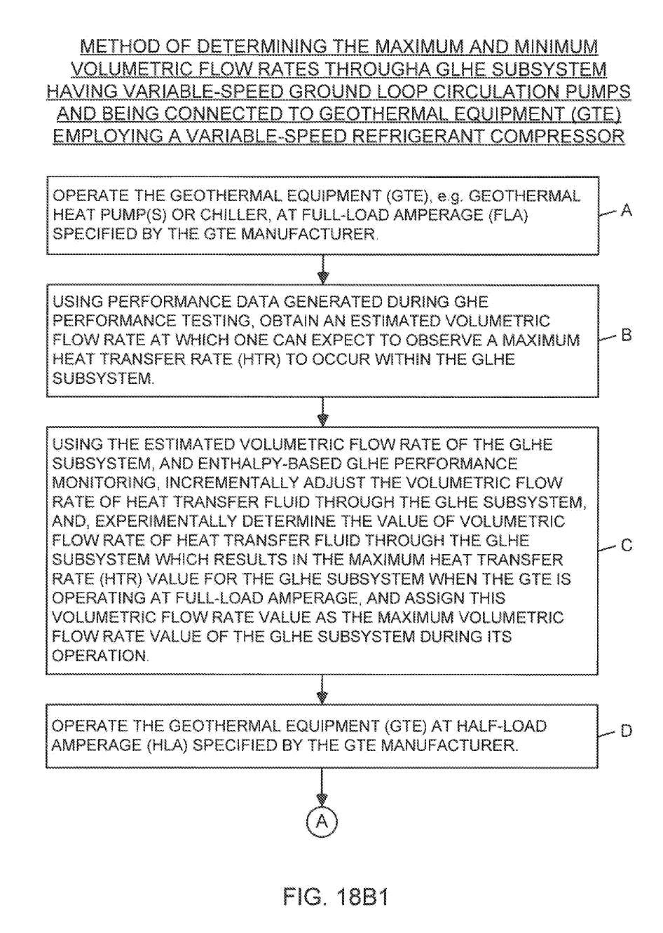

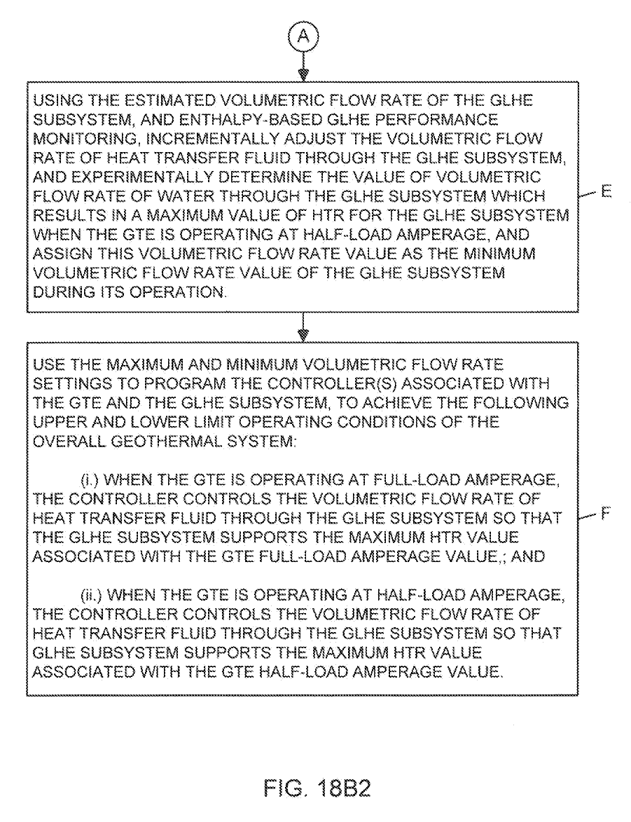

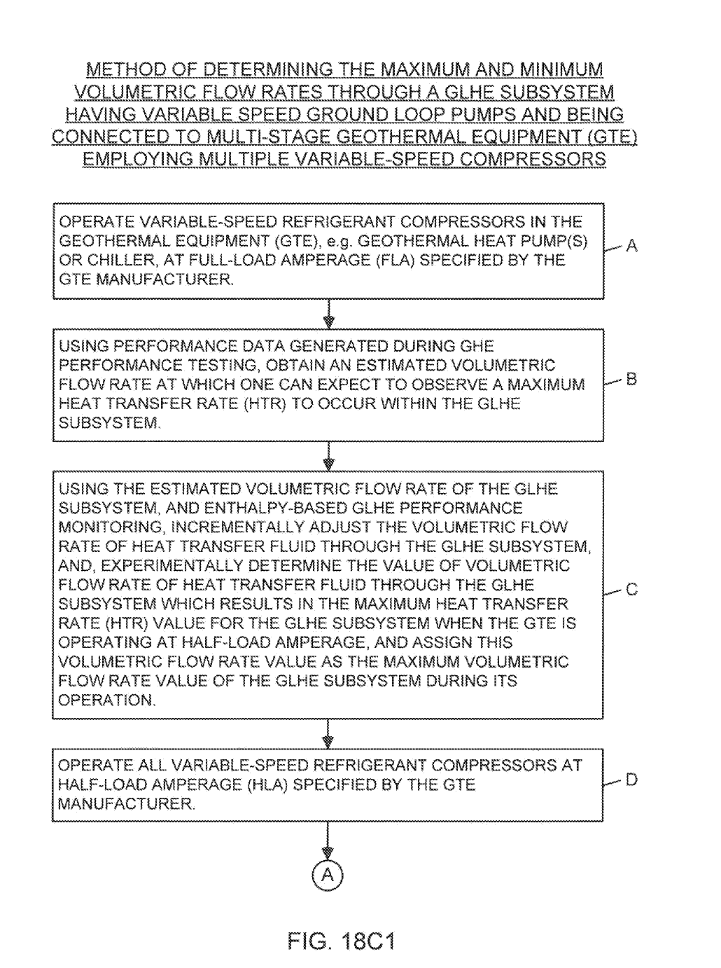

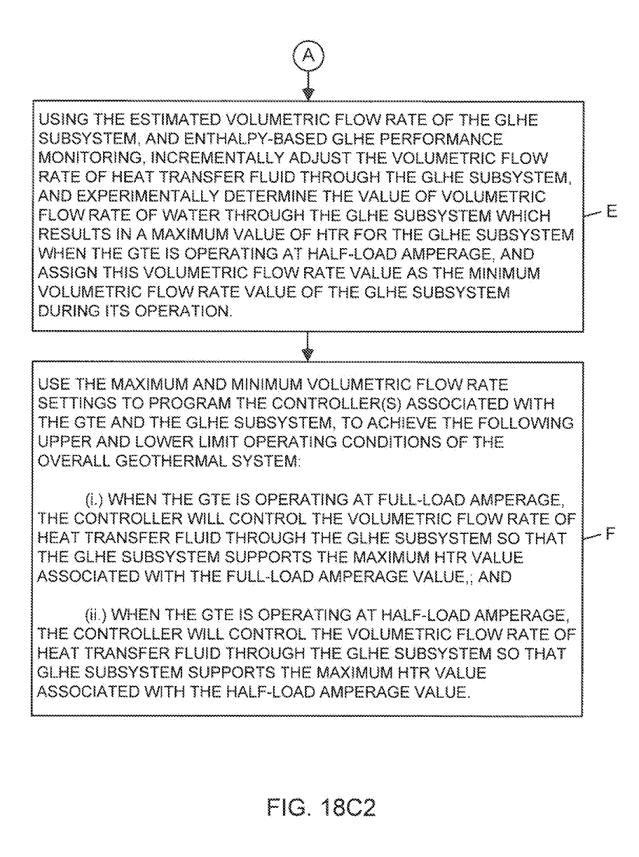

When completing above check points, the geothermal system and its air handling subsystem should be set up and operating properly, and its GLHE subsystem ready for performance testing and tuning, for the purpose of optimize its heat transfer rate (HTR) performance with the deep Earth environment, while the GTE is being managed by the GTE controller in response to time-varying building loads. Depending on the class of geothermal system involved, one of the testing and tuning methods described in FIG. 18 A, 8B or 18C can be used to test and tune operations of the geothermal system, preferably using either an Enthalpy-Based Ground Loop Performance Monitoring Module installed in the system or Enthalpy-Based GHE Performance Calculator Program running on a portable computer system, as shown in FIG. 15A).

In general, geothermal systems can be grouped into at least three different classes described below.

Method of Determining the Maximum Volumetric Flow Rate Through a GLHE Subsystem Having Fixed-Speed Ground Loop Circulation Pumps and being Connected to Geothermal Equipment (GTE) Employing Fixed-Speed Refrigerant Compressor

The first most basic class of geothermal system is where the geothermal system comprises (i) GTE having a single fixed-speed refrigerant compressor with only ON/OFF states of operation, and (ii) a GLHE subsystem having only single or fixed speed ground loop circulation pump(s) that are controlled by the same controller controlling the operation of refrigerant compressor. When using this basic class of geothermal system, it is desired to determine the volumetric flow rate of heat transfer fluid through the GLHE at the refrigerant compressor full-load amperage (FLA) operating conditions, and then program the compressor controller to operate a fixed speed ground loop circulation pump at the volumetric flow rate which achieves the maximum heat transfer rate (HTR) when the compressor is operating at its FLA condition.

In FIG. 18A, a method is described for testing and tuning the GLHE subsystem to achieve such optimized operation. This method involves the use of enthalpy-based GHLE performance monitoring to determine maximum value of HTR for the GLHE subsystem when the fixed-speed refrigerant compressor is operating at its FLA condition, specified by the GTE manufacturer.

As illustrated at Block A in FIG. 18A, the first primary step of the method involves operating the geothermal equipment (GTE), e.g. geothermal heat pump(s) or chiller, at full-load amperage (FLA) specified by the GTE manufacturer.

As indicated at Block B, the second step of the method involves using performance data generated during GHE performance testing, to obtain an estimated volumetric flow rate at which one can expect to observe a maximum heat transfer rate (HTR) to occur within the GLHE subsystem. HTR measurements can be performed using the GLHE energy performance instrumentation described hereinabove.

As indicated at Block C, the third primary step of the method involves using the estimated volumetric flow rate of the GLHE subsystem, and enthalpy-based GLHE performance monitoring, to incrementally adjust the volumetric flow rate of heat transfer fluid through the GLHE subsystem, and, experimentally determine the value of volumetric flow rate of heat transfer fluid through the GLHE subsystem which results in the maximum heat transfer rate (HTR) value for the GLHE subsystem when the GTE is operating at full-load amperage, and assign this volumetric flow rate value as the maximum volumetric flow rate value of the GLHE subsystem during its operation.

As indicated at Block D, the method then involves using the maximum volumetric flow rate setting to program the controller associated with the GTE and the GLHE subsystem, to achieve the following optimal operating condition for the overall geothermal system, namely: when the GTE is operating at full-load amperage, the controller controls the volumetric flow rate of heat transfer fluid through the GLHE subsystem so that the GLHE subsystem supports the maximum HTR value associated with the GTE full-load amperage value.

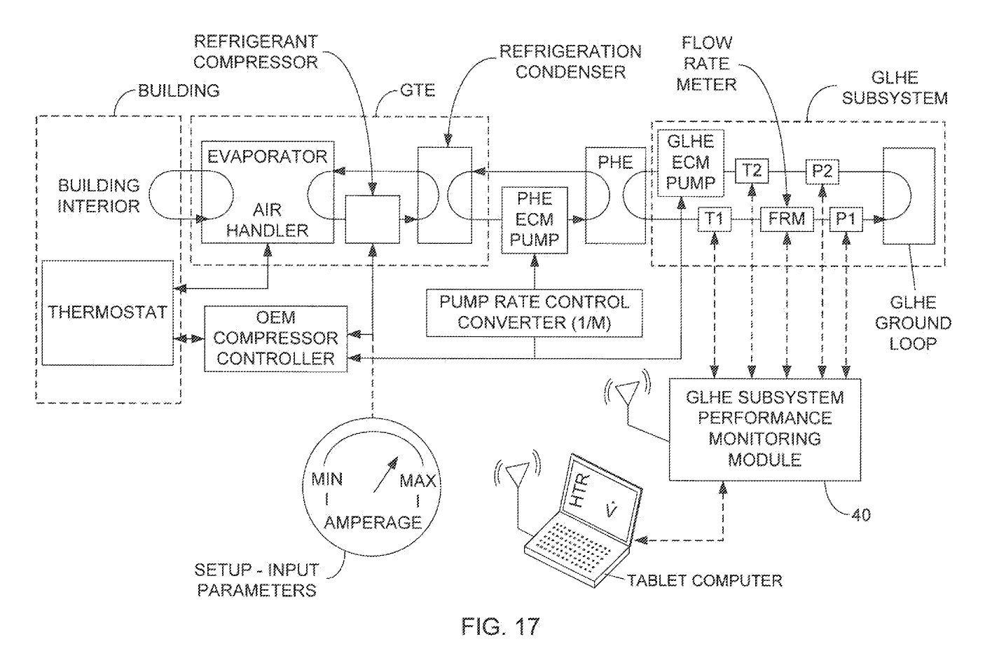

The method of FIG. 18A can be practiced using diverse kinds and types of geothermal systems employing GHE-based GLHE subsystems including the illustrative embodiments shown in FIGS. 15A, 16 and 17, in particular. As shown in FIG. 15A, two GHEs have been installed in the ground loop field, and connected to an inlet and outlet manifold, inside the building, where a single 10 Ton geothermal heat pump has been installed and connected to the inlet and outlet manifolds. In FIG. 16, multiple GHEs are connected to multiple GSHPs via a plate heat exchanger (PHE) as shown in FIG. 14. Also, in FIG. 17, a large-scale GLHE subsystem is connected to a geothermal chiller via a plate heat exchanger (PHE). In each illustrative embodiment, inlet and outlet temperature and pressure measurements {Tᵢₙ, Pᵢₙ, Tₒᵤₜ, Pₒᵤₜ} and water flow rate measurements are made across the “control volume” of the GLHE subsystem during the performance “testing and tuning” optimization procedure described above.

Method of Determining the Maximum and Minimum Volumetric Flow Rates Through a GLHE Subsystem Having Variable-Speed Ground Loop Circulation Pumps and being Connected to Geothermal Equipment (GTE) Employing a Variable-Speed Refrigerant Compressor

The second class of geothermal system is where a geothermal system comprises (i) GTE having a single variable-speed refrigerant compressor with variable states of operation which include at least a full load amperage (FLA) condition for serving maximum thermal loads, and a half-load amperage (HLA) condition for serving minimum thermal loads during operation. A variation on this system class includes the use of a full-range variable-speed refrigerant compressor that can operate in discrete intervals between maximum and minimum amperage ranges, to serve different levels of thermal loading. In this class of geothermal system, it is desired to determine the volumetric flow rate of heat transfer fluid through the GLHE at FLA and HLA operating conditions, and then program the compressor controller to operate a variable-speed ground loop circulation pump(s) at the volumetric flow rates which achieves the maximum heat transfer rate (HTR) when the variable-speed compressor is operating at its FLA and HLA conditions, respectively.

In FIG. 18B, a method is described for testing and tuning the GLHE subsystem to achieve such optimized operation. This method involves the use of enthalpy-based GHLE performance monitoring to determine maximum values of HTR for the GLHE subsystem when the refrigerant compressor is operating at its FLA and HLA conditions, specified by the GTE manufacturer.

As illustrated in FIG. 18B, the first primary step of the method involves operating the geothermal equipment (GTE), e.g. geothermal heat pump(s) or chiller, at full-load amperage (FLA) specified by the GTE manufacturer.

As illustrated at Block B in FIG. 18B, the second primary step of the method involves using performance data generated during GHE performance testing, to obtain an estimated volumetric flow rate at which one can expect to observe a maximum heat transfer rate (HTR) to occur within the GLHE subsystem.

As illustrated at Block C in FIG. 18B, the third primary step of the method involves using the estimated volumetric flow rate of the GLHE subsystem, and enthalpy-based GLHE performance monitoring, to incrementally adjust the volumetric flow rate of heat transfer fluid through the GLHE subsystem, and, experimentally determine the value of volumetric flow rate of heat transfer fluid through the GLHE subsystem which results in the maximum heat transfer rate (HTR) value for the GLHE subsystem when the GTE is operating at full-load amperage, and then assign this volumetric flow rate value as the maximum volumetric flow rate value of the GLHE subsystem during its operation.

As illustrated at Block D in FIG. 18B, the fourth primary step of the method involves operating the geothermal equipment (GTE) at half-load amperage (HLA) specified by the GTE manufacturer.

As illustrated at Block E in FIG. 18B, the fifth primary step of the method involves using the estimated volumetric flow rate of the GLHE subsystem, and enthalpy-based GLHE performance monitoring, to incrementally adjust the volumetric flow rate of heat transfer fluid through the GLHE subsystem, and experimentally determine the value of volumetric flow rate of water through the GLHE subsystem which results in a maximum value of HTR for the GLHE subsystem when the GTE is operating at half-load amperage, and then assign this volumetric flow rate value as the minimum volumetric flow rate value of the GLHE subsystem during its operation.

As illustrated at Block F in FIG. 18B, the sixth primary step of the method involves using the maximum and minimum volumetric flow rate settings to program the controller(s) associated with the GTE and the GLHE subsystem, and achieve the following upper and lower limit operating conditions of the overall geothermal system:

(i) when the GTE is operating at full-load amperage, the controller controls the volumetric flow rate of heat transfer fluid through the GLHE subsystem so that the GLHE subsystem supports the maximum HTR value associated with the GTE full-load amperage value, and

(ii) when the GTE is operating at half-load amperage, the controller controls the volumetric flow rate of heat transfer fluid through the GLHE subsystem so that GLHE subsystem supports the maximum HTR value associated with the GTE half-load amperage value.

The method of FIG. 18B can be practiced using diverse kinds and types of geothermal systems employing GHE-based GLHE subsystems including the illustrative embodiments shown in FIGS. 15A, 16 and 17, in particular. As shown in FIG. 15A, two GHEs have been installed in the ground loop field, and connected to an inlet and outlet manifold, inside the building, where a single 10 Ton geothermal heat pump has been installed and connected to the inlet and outlet manifolds. In FIG. 16, multiple GHEs are connected to multiple GSHPs via a plate heat exchanger (PHE) as shown in FIG. 14. Also, in FIG. 17, a large-scale GLHE subsystem is connected to a geothermal chiller via a plate heat exchanger (PHE). In each illustrative embodiment, inlet and outlet temperature and pressure measurements {Tᵢₙ, Pᵢₙ, Tₒᵤₜ, Pₒᵤₜ} and water flow rate measurements are made across the “control volume” of the GLHE subsystem during the performance “testing and tuning” optimization procedure described above.

Method of Determining the Maximum and Minimum Volumetric Flow Rates Through a GLHE Subsystem Having Variable Speed Ground Loop Pumps and being Connected to Multi-Stage Geothermal Equipment (GTE) Employing Multiple Variable-Speed Refrigerant Compressors

The third class of geothermal system is where a geothermal system comprises (i) GTE having multiple variable-speed refrigerant compressors which are controlled so as to serve different stages of thermal load management within a building structure. In this third class of system, the building control computer can enable and disable particular stages of refrigeration-based heat transfer, by controlling the electronically-controlled refrigerant compressor(s). In this class of system, each refrigerant compressor has variable states of operation which include at least a full load amperage (FLA) condition for serving maximum thermal loads, and a half-load amperage (HLA) condition for serving minimum thermal loads during operation, and typically different discrete levels of operation between these upper and lower limits. In such types of geothermal system, it is desired to determine the volumetric flow rate of heat transfer fluid through the GLHE at FLA and HLA operating conditions, and then program the compressor controller to operate variable-speed ground loop circulation pumps at the volumetric flow rates which achieves the maximum heat transfer rate (HTR) when the compressor is operating at its FLA and HLA conditions, respectively.

In FIG. 18C, a method is described for testing and tuning the GLHE subsystem to achieve such optimized operation. This method involves the use of enthalpy-based GHLE performance monitoring to determine maximum values of HTR for the GLHE subsystem when the variable speed refrigerant compressors are operating, at different stages, at FLA and HLA conditions, specified by the GTE manufacturer.

As illustrated at Block A in FIG. 18C, the first primary step of the method involves operating variable-speed refrigerant compressors in the geothermal equipment (GTE), e.g. geothermal heat pump(s) or chiller, at full-load amperage (FLA) specified by the GTE manufacturer.

As illustrated at Block B in FIG. 18C, the second primary step of the method involves using performance data generated during GHE performance testing, obtain an estimated volumetric flow rate at which one can expect to observe a maximum heat transfer rate (HTR) to occur within the GLHE subsystem.

As illustrated at Block C in FIG. 18C, the third primary step of the method involves using the estimated volumetric flow rate of the GLHE subsystem, and enthalpy-based GLHE performance monitoring, to incrementally adjust the volumetric flow rate of heat transfer fluid through the GLHE subsystem, and experimentally determine the value of volumetric flow rate of heat transfer fluid through the GLHE subsystem which results in the maximum heat transfer rate (HTR) value for the GLHE subsystem when the GTE is operating at half-load amperage, and then assign this volumetric flow rate value as the maximum volumetric flow rate value of the GLHE subsystem during its operation.

As illustrated at Block D in FIG. 18C, the fourth primary step of the method involves operating all variable-speed refrigerant compressors at half-load amperage (HLA) specified by the GTE manufacturer.

As illustrated at Block E in FIG. 18C, the fifth primary step of the method involves using the estimated volumetric flow rate of the GLHE subsystem, and enthalpy-based GLHE performance monitoring, to incrementally adjust the volumetric flow rate of heat transfer fluid through the GLHE subsystem, and experimentally determine the value of volumetric flow rate of water through the GLHE subsystem which results in a maximum value of HTR for the GLHE subsystem when the GTE is operating at half-load amperage, and then assign this volumetric flow rate value as the minimum volumetric flow rate value of the GLHE subsystem during its operation.

As illustrated at Block F in FIG. 18C, the sixth primary step of the method involves using the maximum and minimum volumetric flow rate settings to program the controller(s) associated with the GTE and the GLHE subsystem, to achieve the following upper and lower limit operating conditions of the overall geothermal system:

(i) when the GTE is operating at full-load amperage, the controller will control the volumetric flow rate of heat transfer fluid through the GLHE subsystem so that the GLHE subsystem supports the maximum HTR value associated with the GTE full-load amperage value, and

(ii) when the GTE is operating at half-load amperage, the controller will control the volumetric flow rate of heat transfer fluid through the GLHE subsystem so that GLHE subsystem supports the maximum HTR value associated with the GTE half-load amperage value.

The method of FIG. 18C can be practiced using diverse kinds and types of geothermal systems employing GHE-based GLHE subsystems including the illustrative embodiments shown in FIGS. 15A, 16 and 17, in particular. As shown in FIG. 15A, two GHEs have been installed in the ground loop field, and connected to an inlet and outlet manifold, inside the building, where a single 10 Ton geothermal heat pump has been installed and connected to the inlet and outlet manifolds. In FIG. 16, multiple GHEs are connected to multiple GSHPs via a plate heat exchanger (PHE) as shown in FIG. 14. Also, in FIG. 17, a large-scale GLHE subsystem is connected to a geothermal chiller via a plate heat exchanger (PHE). In each illustrative embodiment, inlet and outlet temperature and pressure measurements {Tᵢₙ, Pᵢₙ, Tₒᵤₜ, Pₒᵤₜ} and water flow rate measurements are made across the “control volume” of the GLHE subsystem during the performance “testing and tuning” optimization procedure described above.

### Monitoring, Logging and Recording the Performance of a Tuned Ground Loop Heat Exchanger (GLHE) Subsystem Using the Enthalpy-Based Ground Loop Performance Monitoring Module

Once a geothermal system (e.g. geothermal heat pump, chiller or HVAC system) and its GLHE subsystem have been installed at a particular loop field location, and operate according to manufacturer specifications, it will be useful to monitor the actual energy performance of the GLHE subsystem.

The energy performance profile for every GLHE subsystem should be expressed in terms of the heat transfer rate (HTR), flow work rate (FWR), energy efficiency ratio (EER/COP), and heat transfer efficiency (HTE) of the control volume drawn about the GLHE subsystem, while the GLHE subsystem is serving the energy transfer requirements of the geothermal system connected to the building environment.

Another object of the present invention to teach how to monitor, log and record the HTR, FWR, EER and HTE performance characteristics of any GLHE subsystem using the Enthalpy-Based Ground Loop Performance Monitoring Module, shown deployed in the geothermal systems of FIGS. 15A, 16 and 17.

In general, the Enthalpy-Based Ground Loop Performance Monitoring Module 40 shown in FIGS. 15A and 15B comprises a number of components, namely: a programmed microprocessor 41; a system bus 42; a memory architecture 43 including RAM, FLASH ROM and hard-disc; a high-speed I/O interface 44 for receiving the inputs from temperature and pressure transducers 45A, 45B, 46A, 46B, volumetric fluid rate meter(s) 47, signals from an onboard GPS transceiver module 48, and other sensed data inputs indicated in FIG. 15A; a touch-screen LCD display panel 49 interfaced with system bus/CPU via display controller 50, for selecting functions and displaying sensed data and calculated performance figures for the system being monitored; a communications module 51 for supporting GSM, WIFI, and Ethernet protocols, with related communication interfaces/ports 52; antennas 53 for supporting the communication module 51; a power supply module 54; a backup battery module 55; and a compact wall-mountable housing 56 for containing all of the system components. The Web-enabled onboard system computer 22 can be realized by a programmed microprocessor having system and I/O buses, supporting one or more of the following data communication interfaces: USB, Firewire, and Ethernet communication interfaces, through which the 3G/4G WIFI router 26 is interfaced.

In general, the Ground Loop Performance Monitoring Module 40 supports multiple analog and digital signal inputs, and multiple communication protocols, for example: RS422/485, Ethernet 10Base-T TCP/IP, Modbus RTU, Ethernet 10Base-T TCP/IP Modbus, BacNet, and Lonworks data communication protocols, as well as WIFI (802.11) and infrared (IR) R100 communication protocols. Such communication protocols enable the Module 40 to monitor devices operating within the ground loop, and communication with environmental control system computers within the building or operating environment.

The mathematical formulas derived for HTR_{glf} FWR_{glp} EER_{glf} and HTE_{glf} as well as Thermal Equilibrium Indices (TEI) and other performance measures specified in detail above, are programmed into the FLASH ROM of the Enthalpy-Based Ground Loop Performance Monitoring Module 40 in a matter known in the computer hardware art, to enable such performance measuring capabilities of the present invention.

### Method of Monitoring, Logging and Recording the Energy Performance of a Tuned Ground Loop Heat Exchanging (GLHE) Subsystem Using The Enthalpy-Based Ground Loop Performance Monitoring Module of the Present Invention

At this juncture, it is appropriate to describe a preferred method of monitoring, logging and recording the energy performance of a tuned ground loop heat exchanging (GLHE) subsystem 60 using the enthalpy-based ground loop performance monitoring module of the present invention.

STEP 1: Install inlet and outlet temperature and pressure transducers 45A-46B, and a volumetric flow rate meter(s) 47 at the inlet and outlet manifolds of the GLHE subsystem 60, as shown in the first geothermal system of FIG. 15A the second geothermal system of FIG. 16, and the third geothermal system of FIG. 17.

As shown in FIG. 15A, a single geothermal heat pump system is connected to an air handling subsystem and a GLHE subsystem comprising two GHE installations, under the control of the central environmental control system of the building. In FIG. 16, the GLHE subsystem 60′ comprises five GHEs, connected to multiple geothermal heat pumps, each having an integrated air handling subsystem. In FIG. 17, the GLHE subsystem is connected to a geothermal chiller, connected to an air handling system.

STEP 2: Use the Enthalpy-Based Ground Loop Performance Monitoring Module 40 to periodically monitor the inlet and outlet temperatures and pressures at a defined control volume of the ground loop system, as well as the volume/mass flow rate through the control volume, {Tᵢₙ,Pᵢₙ,\dot{m}ᵢₙ} and {Tₒᵤₜ,Pₒᵤₜ,\dot{m}ₒᵤₜ} and log and record such data values within the memory aboard the Ground Loop Performance Monitoring Module 40.

STEP 3: Use the Enthalpy-Based Ground Loop Performance Monitoring Module to process logged and recorded data, and calculate the actual heat transfer rate (HTR), flow work rate (FWR), energy efficiency ratio (EER)/Coefficient of Performance (COP), and Heat Transfer Efficiency (HTE) figures for the monitored GLHE subsystem, at periodic moments in time (e.g. at 1 minute or 5 minute intervals).

Once calculated, these performance figures are recorded in a Ground Loop Performance Database Server 62 for the building being served by the GLHE subsystem. The Ground Loop Performance Database Server can be realized using any computer system, but a dedicated server, with automated backup provisions and wireless communication services, is preferred.

After being logged and recorded in the Ground Loop Performance Database Server, the HTR, FWR, EER and HTE performance figures can be sent to the building's environmental control system, if such a system has been installed, and used in the overall energy management system deployed in the building to improve operations efficiency. These measured performance figures will provide building owners, managers, energy performance managers, and geothermal system maintenance technicians alike, with valuable information on how well a particular GLHE subsystem has been and is currently performing, from season to season, year to year.

The building environmental control system can be programmed to periodically interrupt normal heating and cooling equipment operation of the building, allowing continuous fluid circulation to a number of independently piped Ground Loop Field Zones, so that any incremental changes in the deep Earth temperature of those Ground Loop Field Zones can be measured, detected and recorded when the inlet and outlet water temperature of those Zones are in a state of thermal equilibrium (i.e. Tᵢₙ=Tₒᵤₜ). Notably, such periodic deep Earth temperatures and detected incremental changes therein can be stored in the Ground Loop Performance Database Server 62, along with other performance data maintained on the ground loop throughout its lifetime.

Collectively, the historical performance data records on the GLHE subsystem, maintained in the Ground Loop Performance Database, can be used to confirm ground loop performance expectations or projections (with respect to thermal loads), as well as support diagnostic operations, as required.

Modeling the Energy Conservation Balance Across the Control Volume for a Ground Loop Subsystem that is Connected to a Geothermal Heat Pump System and Monitored by the Enthalpy-Based GHE Performance Monitoring Module

FIG. 15C presents an energy conservation balance across the control volume for a ground loop subsystem that is connected to a geothermal heat pump system(s), and monitored by the enthalpy-based GHE performance monitoring module 40 shown being used in the applications of FIGS. 15A, 16 and 17.

In general, the ground loop subsystem might be configured to operate with any type of geothermal HVAC or chiller system 60 as shown, for example, in FIGS. 15A, 16 and 17, or anywhere heat energy is exchanged with the deep Earth environment through a ground loop subsystem, regardless of its design and/or construction.

The energy balance equation across the control volume defined in FIGS. 15A and 15B is given by the expression:

\dot{m}ₒᵤₜhₒᵤₜ=\dot{m}ᵢₙhᵢₙ+\dot{Q}_{ghe1}+ . . . +\dot{Q}_{gheN}

This expression can be rewritten as:

\dot{m}ₒᵤₜhₒᵤₜ=\dot{m}ᵢₙhᵢₙ+\dot{Q}_{glf}

where the total or net heat transfer rate between the N number of GHEs and their deep Earth environment is given by the formula \dot{Q}_{glf}=\dot{Q}_{ghe1}+ . . . +\dot{Q}_{gheN}, and by substitution, the energy balance can be rewritten as follows:

\dot{m}ₒᵤₜhₒᵤₜ=\dot{m}ᵢₙhᵢₙ+\dot{Q}_{glf}

By algebraic manipulation, this energy balance can be rewritten as follows:

\dot{Q}_{glf}=\dot{m}(hₒᵤₜ−hᵢₙ)

This expression for \dot{Q}_{glf} provides a formula for measuring the actual heat transfer rate (HTR_{glf}) between the deep Earth environment and the ground loop field system represented by the control volume indicated in FIGS. 15A, 16 and 17.

Referring now to the pump side of the geothermal system under analysis, where M number of water circulation pumps are provided, the total work rate performed by M number of circulation pumps on heat transferring fluid flowing through a control volume about this system, can be summed up by the following equation:

\dot{W}_{glp}=\dot{W}_{glp1}+ . . . +\dot{W}_{glpM}

This expression represents the total work rate of the M number of ground loop pumps pushing/pulling heat transferring fluid (water) through the control volume of the ground loop field.

Using flow energy analysis, the total amount of flow work performed by these M pumps to move water through the N number of GHEs is given by the following expression:

\dot{W}_{glp}=mv(Pᵢₙ−Pₒᵤₜ)

This expression for \dot{W}_{glp} provides a formula for measuring the actual flow work rate (EER_{glf}) performed by the M circulation pumps to move water through the ground loop field system, defined by the control volume in FIGS. 15A and 16, without a change in potential or kinetic energy of the water flow.

Finally, using the formulas derived for HTR_{glf} and FWR_{glp} above, an Energy Efficiency Ratio (EER_{glf}) can be rewritten for the ground loop field (GLF) comprising N number of GHEs, through which water is pumped by M number of circulation pumps, as follows:

$${EER}_{glf} = \frac{{HTR}_{glf}}{{FWR}_{glp}} = \frac{{\dot{Q}}_{glf}}{{\dot{W}}_{glp}}$$

Making substitutions for the net heat transfer rate and the net flow work in the above expression, the Energy Efficiency Ratio (EER) for the ground loop field can be expressed in terms of measurable inlet and outlet enthalpies and pressures, as follows:

$${EER}_{glf} = \frac{( {h}_{out} - {h}_{in} )}{v ( {P}_{in} - {P}_{out} )}$$

Notably, the above formula for EER_{glf} holds for any control volume about a ground loop field comprising N number of GHEs, driven by M number of ground loop circulation pumps, provides an accurate measure of the actual energy efficiency of the ground loop field.

Moreover, this EER performance figure is expressed in terms of (i) the empirically measurable rate of heat energy exchange between the ground loop field (GLHE) and the deep Earth environment, and (ii) the empirically measurable rate of energy supplied to maintain water flowing through the loop field against frictional and viscous losses, without losses in potential or kinetic energy of the water flowing through the ground loop field, and will include losses associated with piping between the GHEs, as well as the inherent losses of each GHE due to internal fluid frictional losses.

In addition, the heat transfer efficiency (HTE) performance measured can be found for this ground loop heat exchanging (GLHE) subsystem using the following formula:

$$\begin{matrix}{HTE}_{glf} = \frac{{\dot{Q}}_{glf}^{real}}{{\dot{Q}}_{glf}^{ideal}} \\ = \frac{[ 1 - \frac{{h}_{out} ( {T}_{out} , {P}_{out} )}{{h}_{in} ( {T}_{in} , {P}_{in} )} ]}{[ 1 - \frac{{h}_{out} ( {T}_{de} , {P}_{out} )}{{h}_{in} ( {T}_{in} , {P}_{in} )} ]}\end{matrix}$$

where \dot{Q}_{glf}^{real} and \dot{Q}_{glf}^{ideal} are measured at the control volume of the ground loop (GLHE) as indicated in FIGS. 15A and 16, in the illustrative embodiments

The Enthalpy-Based Ground Loop Performance Module shown in FIGS. 15A, 16, and 17 comprises: a programmed microprocessor; a system bus; a memory architecture including RAM, FLASH ROM, etc; and high-speed I/O interface, for receiving the inputs from temperature and pressure transducers, fluid rate meters, GPS receiver, and other data inputs indicated in the spreadsheet of FIG. 10; LCD display panel with touch-screen data input and selection functions; communication circuits (GSM, WIFI, and Ethernet) and communication interface/ports; antennas for supporting the communication circuits; and a compact wall-mountable housing for containing all of the system components. The mathematical formulas derived above for HTR_{glf}, FWR_{glp} EER_{glf} and HTE_{glf} are programmed into the micro-computing architecture of the Enthalpy-Based Ground Loop Performance Module in a manner well known in the data monitoring, logging and recording art.

How to Use the Spreadsheet Enthalpy-Based GHE Performance Calculator Program to Measure the Heat Transfer Rate (HTR) Performance of any Ground Heat Exchanger (GHE) or Ground Loop Heat Exchanging (GLHE) System, Coupled to a Geothermal Heat Pump Operating within a Building Environment

In many geothermal heat pump system applications, building owners and energy engineers need to know, in objective quantifiable terms, how well a particular ground loop subsystem is performing in relation to its geothermal heat pump unit to which it is connected and operating within a building environment. The Spreadsheet Enthalpy-Based GHE Performance Calculator Program of the present invention illustrated in FIGS. 9A1 and 9A2 can be run on any computing system to help measure the heat transfer rate (HTR) performance of a GHE or GLHE subsystem while coupled to geothermal equipment (GTE), e.g. geothermal heat pumps or chiller, operating within a building environment.

STEP 1: install the Spreadsheet Enthalpy-Based GHE Performance Calculator Program on any computer system.

STEP 2: define a control volume (CV) around the ground heat exchanger (GHE) or ground loop heat exchanger (GLHE) subsystem as shown in FIGS. 15A, 16 and 17, into which and out of which ground loop water flows at a constant mass or volume flow rate, and across the boundaries of which, heat energy is transferred with the deep Earth environment and achieves a state of thermal equilibrium or quasi-equilibrium.

STEP 3: monitor, log and record temperature and pressure values of entering and returning water flows in the ground loop, along with volume/mass flow rates of the water flow.

STEP 4: import the recorded data into the Spreadsheet Enthalpy-Based GHE Performance Calculator Program, and process the data to calculate the actual heat transfer rate (HTR) performance of the GHE or GLHE system.

In such HTR performance monitoring applications, the entering water temperature (i.e. the enthalpy of entering water) will not be maintained substantially constant, as otherwise achieved when using the Enthalpy-Based GHE Performance Test System during performance testing operations. Also, the volume/mass flow rates may also vary over time, particularly when using variable-speed ground loop water circulation pumps. However, the energy rates into and out of the ground heat exchanging system must satisfy the First Law of Thermodynamics, in one form or another, and a new state of thermal equilibrium or quasi-thermal equilibrium will be attained as water flows through the ground loop after one or more ground loop system parameters may have been changed during operation of the overall geothermal system.

For such reasons, the enthalpy-based heat transfer rate (HTR) equation employed in the Spreadsheet Enthalpy-Based GHE Performance Calculator should provide a true and accurate measure of the rate of heat transfer entering or leaving any ground heat exchanging subsystem, in [BTUs/Hr], while performance monitoring—provided temperature, pressure and volume flow rate measurements are taken during states of thermal equilibrium or quasi-thermal equilibrium.

When using the Spreadsheet Enthalpy-Based GHE Performance Calculator Program for such GHE or GLHE performance measurements, any commercially available data logging and recording system can be used, such as the HOBO-U30 Remote Monitoring System, from Onset Computer Corporation, along with conventional temperature and pressure transducers, and mass/volume flow rate meters. However, care must be undertaken to ensure that all incoming (analog and digital) data feeds are properly converted to units of measure required by the Spreadsheet Enthalpy-Based GHE Calculator, particularly when implemented using a Microsoft® Excel® Programming environment.

Monitoring, Logging and Recording the Performance of a Tuned Ground Loop Heat Exchanger (GLHE) Subsystem Using the Enthalpy-Based GLHE Performance Monitoring Module, or the Enthalpy-Based GHE Performance Calculator Program Running on a Portable Computer System

Once a geothermal system (e.g. geothermal heat pump or chiller system) and its ground loop heat exchanging (GLHE) subsystem have been installed at a particular loop field location, and operating according to manufacturer specifications, it will be useful to monitor the actual performance of the geothermal ground loop subsystem in terms of its actual heat transfer rate (HTR), flow work rate (FWR), energy efficiency ratio (EER) and heat transfer efficiency (HTE) performance in connection with the building environment which the geothermal system serves. Monitoring the HTR, FWR, EER and HTE performance of the GLHE subsystem can be easily accomplished by the following method.

STEP 1: install inlet and outlet temperature and pressure transducers, and a volume flow rate meter(s) at the inlet and outlet manifolds of the ground loop subsystem, as shown in the first exemplary geothermal system shown in FIG. 15A, the second exemplary geothermal system shown in FIG. 16, or the third geothermal system shown in FIG. 17. As shown in FIG. 15A, the geothermal heat pump system is connected to an air handling subsystem, under the control of the central environmental control system of the building. In FIG. 16, the ground loop field is connected to multiple geothermal heat pumps each having an integrated air handling subsystem. In FIG. 17, the ground loop field is connected to a large-scale geothermal chiller having an integrated air handling subsystem.

STEP 3: use the Enthalpy-Based GLHE Performance Monitoring Module to periodically monitor the inlet and outlet temperatures and pressures at a defined control volume of the ground loop system, as well as the volume/mass flow rate through the control volume, {Tᵢₙ,Pᵢₙ,\dot{m}ᵢₙ} and {Tₒᵤₜ,Pₒᵤₜ,\dot{m}ₒᵤₜ} and log and record such data values within either (i) memory aboard the GLHE Performance Monitoring Module, (ii) mass storage in a remotely situated RF data logging and recording station, illustrated in FIGS. 1A and 1B, and/or (iii) within a portable computer system running the Enthalpy-Based Spreadsheet GHE Performance Calculator of the present invention.

STEP 4: use either the Enthalpy-Based GLHE Performance Monitoring Module (or the Enthalpy-Based GHE Performance Calculator Program) to process logged and recorded data, and calculate the actual heat transfer rate (HTR), flow work rate (FWR), energy efficiency ratio (EER) and heat transfer efficiency (HTE) figures for the monitored GLHE subsystem, at periodic moments in time, and record these performance figures in a Ground Loop Performance Database maintained within the enterprise of the building which is being served by the ground loop subsystem. The Ground Loop Performance Database can be realized using almost any computer system, but a dedicated server, with automated backup provisions, would be preferred.

After being logged and recorded in the Ground Loop Performance Database, these HTR, FWR, EER and HTE performance figures can be sent to the building's environmental control system, if such a system has been installed, and used in the overall energy management system deployed in the building to improve operations efficiency. These HTR, FWR, EER and HTE performance figures will provide building owners, managers, energy performance managers, and geothermal system maintenance technicians alike, with valuable information on how well any particular ground loop subsystem, and its geothermal heat pump, have been and are currently performing, from season to season, year to year.

The building environmental control system can be programmed to periodically interrupt normal heating and cooling equipment operation of the building, while allowing continuous fluid circulation to a number of independently piped Ground Loop Field Zones, measure, detect and record any incremental changes in the deep Earth temperature of those Ground Loop Field Zones when the inlet and outlet water temperature of those zones are in a state of thermal equilibrium (i.e. Tᵢₙ=Tₒᵤₜ). Periodic deep Earth temperatures, and detected incremental changes therein, can be stored in the Ground Loop Performance Database, along with other performance data maintained on the ground loop throughout its lifetime.

Collectively, the historical performance data records on the ground loop, maintained in the Ground Loop Performance Database, can be used to confirm ground loop performance expectations or projections (with respect to thermal loads), as well as perform diagnostic operations, if and when situations requiring the same should arise.

Method of Creating a GPS-Indexed Heat Transfer Rate (HTR) Performance Database Using Empirically Obtained Heat Transfer Rate (HTR) Performance Surveys Taken Using a Closed-Loop Concentric-Type GHE and GPS-Tracking Enthalpy-Based GHE Performance Test Instrumentation

FIGS. 1A and 1B show an Internet-based network for wireless enthalpy-based GPS-tracking GHE performance test instrumentation systems deployed over the Earth, and communication with a centralized data logging and recording station, and accessible by a remote database server and a plurality of client systems supporting Web-based communication interfaces. This network and the methods of GHE performance testing taught herein can be used to practice a novel method of creating a GPS-indexed heat transfer rate (HTR) performance database using empirically obtained heat transfer rate (HTR) performance surveys taken using a closed-loop concentric-type GHE and GPS-tracking enthalpy-based GHE performance test instrumentation. The advantage of this method and network would be that geothermal engineers would have empirical knowledge of the potential capacity of specific regions of Earth mass to exchange heat energy with such types of ground heat exchangers (GHEs), based on scientific research and empirical investigation. Such a knowledge base could be made available for the benefit of the nation.

Using an Enthalpy-Based Ground Loop Flow Rate Controller for Controlling the Flow Rate of Water Flowing Through the Ground Loop Heat Exchanging (GLHE) Subsystem in Response to Real-Time Measurement and Analysis of Water Inlet Temperature and Computed Heat Transfer Rate (HTR) Across the GLHE Subsystem

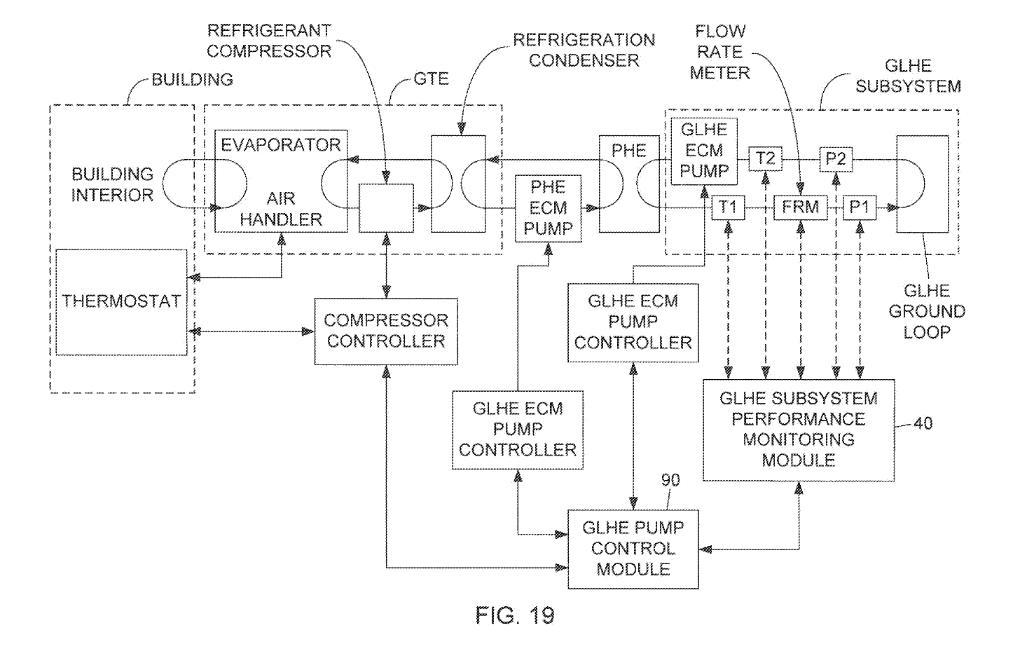

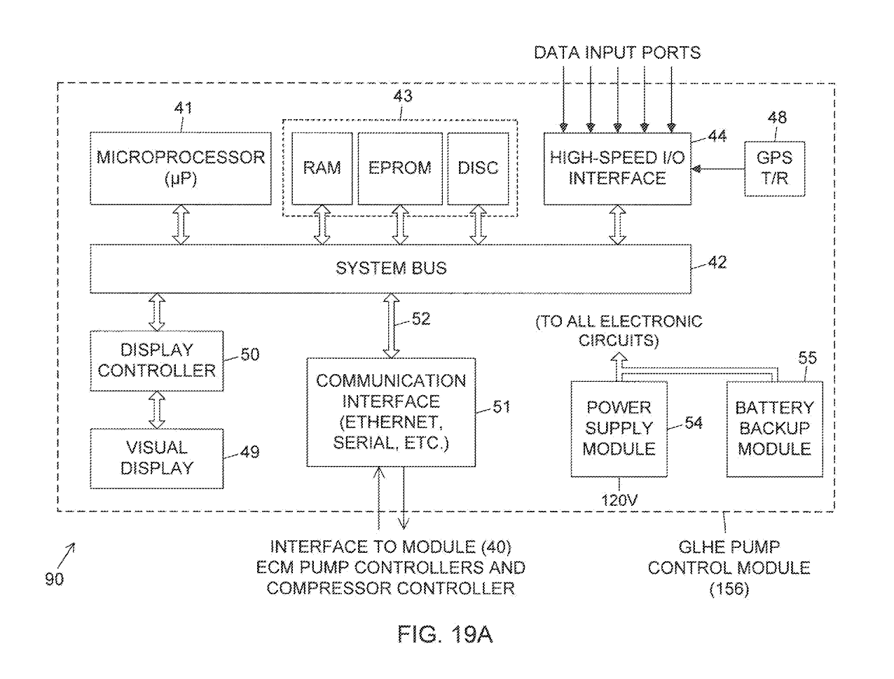

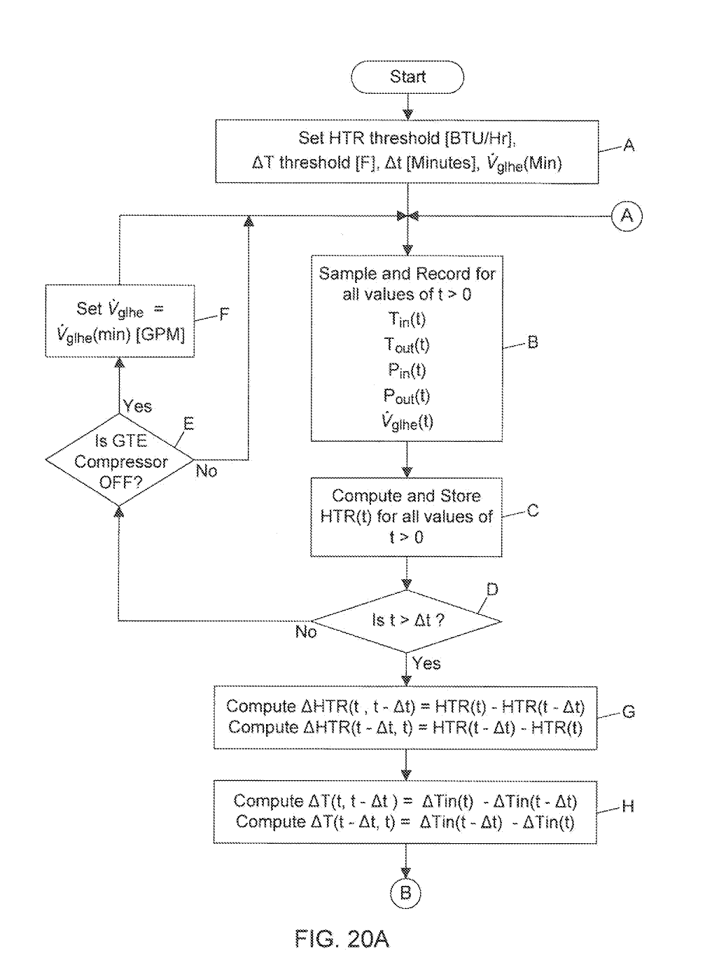

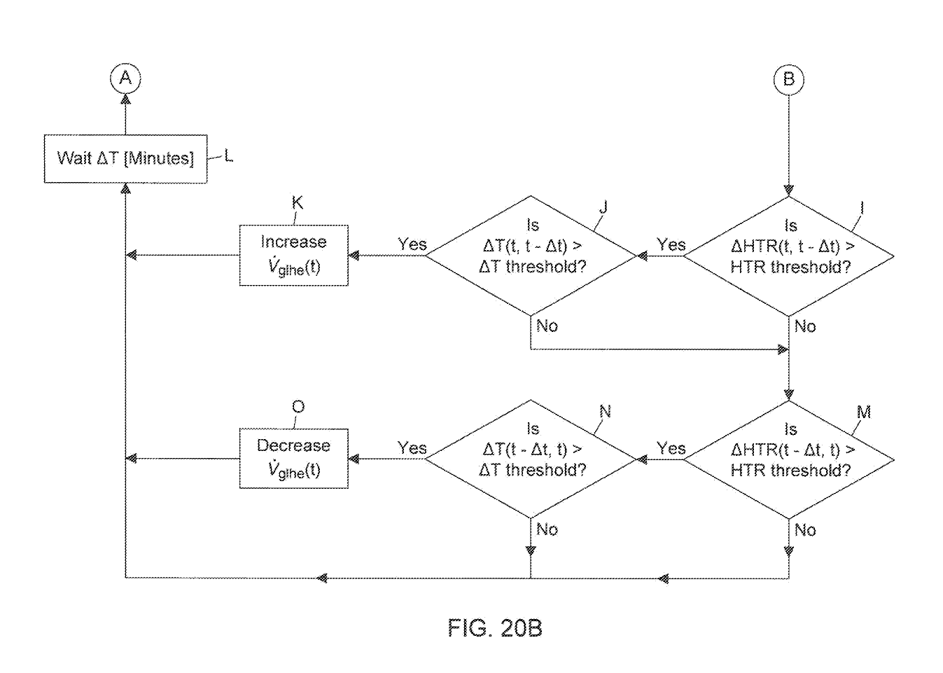

Referring to FIGS. 19, 19A, 20A and 20B, it is appropriate at this juncture to describe a novel method of and apparatus for controlling the volumetric (or mass) flow rate of water flowing through a ground loop heat exchanging (GLHE) subsystem in response to real-time measurement and analysis of the water inlet temperature Tᵢₙ and the computed heat transfer rate (HTR_{glhe}) across the GLHE subsystem.

As shown in FIG. 19, the apparatus of the illustrative embodiment of the present invention is realized in the form of an enthalpy-driven ground loop volumetric flow rate controller that monitors incremental changes in the inlet water temperature Tᵢₙ and the computed HTR_{glhe} across the GLHE subsystem, and in response thereto, automatically increases or decreases the volumetric flow rate V_{glhe} of water flowing through into and out of the GLHE subsystem, to minimize the electrical energy consumption of oelectronically-controlled ground loop pumps employed to pump water through the GLHE subsystem.

In FIG. 19, there is shown a building having its air-conditioned using a geothermal system having geothermal equipment (GTE), e.g. geothermal heat pump or chiller, connected to a ground loop heat exchanging (GLHE) subsystem. As shown, the GLHE subsystem comprises: multiple GHEs installed in the deep Earth environment, and connected together via an underground piping network designed in accordance with the principles of the present invention. Also, the GTE comprises: an evaporator, a condenser and a refrigerant compressor connected in series in a refrigerant loop. As shown, air handler is installed between the building space and the evaporator, and compressor controls are provided for controlling the refrigerant compressor, in response to signals provided by a thermostat installed in the building interior, and in communication with the air-handler.

As shown, the GLHE subsystem (i.e. GHEs) are interfaced with the GTE, using a PHE as shown in FIG. 14. The PHE creates a first hydraulic loop between the geothermal equipment (GTE) and the PHE, and a second hydraulic loop between the PHE and the GLHE subsystem. As shown, a first PHE ECM pump is installed in the first hydraulic loop, and a second PHE ECM pump is installed in the second hydraulic loop.

As shown in FIG. 19, an enthalpy-driven ground loop flow rate control subsystem comprises: a GLHE subsystem performance monitoring module 40 receiving input data signals from inlet and outlet temperature sensors Tᵢₙ, Tₒᵤₜ and inlet and outlet pressure transducers; Pᵢₙ, Pₒᵤₜ, and volumetric (or mass) flow rate meter (FRM) installed at the inlet and outlet ports of the GLHE subsystem comprising multiple GHEs installed and connected in parallel in a flow balanced manner; a GLHE pump control module 90 receiving sampled and buffered inlet temperature values Tᵢₙ(t) and computed HTR_{glhe}(t) values supplied from the GLHE Subsystem Performance Monitoring Module 40, at a frequency of 1/Δt where Δt is the control loop updating interval (e.g. 15 minutes); a first GLHE ECM pump controller interfaced with the GLHE pump control module, and GLHE ECM pump controller which is interfaced with the first PHE ECM pump installed in the first hydraulic loop of the GLHE subsystem; and a second GLHE ECM pump controller interfaced with the GLHE pump control module, and GLHE ECM pump controller which is interfaced with the second PHE ECM pump installed in the second hydraulic loop of the GLHE subsystem.

As shown in FIG. 19A, the Module 90 comprises a number of components, namely: a programmed microprocessor 41; a system bus 42; a memory architecture 43 including RAM, FLASH ROM and hard-disc; an high-speed I/O interface 44 for optionally receiving the inputs from temperature and pressure transducers 45A, 45B, 46A, 46B, volumetric fluid rate meter(s) 47, signals from an onboard GPS transceiver module 48, and other sensed data inputs indicated in FIG. 19; a touch-screen LCD display panel 49 interfaced with system bus/CPU via display controller 50, for selecting functions and displaying sensed data and calculated performance figures for the system being monitored; a communications module 51 for supporting communication protocols and related communication interfaces/ports; connectors and (optionally antennas) supporting the communication module 51; a power supply module 54; a backup battery module 55; and a compact rugged housing 156 for containing all of the module components. In general, communications module 51 supports multiple analog and digital signal inputs, and multiple communication protocols, for example: RS422/485, Ethernet 10Base-T TCP/IP, Modbus RTU, Ethernet 10Base-T TCP/IP Modbus, BacNet, and Lonworks data communication protocols, as well as WIFI (802.11) and infrared (IR) R100 communication protocols. Such communication protocols enable the module 90 to communicate with module 40, ECM pump controllers, and the compressor controller(s) shown in FIG. 19, as well as with other devices operating within the ground loop, within the building loop, and environmental control system computers deployed within the building or operating environment.

While shown as two separate but interfaced modules, optionally, the GLHE pump control module 90 can be integrated with the GLHE subsystem performance monitoring module 40 so as to provide a single module or device supporting both energy performance calculation functions, as well as ground loop flow rate control processes, in accordance with the principles of the present invention. Such modules can be realized using a commercially available programmable micro-control system, programmed to carry out sample, store and process inlet and outlet water temperature and pressure values, and volumetric flow rate, and computer the energy performance parameters of the present invention, particularly the HTR parameter. Also, these modules can be realized using custom silicon chip technology, as well as programmable logic array, or FPGA technology, well known in the art.

FIGS. 20A and 20B show the primary steps carried out the real-time ground loop flow rate control process and controller according to the principles of the present invention. During the process, incremental changes in the inlet water temperature and HTR across the GLHE subsystem are periodically monitored, and in responses thereto, the volumetric flow rate of water flowing through into and out of the GLHE subsystem is automatically increased or decreased, to minimize the electrical energy consumption of electronically-controlled ground loop pumps employed to pump water through the GLHE subsystem.

As indicated at Block A in FIG. 20A, the method involves setting default values for parameters HTR_{threshold} [BTU/Hr], ΔT threshold [F], Δt=15 [Minutes] and V_{glhe}=V_{glhe}.(min). However, these default values can be modified during the process to make the control process quicker and more responsive.

As indicated at Block B, the method involves sampling and recording, for all values of t>0, the following parameters: Tᵢₙ(t), Tₒᵤₜ(t), Pᵢₙ(t), Pₒᵤₜ(t), and V_{glhe}(t).

As indicated at Block C, the method involves computing and storing HTR_{glhe}(t) for all values of t>0.

As indicated at Block D, the controller determines whether or not the t>Δt, which ensures that at least one sampling period has lapsed and a set of sampled parameters have been stored and available for use in the computational loops of the control process.

If t is not greater than Δt, that at Block E, the controller determines whether or not the GHE compressor is ON or OFF. If the GTE compressor is not OFF, then the controller proceeds to Block B as shown. If the GTE compressor is OFF, then at Block F, the controller sets V_{glhe}=V_{glhe}(min) [GPM}, and then proceeds to Block B, as shown.

As indicated at Block G, the method involves computing ΔHTR(t, t−Δt)=HTR(t)−HTR(t−Δt) and ΔHTR(t−Δt, t)=HTR(t−Δt)−HTR(t) and storing these values in buffer memory.

As indicated at Block H, the method involves computing ΔT(t, t−Δt)=ΔTᵢₙ(t)−ΔTᵢₙ(t−Δt) compute ΔT(t−Δt, t)=ΔTᵢₙ(t−Δt)−ΔTᵢₙ(t).

As indicated at Block I in FIG. 20B, the controller determines whether or not the HTR_{threshold} ΔHTR(t, t−Δt)>HTR_{threshold} is reached.

If the HTR threshold is reached at Block I in FIG. 20B, then at Block J, the controller determines whether or not the inlet temperature threshold ΔT(t, t−Δt)>ΔT is reached.

If the inlet temperature threshold is reached at Block J, then at Block K, controller increases V_{glhe}(t) and after waiting ΔT [Minutes] at Block J, return to Block B in FIG. 20A. If the inlet temperature threshold is not reached at Block J, then the controller proceeds to Block M, as shown in FIG. 20B.

If at Block I, the HTR threshold is not reached, then the controller proceeds to Block M

At Block M, the controller determines whether the HTR_{threshold} ΔHTR(t−Δt, t)>HTR_{threshold} is reached.

If the HTR threshold is not reached at Block M then the controller proceeds to Block L, waits ΔT [Minutes] and then return to Block B in FIG. 20A.

If the HTR threshold is reached at Block M, then the controller proceeds to Block N and determines whether or not the inlet temperature threshold ΔT(t−Δt, t)>ΔT is reached.

If the inlet temperature threshold is reached at Block N, then the controller proceeds to Block O and decreases V_{glhe}(t), and advances to Block L, as shown in FIG. 20B.

If the inlet temperature threshold is not reached at Block N, then the controller proceeds to Block J, waits ΔT [Minutes] and then return to Block B in FIG. 20A.

Notably, the enthalpy-driven ground loop flow rate controller does not use or require control or timing signals supplied from the compressor controller used to control the operation of refrigerant compressors and other power consuming devices associated with the geothermal equipment (GTE), e.g. geothermal heat pump or chiller, connected to the GLHE subsystem.

Notably, a single enthalpy-driven ground loop volumetric flow rate controller can be used to control both (i) the volumetric flow rate of water flowing through the first hydraulic loop between the GTE and a PHE, and (ii) the volumetric flow rate of water flowing through a second hydraulic loop between the PHE and a GLHE subsystem, wherein the PHE is configured to allow the maximum heat transfer rate (HTR) or load across the GTE to be transferred across the PHE to the GLHE subsystem operating a volumetric flow rate tuned to support the maximum HTR across the GTE. This dual-method of pump control is made possible because of the fact that the ratio of volumetric flow rate within the second hydraulic (GLHE) loop will typically be greater than the volumetric flow rate through the first hydraulic (GTE) loop by a constant design factor typically greater than 1.0, while the ratio of temperature differences across the input and output ports of the PHE will be inversely proportional to this fixed facto (i.e. because the PHE is an essentially low energy loss system, during thermal energy transformation), in accordance with the First Law of Thermodynamics. Thus, control signals generated for ECM pumps in the second hydraulic (GLHE) loop (e.g. by pump rate control converter (1/M) in FIG. 17, or by GLHE pump control module 90 in FIG. 19) can be used to control ECM pumps in the first hydraulic (GTE) loop, simply by converting or scaling the control signals generated for ECM pumps in the second hydraulic (GLHE) loop. Alternatively, a separate GLHE subsystem performance monitoring module 40 and GLHE pump control module 90 can be installed for each isolated ground loop within a geothermal system, but it is advised to exploit relationships between ground loop flow rates wherever possible in order to simply design and construction costs, without sacrificing energy efficiency and performance.

Method of and Apparatus for Measuring Changes in Deep Earth Temperature about a Ground Heat Exchanger in Response to Thermal Loads on Neighboring Ground Heat Exchangers

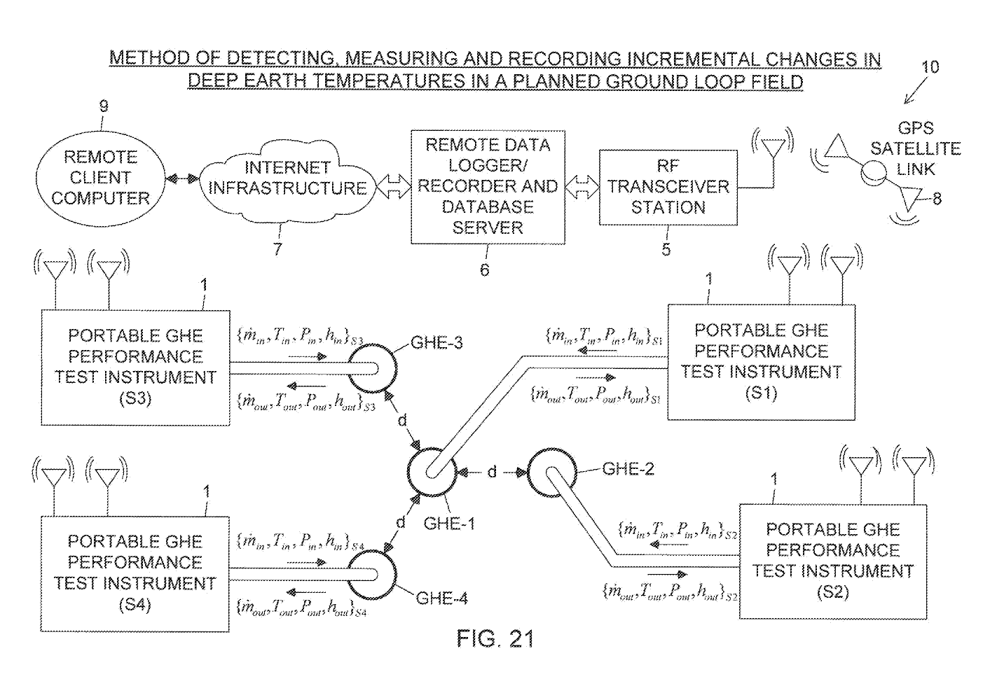

During the ground loop engineering process, there might come a time when the thermal conductivity properties of the deep Earth environment might be brought into serious question, especially when a very large project is involved. In such instances, the GLE process recommends that multiple Portable Enthalpy-Based GHE Performance Test Instrumentation Systems 1 described above be used to carry out a thermal response measurement test, as illustrated in FIG. 21. In the illustrative embodiment shown in FIG. 20, this involves installation of four Thermacouple® ground heat exchangers (TC50s GHEs) at a particular test site, on which a ground loop subsystem is being planned for design and construction. The purpose of such a test arrangement is to measure incremental changes in deep Earth temperature (ΔT_{de}) about a “thermally-passive” ground heat exchanger (GHE-1) in response to thermal loads on neighboring “actively-driven” ground heat exchangers (GHE-2, GHE-3 and GHE-4). In most geological test environments, the thermal properties of the deep Earth mass, and underground water resources, are such as to rapidly disperse and distribute heat energy from neighboring ground heat exchangers at a rate as to not cause any significant increase in deep Earth temperature throughout the year.

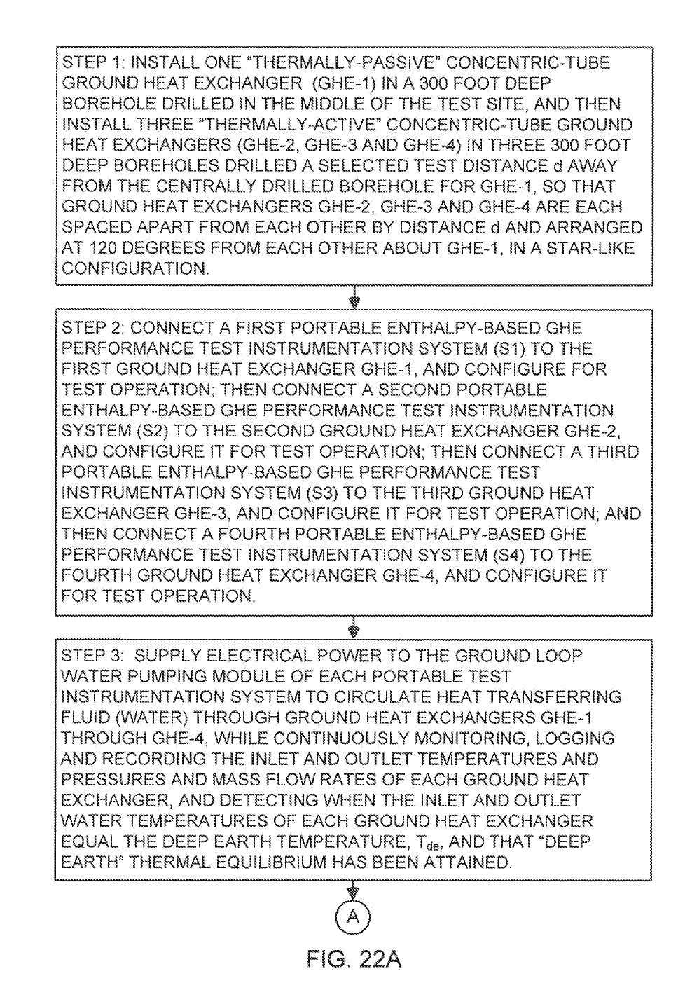

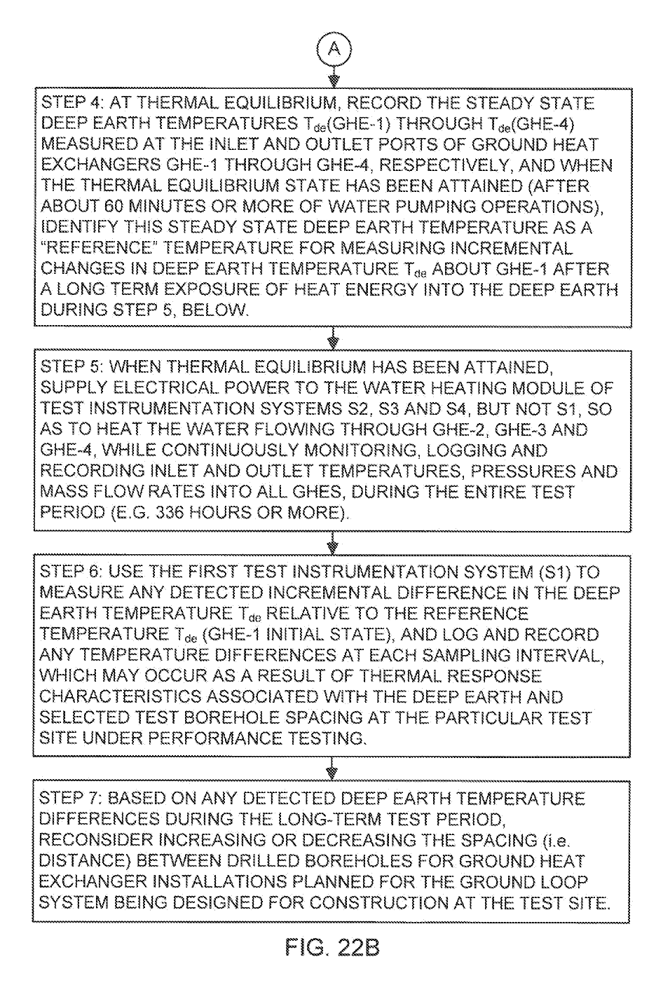

As shown in Step 1 of FIG. 22A, the method involves installing one “thermally-passive” Thermacouple® ground heat exchanger (GHE-1) in a 300 foot deep borehole drilled in the middle of the test site, and then installing three “thermally-active” Thermacouple® ground heat exchangers (GHE-2, GHE-3 and GHE-4) in three 300 foot deep boreholes drilled twenty (20) feet away from the centrally drilled borehole for GHE-1, so that ground heat exchangers GHE-2, GHE-3 and GHE-4 are each spaced apart from each other by 20 feet and arranged at 120 degrees from each other about GHE-1, in a star-like configuration as illustrated in FIG. 19.

As shown in Step 2 of FIG. 22A, the method involves connecting a first Portable Enthalpy-Based GHE Performance Test Instrumentation System (S1) to the first ground heat exchanger GHE-1, and configuring for test operation; then connecting a second Portable Enthalpy-Based GHE Performance Test Instrumentation System (S2) to the second ground heat exchanger GHE-2, and configuring it for test operation; then connecting a third Portable Enthalpy-Based GHE Performance Test Instrumentation System (S3) to the third ground heat exchanger GHE-3, and configuring it for test operation; and then connecting a fourth Portable Enthalpy-Based GHE Performance Test Instrumentation System (S4) to the fourth ground heat exchanger GHE-4, and configuring it for test operation.

As shown in Step 3 of FIG. 22A, the method involves supplying electrical power to the ground loop water pumping module of each Portable Test Instrumentation System to circulate heat transferring fluid (water) through each ground heat exchangers GHE-1 through GHE-4, continuously monitoring, logging and recording the inlet and outlet temperatures and pressures and mass flow rates of each ground heat exchanger, and to detect when the inlet and outlet water temperatures of each ground heat exchanger equal the deep Earth temperature, T_{de}, and “deep Earth” thermal equilibrium has been attained.

As shown in Step 4 of FIG. 22B, the method involves, recording at thermal equilibrium, the steady state deep Earth temperatures T_{de}(GHE-1) through T_{de}(GHE-4) measured at the inlet and outlet ports of ground heat exchangers GHE-1 through GHE-4, respectively, and when the thermal equilibrium state has been attained after about 60 minutes or more of water pumping operations, identifying this steady state deep Earth temperature as a “reference” temperature for measuring changes in deep Earth temperature T_{de} about GHE-1 after a long term exposure of heat energy into the deep Earth during Step 4, below.

As shown in Step 5 of FIG. 22B, method involves, when thermal equilibrium has been attained, supplying electrical power to the water heating module of Portable Test Instrumentation Systems S2, S3 and S4, but not 51, heating the water flow through GHE-2, GHE-3 and GHE-4, and continuously monitoring, logging and recording inlet and outlet temperatures, pressures and mass flow rates into all GHEs, during the entire test period (e.g. 150 hours).

As shown in Step 6 of FIG. 22B, method involves using the first Test Instrumentation System (S1) to measure any detected difference in the deep Earth temperature T_{de} relative to the reference temperature T_{de} (GHE-1 initial state), and log and record any temperature differences, each sampling interval, which may occur as a result of thermal response characteristics associated with the deep Earth and selected borehole spacing at the particular test site under performance testing.

As shown in Step 7 of FIG. 22B, the method involves carefully reviewing any detected changes in deep Earth temperature during the long-term test period, and reconsidering increasing or decreasing the spacing (i.e. distance) between drilled boreholes for ground heat exchanger installations planned for the ground loop system being design for construction at the test site.

Ideally, the longer the test period, the better, but practical considerations and temperature trends detected over a 150 hour test period should typically indicate little need to extend the period beyond this time frame.

In Earth environments where there is sufficient ground water and adequate thermal conductivity, differences in deep Earth temperature should measure relative low, if not negligible, during steady-state long term conditions.

It is expected that for most geological environments, where there is sufficient ground water, borehole distances of about 20 or more feet will result in deep Earth temperature changes that are negligible, indicating that the deep Earth environment under testing has the capacity to dissipate and distribute heat energy from the ground loop subsystem, throughout the mass of the surrounding deep Earth so as not appreciably alter the average deep Earth temperature throughout the year, from season to season.

Modifications that Readily Come to Mind

Having the benefit of the present invention disclosure, several modifications thereto readily come to mind.

For example, in the illustrative embodiments of the Portable GHE Performance Test Instrumentation System of the present invention, the water heating module has been realized using a plurality of electrically-powered individually-switchable water heating elements, preferably powered by a 230 Volt/100 Amp service delivered to the test site using J-cord, a portable electrical power generator or the like. However, in alternative embodiments of the present invention, it is possible to realize the water heating module using natural gas, propane or other combustion-type devices for heating the stream of water flowing through the GHE Performance Test Instrumentation System to maintain a substantially constant inlet temperature Tᵢₙ while the water flow is maintained a constant flow rate during the long term testing operations. Alternatively, it is possible to realize the water heating module using a water-to-water heat pump unit that has been adapted to supply heat energy to the water stream flowing through the water pumping module of the GHE Performance Test Instrumentation System, to maintain a substantially constant inlet temperature Tᵢₙ at a substantially constant mass flow rate through the GHE.

In the illustrative embodiment, the Portable GHE Performance Test Instrumentation System of the present invention has been operating in a “cooling mode” meaning that its water heating module adds heat energy the heat transferring fluid (i.e. water) so that it attains a constant inlet temperature (e.g. Tᵢₙ=95° F.) during performance testing operations, while the mass of the deep Earth environment is allowed to absorb the heat energy at a rate to be empirically measured by the enthalpy-based heat transfer rate measurement techniques practiced by the GHE Performance Test Instrumentation System of the present invention.

However, in alternative embodiments, it is understood that the Portable GHE Performance Test Instrumentation System may be readily adapted to operate in a “heating mode”, meaning that its water heating module would be replaced with a water cooling module, so that the heat transferring fluid (i.e. water) is automatically cooled (rather than heated) as the fluid flows through its pumps to a predetermined constant inlet temperature Tᵢₙ, e.g. 35 [° F.], while flowing through the GHE at a constant mass flow rate during performance testing operations. In such alternative embodiments, the water cooling module can be realized by integrating a refrigeration unit or a water-to-water heat pump with the water pumping module for the purposes of cooling the heat transferring fluid to a substantially constant inlet temperature Tᵢₙ=35 [° F.], at a constant mass flow rate, during performance test operations.

Also, while the illustrative embodiments of the GHE Performance Test Instrumentation System and method of the present invention have been described in connection with concentric-tube (i.e. coaxial-flow) and HDPE U-Tube type ground heat exchangers, it is understood that the test instrumentation methods and apparatus of the present invention can be used to measure the in situ HTR, FWR and EER performance of other closed types of ground heat exchangers, as well as open-type standing column well ground heat exchangers, well known in the art. Such open-type systems will require several modifications to the test system and method, including its energy balance model, to address the “open” nature of the system in which a constant flow of used ground water is being pumped out of the system, while a fresh source of ground water is being pumped into the system, while the mass flow rates of water into and out of the system is maintained substantially constant.

Also, it is understood that the heat transfer rate test method of the present invention, including its enthalpy-based spreadsheet-based GHE performance calculator can be readily adapted for measuring the performance of all kinds of geothermal ground loop subsystems that have been engineered for used with ground source heat pumps, HVAC chillers, and other types of heat transferring machines and systems, working to control the temperature and/or enthalpy of fluids, and/or spatial environments associated with machines, systems, buildings and the like.

It is understood that the HTR, FWR and EER performance test apparatus and methodologies of the present invention may be modified in various ways which will become readily apparent to those skilled in the art of having had the benefit of exposure to the novel teachings disclosed herein. All such modifications and variations of the illustrative embodiments thereof shall be deemed to be within the scope and spirit of the present invention, as defined by the Claims to Invention appended hereto.

1-83. (canceled)

84. Apparatus for controlling the flow rate of heat transferring fluid flowing through a ground loop heat exchanging (GLHE) subsystem constructed from one or more ground heat exchangers (GHE) and one or more electronically-controlled pumps installed in a GLHE loop, while being operably connected to geothermal equipment (GTE) including a refrigerant compressor and associated with a geothermal system, said apparatus comprising:
a data collection and buffering subsystem for monitoring the temperature and pressure of heat transferring fluid entering and exiting said GLHE subsystem, as well as the flow rate of said heat transferring fluid flowing through said GLHE subsystem; and
a processor for (i) processing said temperature, pressure and flow rate data, and computing the heat transfer rate (HTR) of said heat transferring fluid entering said GLHE subsystem, and (ii) measuring incremental changes in said temperature of heat transferring fluid entering into said GLHE subsystem, and said heat transfer rate (HTR) across said GLHE subsystem, and in response to said monitored incremental changes in said temperature and said HTR determined by said processor, automatically generating flow rate control signals for use by said one or more electrically controlled pumps to control the flow rate of said heat transferring fluid flowing through said GLHE subsystem so that said GLHE subsystem satisfies the HTR requirements of said GTE.

85. The apparatus of claim 84, wherein said processor generates control signals for incrementally increasing and/or decreasing said flow rate of said heat transferring fluid, and said control signals being provided to said one or more electrically controlled pumps.

86. An enthalpy-driven ground loop flow rate controller for monitoring incremental changes in the inlet water temperature into and HTR across a GLHE subsystem, and in response thereto, automatically increasing or decreasing the flow rate of water flowing through into and out of said GLHE subsystem, so as to minimize the electrical energy consumption of electronically-controlled ground loop pumps employed to pump water through said GLHE subsystem.

87. The enthalpy-driven ground loop flow rate controller of claim 86, which is arranged to control both (i) the flow rate of water flowing through a first hydraulic loop between geothermal equipment (GTE) and a plate heat exchanger (PHE), and (ii) the flow rate of water flowing through a second hydraulic loop between said PRE and a GLHE subsystem, wherein said PHE is configured to allow the maximum heat transfer rate (HTR) or load across the GTE to be transferred across said PHE to said GLHE subsystem operating a flow rate tuned to support the maximum HTR across said GTE.

88. Apparatus for controlling the flow rate of aqueous-based heat transferring fluid flowing through a ground loop heat exchanging (GLHE) subsystem (i) constructed from one or more ground heat exchangers (GHEs) connected in ground loop through which aqueous-based heat transferring fluid is circulated using one or more electronically-controlled pumps, and (ii) connected to geothermal equipment (GTE) having one or more refrigerant compressors, said apparatus comprising:
a programmed processor for monitoring one or more of (i) the temperature of said aqueous-based heat transferring fluid flowing into said GLHE subsystem, and (ii) the measured heat transfer rate (HTR) across said GLHE subsystem;
wherein in response to periodic measurement and analysis of said temperature and/or said measured heat transfer rate (HTR) across said GLHE subsystem, said programmed processor automatically generates control signals for controlling said one or more electronically-controlled pumps; and
wherein said control signals being are used to control the flow rate of said aqueous-based heat transferring fluid being pumped through said GLHE subsystem by said one or more electronically-controlled pumps.

89. The apparatus of claim 88, wherein said GLHE subsystem is interfaced with said GTE, using a heat exchanger;
wherein said heat exchanger creates a first hydraulic loop between said GTE and said heat exchanger, and a second hydraulic loop between said PHE and said GLHE subsystem;
wherein at least one said electronically-controlled pump is installed in said first hydraulic loop;
wherein at least one said electronically-controlled pump is installed in said second hydraulic loop; and
wherein said control signals are used to control the flow of said aqueous-based heat transferring fluid flowing through said first and second hydraulic loops so as to transfer thermal energy between said GTE to said GLHE subsystem.

90. The apparatus of claim 89, wherein said heat exchanger is a plate heat exchanger (PHE).

91. The apparatus of claim 88, wherein further comprising:
data input ports for receiving said inlet temperature data and said computed HTR values from said programmed processor; and
data buffers for receiving and buffering said inlet temperature values and said computed HTR values, during each control loop updating interval.

92. The apparatus of claim 88, which is realized in the form of a compact module.

93. The apparatus of claim 91, which further comprises a communications module supporting multiple analog and digital signal inputs, and multiple communication protocols to allow communication with one or more of said GLHE subsystem performance monitoring subsystem, ECM pump controllers, and said refrigerant compressor(s).

94. A process for controlling the flow rate of heat transferring fluid flowing through a ground loop heat exchanging (GLHE) subsystem constructed from one or more ground heat exchangers (GHE) and being operably connected to geothermal equipment (GTE) including a refrigerant compressor that is associated with a geothermal system, said process comprising the steps of:
(a) monitoring incremental changes the temperature of heat transferring fluid entering into said GLHE subsystem, and also the heat transfer rate (HTR) across said GLHE subsystem; and
(b) in response to said monitored incremental changes temperature and said HTR, automatically incrementally increasing or decreasing the flow rate of said heat transferring fluid flowing through said GLHE subsystem, during each flow rate updating cycle carried out by said process.

95. A process for controlling the flow rate of aqueous-based heat transferring fluid flowing through a ground loop heat exchanging (GLHE) subsystem constructed from one or more ground heat exchangers (GHEs) connected in ground loop through which aqueous-based heat transferring fluid is circulated using one or more electronically-controlled pumps, and connected to geothermal equipment (GTE) having one or more refrigerant compressors, said process comprising the steps of:
(a) monitoring one or more of (i) the temperature of said aqueous-based heat transferring fluid flowing through said GLHE subsystem, and (ii) the measured heat transfer rate (HTR) across said GLHE subsystem;
(b) in response to periodic measurement and analysis of said temperature and/or said, measured heat transfer rate (HTR) across said GLHE subsystem, automatically generating control signals for controlling said one or more electronically-controlled pumps; and
(c) using said control signals to control the flow rate of said aqueous-based heat transferring fluid being pumped through said GLHE subsystem by said one or more electronically-controlled pumps.
